(19) United States
(12) Patent Application Publication
(10) Pub. No.: US 2014/0097636 A1
(43) Pub. Date: Apr. 10, 2014

(54) VEHICLE WINDOW WITH SHADE

(71) Applicants: Darin J. Snider, Holland, MI (US); Norman B. Warren, Holland, MI (US)

(72) Inventors: Darin J. Snider, Holland, MI (US); Norman B. Warren, Holland, MI (US)

(73) Assignee: MAGNA MIRRORS OF AMERICA, INC., Holland, MI (US)

(21) Appl. No.: 14/125,403

(22) PCT Filed: Jun. 22, 2012
(86) PCT No.: PCT/US2012/043729

§ 371 Date: Dec. 11, 2013

Related U.S. Application Data
(63) Continuation-in-part of application No. 13/642,908, filed on Oct. 23, 2012.
(60) Provisional application No. 61/658,126, filed on Jun. 11, 2012.
(60) Provisional application No. 61/653,100, filed on May 30, 2012.
(60) Provisional application No. 61/646,556, filed on May 14, 2012.
(60) Provisional application No. 61/643,573, filed on May 7, 2012.
(60) Provisional application No. 61/614,881, filed on Mar. 23, 2012.
(60) Provisional application No. 61/593,963, filed on Feb. 2, 2012.
(60) Provisional application No. 61/554,016, filed on Nov. 1, 2011.
(60) Provisional application No. 61/500,899, filed on Jun. 24, 2011.
(60) Provisional application No. 61/447,994, filed on Mar. 1, 2011.
(60) Provisional application No. 61/327,181, filed on Apr. 23, 2010.

(51) Int. Cl. B60J 3/02

(52) U.S. Cl. CPC B60J 3/02
USPC 296/97.8

(57) ABSTRACT

A window assembly for a vehicle includes inner and outer window panels and a spacer element disposed between the window panels to establish an interpane cavity, with a roller shade disposed therein having an end fixedly attached at an anchor stop. A dielectric layer is disposed between the roller shade and a conductive layer at the inner window panel. The shade is operable via applying a voltage at the conductive layer and at the anchor stop to uncoil the shade from a coiled light transmitting condition to an at least partially uncoiled light attenuating condition. The window assembly may include conductive elements established at the dielectric layer for dissipating charge at the dielectric layer when the voltage is not applied and/or may mechanically retain the shade in its uncoiled state to allow for reduction in the voltage applied when the shade is uncoiled.

### CROSS REFERENCE TO RELATED APPLICATIONS

The present application claims the filing benefit of U.S. provisional applications, Ser. No. 61/658,126, filed Jun. 11, 2012; Ser. No. 61/653,100, filed May 30, 2012; Ser. No. 61/646,556, filed May 14, 2012; Ser. No. 61/643,573, filed May 7, 2012; Ser. No. 61/614,881, filed Mar. 23, 2012; Ser. No. 61/593,963, filed Feb. 2, 2012; Ser. No. 61/554,016, filed Nov. 1, 2011; and Ser. No. 61/500,899, filed Jun. 24, 2011, which are all hereby incorporated herein by reference in their entireties.

### FIELD OF THE INVENTION

The present invention relates to a window assembly for a vehicle and, more particularly, a window assembly for a vehicle that includes a shade.

### BACKGROUND OF THE INVENTION

It is known to provide a window assembly for a vehicle that includes a shade that is movable between an open position and a closed or shading position. Examples of such shades are described in U.S. Pat. Nos. 7,645,977; 6,520,239; 7,083,226; 6,899,380; 6,513,864; and 6,520,239, which are hereby incorporated herein by reference in their entireties.

### SUMMARY OF THE INVENTION

The present invention provides a window assembly that provides for shading of the window panel having a pair of spaced apart glass or plastic window panels. The outer window panel may be oversized relative to the inner window panel and may have cross-dimensions that are greater than the inner window panel so as to have perimeter overhang regions at least partially around the window assembly, which may provide enhanced mounting means for mounting the window assembly to the vehicle and may provide an enhanced appearance of the window assembly to a person viewing the window assembly from exterior of the vehicle. The curvatures and contours of the inner and outer window panels may be different and the spacing between the window panels may vary, so as to provide a desired curvature or contour for each window panel relative to the respective vehicle surface at which they are disposed. The shading means or shading element may comprise a coilable shading element or sheet (such as a tightly coiled conductive film, such as, for example, a metalized polymeric film or the like) that is disposed in a cavity between an inner window panel and an outer window panel and that dims or darkens the window assembly via uncoiling of the shading element.

According to an aspect of the present invention, a window assembly of a vehicle (such as for a sunroof or moonroof type window of a vehicle) includes an outer window panel, an inner window panel and a spacer element disposed between the inner and outer window panels to establish an interpane cavity between the inner and outer window panels. A roller shade or shade element is disposed in the cavity and is electrically deployable via electrostatic action to coil and uncoil between a coiled light transmitting condition, where the roller shade functions to substantially allow light transmission through the window assembly, and an at least partially uncoiled light attenuating or light blocking condition, where the roller shade functions to at least partially attenuate or block light transmission through the window assembly. The spacer element comprises a circumferential frame or element and the roller shade may be attached to a support element, such as a generally rigid elongated support element, that is attached along a perimeter portion of the frame. For example, a perimeter portion of the spacer element or frame may comprise a shade attaching structure for attaching or receiving the elongated support element and the roller shade at the perimeter portion of the spacer element. The spacer element is formed to provide a variable spacing between the panels and to seal against the panels, while allowing for electrical connection to the roller shade and optionally to a stop element at an opposite side of the window from the rolled up roller shade.

Optionally, the electrical connection to the roller shade may be made via a conductive element (such as a wire or the like) that passes through the spacer element or under the spacer element (or otherwise between the spacer element and a window panel) and connects to the roller shade at the elongated support structure at the roller shade attaching or receiving structure of the spacer element. Optionally, the window assembly may include an electrically conductive stop element disposed along another perimeter portion of the spacer element, with an end of the shade when unrolled at least partially contacts the stop element when roller shade or film is uncoiled to its light limiting state. The electrical connection to the stop element may be made via an electrically conductive element that electrically connects between the elongated support structure at the roller shade attaching or receiving structure of the spacer element and the stop element. The other perimeter portion of the spacer element may comprise a stop element receiving portion that is configured to receive and retain the stop element thereat, with the stop element at least partially contacting the surface of the inner window panel.

Optionally, the perimeter portion of the spacer element at which the roller shade is positioned may be configured to have an outboard portion curved along a curvature of the perimeter of the inner window panel and an inboard portion configured to provide a generally straight shade attaching structure for receiving and retaining a generally straight portion of the roller shade. Similarly, the other perimeter portion of the spacer element at which the stop element may be disposed may be configured to have an outboard portion curved along a curvature of the perimeter of the inner window panel and an inboard portion configured to provide a generally straight stop element receiving portion for receiving and retaining a generally straight stop element.

The roller shade may comprise a conductive film (such as a flexible or coiled conductive film, such as a metalized polymeric film or the like) that is tightly coiled in its coiled state and that uncoils in response to a voltage applied thereto. Optionally, one or more roller shades may be disposed within the cavity of the window assembly to provide a desired shading scheme and one or more degrees of shading or degrees of light transmission through the window assembly.

Optionally, at least one of (a) the outer window panel has larger cross dimensions relative to the inner window panel to provide overhang regions of the outer window panel, and (b) the inner window panel has a different contour or curvature than that of the outer window panel so that the interpane cavity varies in gap distance across the window assembly. Optionally, the outer window panel has larger cross dimensions relative to the inner window panel to provide overhang regions of the outer window panel. The outer window panel may have an outer surface that is generally flush with an outer surface of at least one of (a) an outer or exterior panel of the vehicle and (b) a windshield of the vehicle and (c) a rear backlite of the vehicle. Optionally, the inner window panel may have a different contour or curvature than that of the outer window panel so that the interpane cavity varies in gap distance across the window assembly, such that the outer surface of the outer window panel may correspond with a contour of an outer surface of at least one of (a) an exterior panel of the vehicle and (b) a windshield of the vehicle and (c) a rear backlite of the vehicle, while an in-cabin surface of the inner window panel may correspond with a contour of an in-cabin surface of an interior panel or headliner or trim element of the vehicle.

The roller shade is electrically operable to adjust between the coiled light transmitting condition and the at least partially uncoiled light attenuating or light blocking condition, and electrical connection is made between the roller shade and a vehicle power source to provide electrical power to the roller shade. Optionally, window assembly may comprise a movable window assembly that is movable relative to the vehicle at which it is mounted between opened and closed positions. Optionally, the electrical connection and powering may be made to the roller shade only when the window is closed or may be made when the window is opened or closed and irrespective of a position of the movable window assembly relative to the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of a portion of a vehicle having a window assembly in accordance with the present invention;

FIG. 2 is a perspective view of the window assembly of FIG. 1;

FIG. 3 is a perspective and partial sectional view of the window assembly of FIG. 2;

FIG. 4 is an exploded perspective view of another window assembly in accordance with the present invention;

FIG. 5 is a perspective view of the spacer element or frame of the window assembly of FIG. 4;

FIGS. 6 and 7 are enlarged perspective views of the corners of the spacer element of FIG. 5, showing the attachment elements for attaching a roller shade support at the spacer element;

FIG. 8 is an exploded perspective view of a roller shade and support of the window assembly of FIG. 4;

FIG. 9 is an enlarged perspective view of an end of the roller shade and support assembly of FIG. 8;

FIG. 10 is a perspective view of the spacer element and roller shade and support assembly attached at a lower window panel in accordance with the present invention;

FIGS. 11-14 are enlarged perspective views of the electrical connections made at the roller shade support and at the stop element of the window assembly of FIG. 4;

FIG. 15 is a perspective view of the assembly of FIG. 10, shown with the adhesive bead and desiccant bead disposed around the perimeter regions of the spacer element for attaching to and sealing against the upper window panel in accordance with the present invention;

FIG. 16 is a plan view of the window assembly of the present invention;

FIG. 17 is a sectional view of the window assembly taken along the line XVII-XVII in FIG. 16;

FIGS. 17A and 17B are enlarged sectional views of the ends of the sectional view of FIG. 17;

FIG. 18 is a sectional view of the window assembly taken along the line XVIII-XVIII in FIG. 16;

FIGS. 18A and 18B are enlarged sectional views of the ends of the sectional view of FIG. 18;

FIG. 19 is a sectional view of the window assembly taken along the line XIX-XIX in FIG. 16;

FIGS. 19A and 19B are enlarged sectional views of the ends of the sectional view of FIG. 19;

FIG. 20 is a sectional view of the window assembly taken along the line XX-XX in FIG. 16;

FIGS. 20A and 20B are enlarged sectional views of the ends of the sectional view of FIG. 20;

FIG. 21 is a sectional view of the window assembly taken along the line XXI-XXI in FIG. 16;

FIGS. 21A and 21B are enlarged sectional views of the ends of the sectional view of FIG. 21;

FIG. 22 is a plan view of a lower window panel of another window assembly of the present invention, showing electrical connectors or busbars established thereat;

FIG. 22A is an enlarged view of a portion of the lower window panel of FIG. 22;

FIG. 23A is a perspective view of another window assembly in accordance with the present invention;

FIG. 23B is another perspective view of the window assembly of FIG. 23A;

FIG. 24 is an underside plan view of the window assembly of FIGS. 23A and 23B;

FIG. 25 is a sectional view of the window assembly taken along the line XXV-XXV in FIG. 24;

FIGS. 26 and 27 are sectional views similar to FIG. 25 of other window assemblies in accordance with the present invention;

FIG. 28 is a perspective view of another window assembly in accordance with the present invention;

FIG. 29 is a perspective view of the window assembly of FIG. 28, with the upper window panel removed to show additional details;

FIG. 30 is an enlarged perspective view of an end of the shade roller of the window assembly of FIGS. 28 and 29;

FIG. 31 is another enlarged perspective view of the end of the shade roller of FIG. 30, with the perimeter frame element removed;

FIG. 32 is a side elevation of a laminated lower window panel suitable for use in the window assembly of the present invention;

FIG. 33 is a side elevation of a lower window panel without a dielectric layer established thereat;

FIG. 34 is a side elevation of a shade element having a dielectric layer incorporated thereon and disposed at the lower window panel of FIG. 33;

FIG. 35A is a side elevation of another shade and window panel construction of the present invention;

FIG. 35B is a side elevation of another shade and window panel construction of the present invention;

FIG. 36 is a side elevation of a lower window panel with a dielectric laminate or layer disposed thereat and adhered to a surface of the lower window panel via an adhesive that contains electrically conductive elements;

FIG. 37 is a plan view of a lower window panel for a shade element of the present invention, with charge dissipation strips disposed along the window panel;

FIG. 38A is a side elevation of a lower window panel with a shade element disposed thereat and pulled or uncoiled to at least partially uncoil the shade element along the window panel, such as during manufacture of the window assembly of the present invention;

FIG. 38B is another side elevation of the lower window panel and shade element of FIG. 38A, with the mandrel or rod around which the shade element was disposed being fixed at the lower window panel to anchor the fixed end of the shade element at the lower window panel;

FIG. 38C is a perspective view of an end portion of the shade element and mandrel or rod of FIGS. 38A and 38B, showing the attachment of the shade element at the fixed window panel in accordance with the present invention;

FIG. 39 is a side elevation of a shade and lower window panel of the present invention, with the shade coiled at each end and with the mandrels or rods at each end of the shade being rotatably drivable to move the shade in either direction to provide different shading features via a single shade element or film;

FIG. 40 is a perspective view of a lower window panel and shade element of the present invention, showing a segmented shade element that facilitates flexing of the shade element to adapt the shade element to curvatures in the lower window panel along the longitudinal axis of the coiled shade element in accordance with the present invention;

FIG. 41 is a perspective view of another window assembly of the present invention, shown with a vent patch disposed at the frame or spacer;

FIG. 42 is a perspective view of another window assembly of the present invention, shown with a threaded vent element disposed at the frame or spacer;

FIG. 43A is a perspective view of another window assembly of the present invention, shown with a bladder or pressure regulating device disposed at the frame or spacer;

FIG. 43B is a sectional view of the window assembly of FIG. 43A;

FIG. 44 is a schematic of another window assembly of the present invention, with a desiccant canister for drying air within the interpane cavity;

FIG. 45 is a sectional view of another window assembly of the present invention, shown with an expandable/collapsible frame portion;

FIG. 46 is a sectional view of another window assembly of the present invention, shown with an expandable/collapsible frame portion;

FIG. 47 is a sectional view of another window assembly of the present invention, shown with an expandable/collapsible frame portion;

FIG. 48 is a sectional view of another window assembly of the present invention, shown with an expandable/collapsible frame portion;

FIG. 49 is an exploded view of a portion of a window assembly of the present invention, showing the upper window panel with the frame portion as it is engaged with the lower window panel for attachment thereto, such as via infrared welding;

FIG. 50 is an exploded view of a portion of another window assembly of the present invention, showing the upper window panel with a portion of the frame as it is engaged with another portion of the frame at the lower window panel for attachment thereto, such as via infrared welding;

FIG. 51 is a sectional view of a portion of another window, assembly of the present invention;

FIG. 52 is a perspective view of a portion of another window assembly of the present invention, shown with a retaining device for retaining the shade film in its deployed state;

FIG. 53 is a perspective view of a portion of another window assembly of the present invention, shown with a retaining device for retaining the shade film in its deployed state;

FIG. 54 is a sectional view of another window assembly of the present invention, shown with an insert element disposed at an inner surface of the upper window panel;

FIG. 55 is a sectional view of another window assembly of the present invention, shown with an insert element disposed at an inner surface of the upper window panel and integrally formed with the spacer element;

FIG. 56 is a sectional view of another window assembly of the present invention, shown with the upper window panel molded or formed to provide a different form or curvature at its inner surface;

FIG. 57 is a sectional view of another window assembly of the present invention, shown with the upper window panel molded or formed to provide a different form or curvature at its inner surface, with a shading element laminated between the opposing surfaces of the upper and lower window panels; and

FIG. 58 is a sectional view of another window assembly of the present invention, shown with the upper window panel attached to a lower window panel laminate construction, with a shading element laminated between two panels of the lower window panel construction.

### DESCRIPTION OF THE PREFERRED EMBODIMENTS

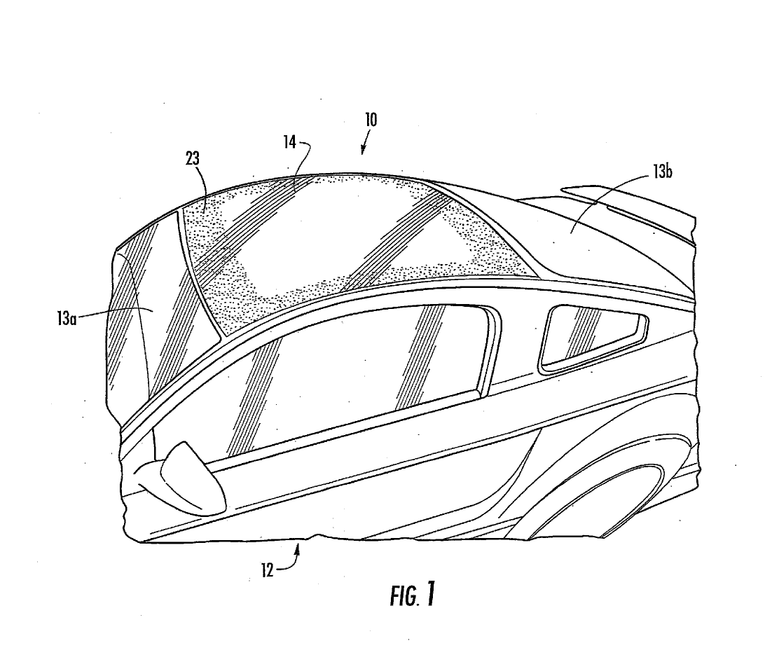

Referring now to the drawings and the illustrative embodiments depicted therein, a window assembly or module 10 (such as a sunroof or moonroof or the like or such as a side or rear window or the like) of a vehicle 12 includes an outer window panel 14 and an inner window panel 16 with a coiled shade element 18 disposed therebetween (FIGS. 1-5). In the illustrated embodiment, window assembly 10 comprises a roof module or roof window (such as a sunroof or moonroof or glass roof or the like) that is disposed between a front windshield 13a of vehicle 12 and a rear backlite or rear window 13b of vehicle 12 (such as at an opening in the roof of the vehicle or otherwise between the windshield and backlite of the vehicle, such as by utilizing aspects of the glass roof assembly described in U.S. patent application Ser. No. 11/933,699, filed Nov. 1, 2007 and published May 8, 2008 as U.S. Pat. Publication No. US-2008-0106124, which is hereby incorporated herein by reference in its entirety). The coiled shading element 18 is coiled or retracted to an open or non-shading position, and may uncoil or extend across the window assembly to a closed or shading position, such as in response to a user input or the like, as discussed below. The window module or window assembly 10 has an outer window panel 14 (or upper panel for the roof window application) that has greater cross dimensions than the inner panel 16 (or lower panel for the roof window application), and provides a uniform or flush outer panel at the exterior surface of the vehicle sheet metal and/or front windshield and rear backlite, as also discussed below. The outer and inner window panels 14, 16 of window module or window assembly 10 may have different contours or curvatures (and thus define or establish a non-uniform spacing or cavity therebetween), and thus may provide enhanced matching or correspondence with the contours of the respective surfaces of the vehicle sheet metal and/or front windshield and rear backlite and of the interior or in-cabin roof liner or headliner, as also discussed below. The window assembly may utilize aspects of PCT Application No. PCT/US2011/033515, filed Apr. 22, 2011 and published Oct. 27, 2011 as International Publication No. WO 2011/133830, which is hereby incorporated herein by reference in its entirety.

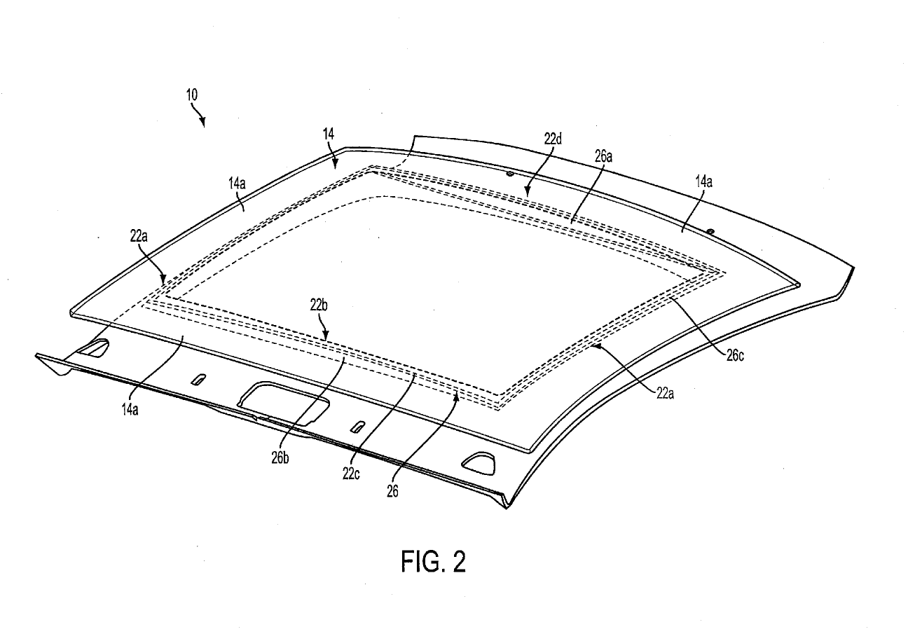

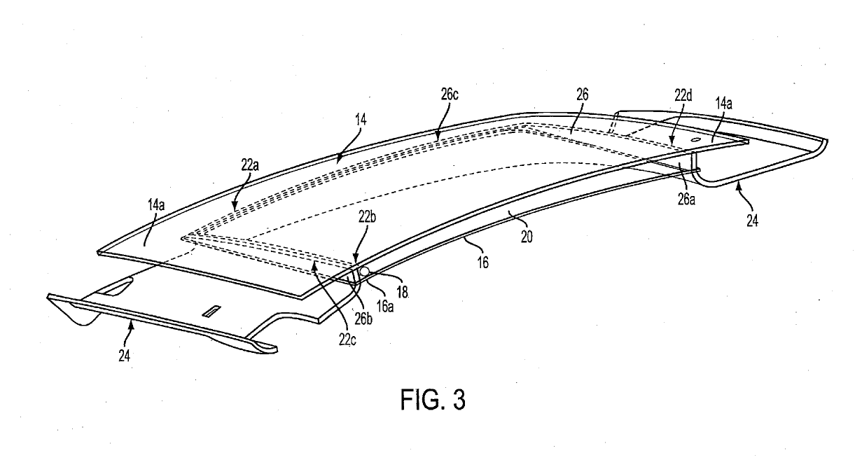

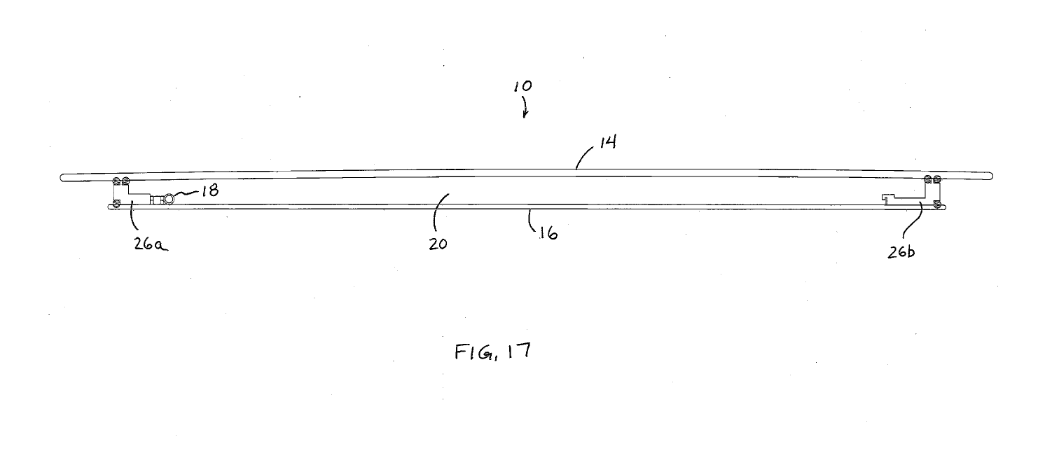

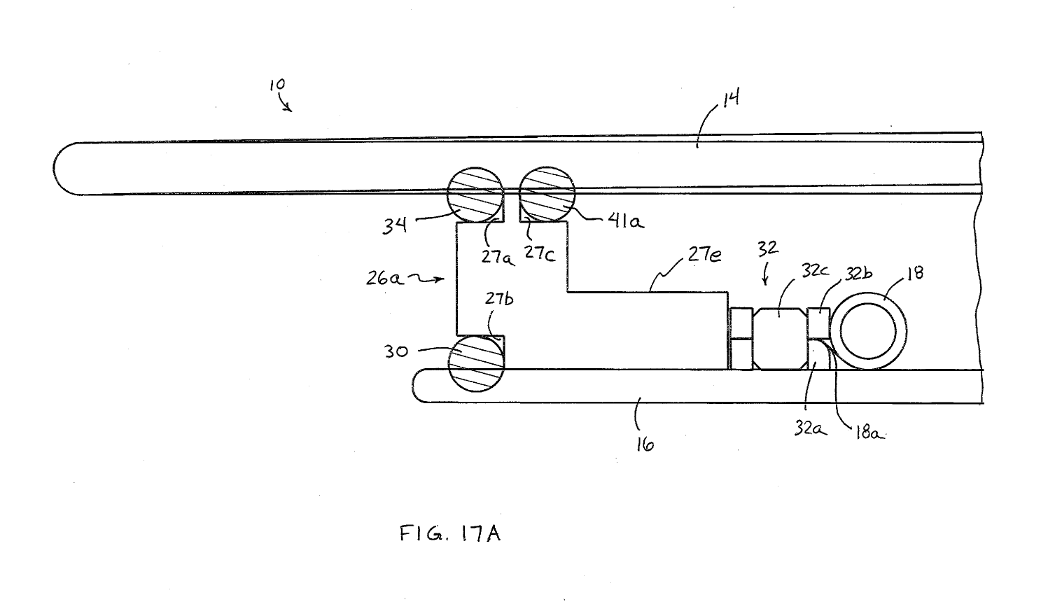

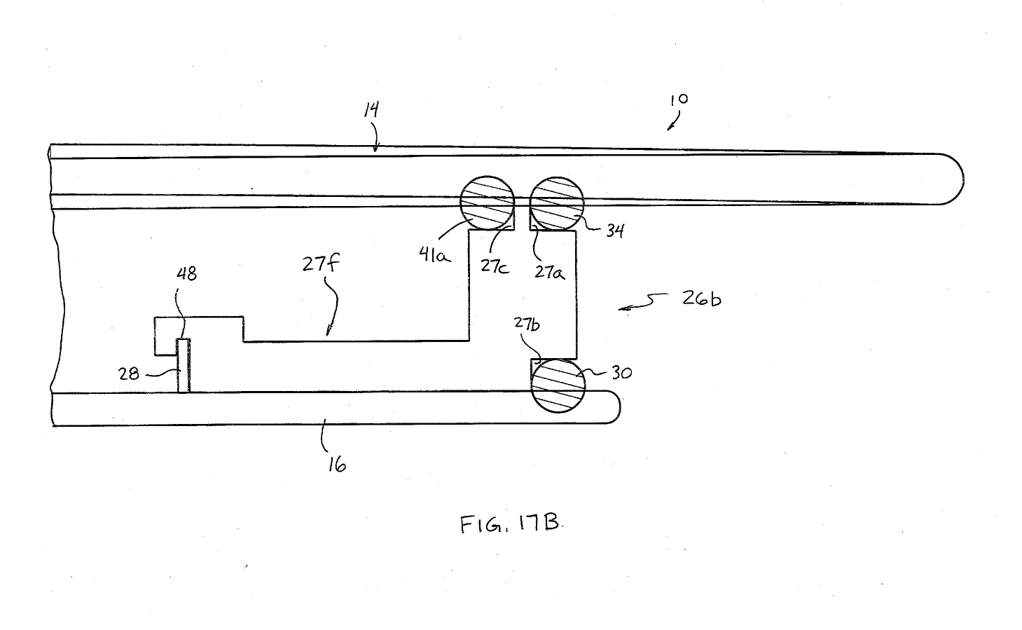

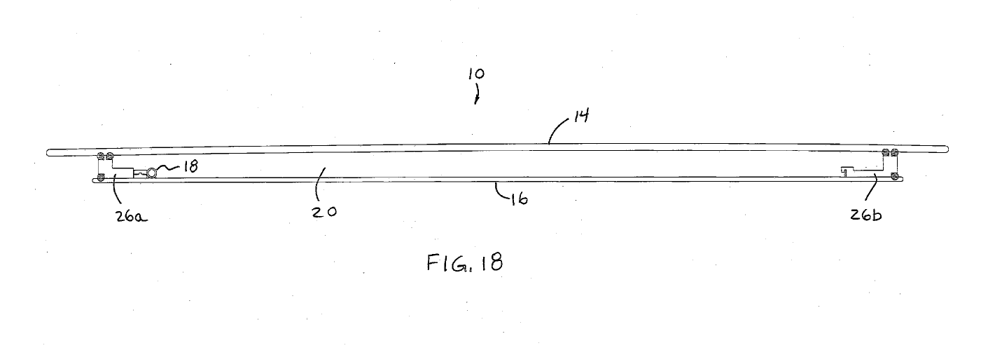

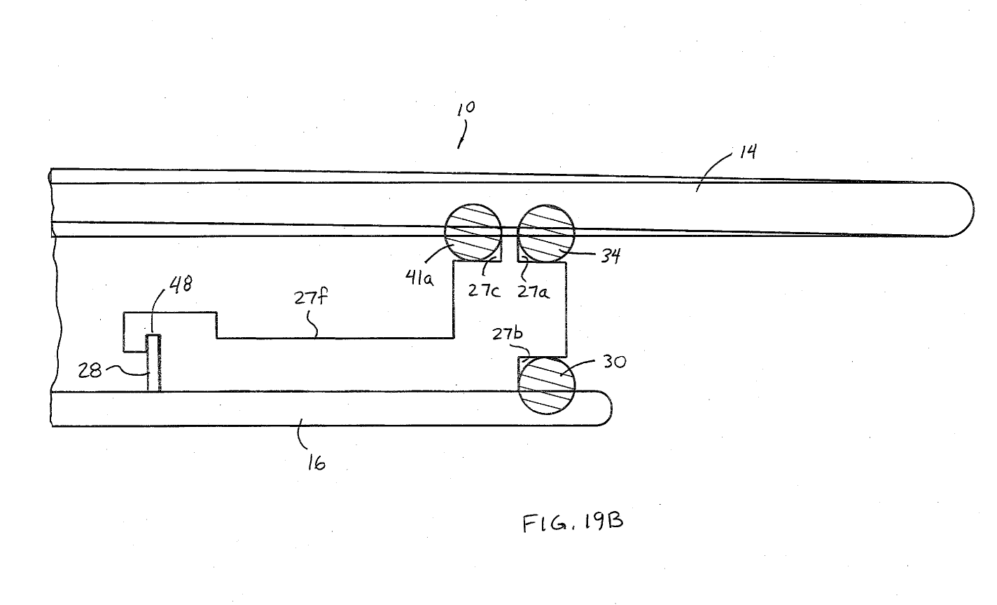

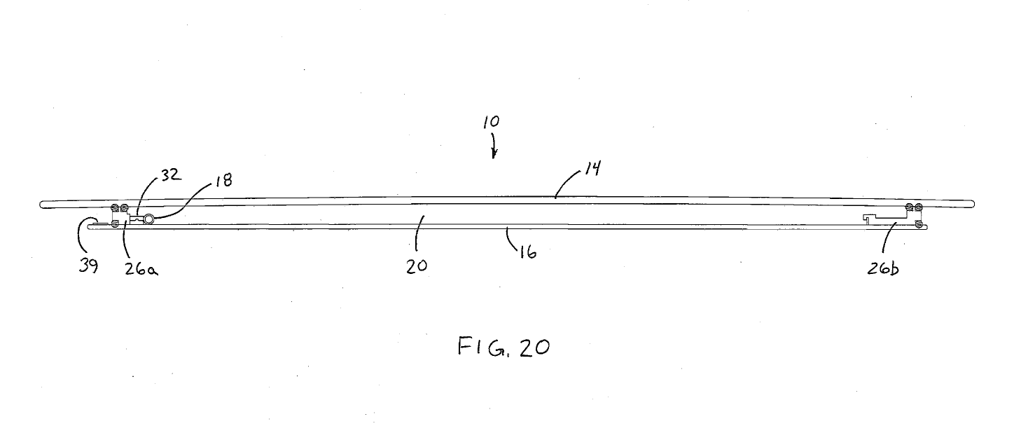

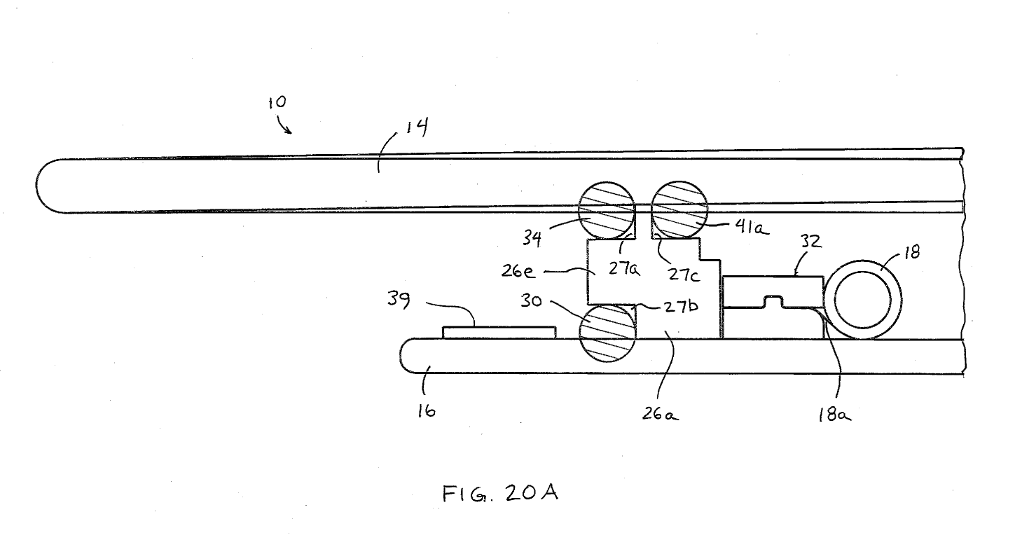

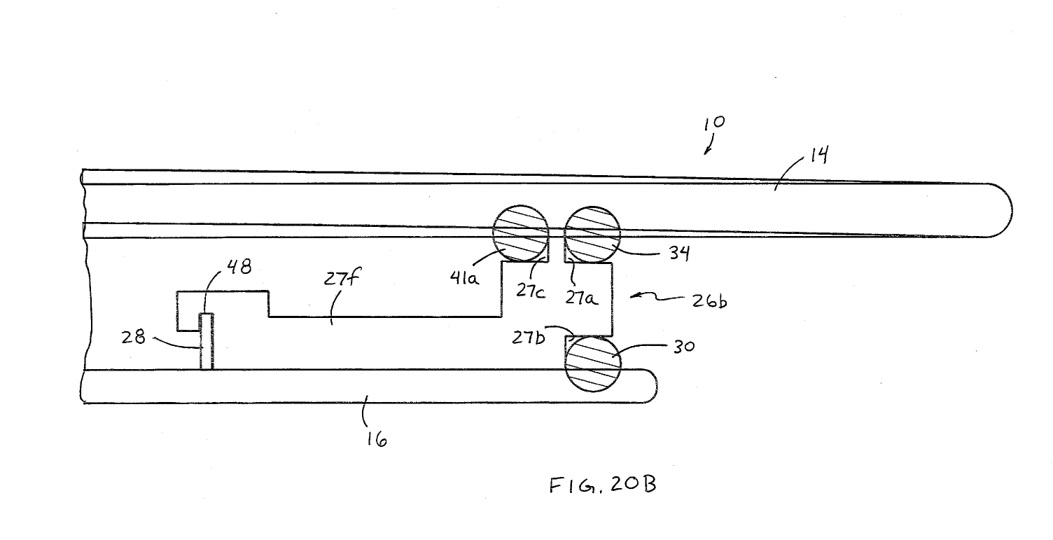

As shown in FIGS. 2 and 3, window panels 14, 16 are spaced apart to define an interpane cavity 20 therebetween, within which the shade element 18 is disposed. Window panels 14, 16 may comprise any suitable materials or panels, such as transparent glass panels, such as tempered glass panels or laminated glass panels or the like, and optionally may comprise glass panels with a low-‘E’missivity coating or treatment, such as on a surface of the panel or panels that faces the cavity 20. As best shown in FIGS. 3 and 17-21, the thickness or spacing dimension of the cavity 20 varies across the window assembly, such that the window panels 14, 16 may have different curvatures or profiles to conform with the inner roof or headliner contours and the outer roof or sheet metal contours, in order to provide an aesthetically pleasing appearance at the interior and exterior of the vehicle. In the illustrated embodiment, the side perimeter regions 22a of the window assembly 10 have a narrowed cavity thickness or depth, with the cavity thickness (or separation distance or gap between the window panels 14, 16) increasing towards its largest gap dimension at about the lateral center region 22b (between the side perimeter regions) of the window assembly. Thus, the shade element 18 is configured to be narrow enough or low profile enough to move along the side perimeter regions 22a (such as from the rear perimeter portion 22c towards the front perimeter portion 22d or vice versa) between its open and closed or shading positions. The profile of the window assembly may vary between the rear and front perimeter portions 22c, 22d, such that the cavity thickness increases towards its largest gap dimension at about the longitudinal center region (between the front and rear perimeter regions) of the window assembly. Clearly, other profiles may be envisioned that would have a varying gap between the panels with the largest gap dimension or dimensions at different locations between the front and rear perimeter portions and/or the side perimeter portions, while remaining within the spirit and scope of the present invention.

In the illustrated embodiment, and as shown in FIGS. 2, 3 and 17-21, outer window panel 14 has larger cross-dimensions than inner window panel 16, such that the perimeter regions of outer window panel 14 extend beyond or overhang corresponding perimeter regions of inner window panel 16. The overhang regions may extend along one or more of the perimeter edges of the window assembly. The degree of overhang (or overhang dimension) of the outer window panel relative to the inner window panel may vary depending on the particular application (such as on the sheet metal opening of the vehicle and curvature of the vehicle body or roof and the headliner shape and contours) and desired mounting surfaces and appearances of the window assembly and vehicle. For example, for flatter or more planar window applications, a smaller or reduced overhang region or regions may be appropriate, but for applications with a greater curvature of the window panel or panels, a greater overhang dimension or dimensions may be appropriate. The overhanging perimeter regions 14a of outer window panel 14 (and a portion of the window panel inboard of the overhang regions) may have a darkened layer or hiding layer 23 (such as a ceramic frit layer or the like) established thereat (such as at an inner or lower surface of the outer window panel) to substantially hide or conceal or render covert the vehicle frame or sheet metal 24 at which the window assembly is mounted and the perimeter sealing and/or spacing element 26 and the coiled shading element 18 (when in its coiled or retracted state).

Optionally, the inner and outer window panels may have similar or the same cross-dimensions (without overhang regions), depending on the particular application of the window assembly. In such a non-overhang application, the perimeter regions of the outer window panel may have a darkened layer or hiding layer (such as a ceramic frit layer or the like) established thereat (such as at an inner or lower surface of the outer window panel) to substantially hide or conceal or render covert the vehicle frame or sheet metal at which the window assembly is mounted and the perimeter sealing and/or spacing element and the coiled shading element (when in its coiled or retracted state) sandwiched between the window panels and within the interpane cavity of the window assembly.

The window panels 14, 16 of window assembly are spaced apart and joined together via a sealing element or spacer element or spacing frame 26 that is disposed at and around the perimeter regions of the upper or cavity facing surface of the inner window panel 16. The outer window panel 14 is attached, at spacing element 26, with the spacing element 26 engaging the cavity facing surface of the outer window panel 14 inboard of the perimeter edges of the outer window panel. Thus, the spacing element 26 functions to space the window panels 14, 16 apart from one another (to establish the interpane cavity 20) and to secure or join the window panels together to form the double pane window assembly 10.

The form or profile of the spacing elements and thus of the gap or interpane cavity may vary depending on the particular application and differences between the exterior surface contour or profile of the vehicle and the interior surface contour or profile of the vehicle. It is envisioned that the minimum gap must be at least large enough to receive the coiled shade element along the perimeter region at which the coiled shade element is located. The gap or spacing distal from or remote from that perimeter region may be reduced since it may only have to provide clearance for the shade film or element in its uncoiled or partially or mostly uncoiled state. For example, the gap or spacing dimensions of the interpane cavity may vary from a minimum of approximately 1 mm or thereabouts (or more or less) to a maximum of about 10 mm or thereabouts (or more or less), depending on the particular application of the window assembly. Optionally, it is envisioned that the window panels may have similar or the same curvatures or profiles such that the gap dimensions are substantially constant or uniform between the window panels, such as for applications where the outer surface of the vehicle is similar to or has a similar profile or contours as the inner surface or in-cabin surface of the vehicle at the location at which the window assembly is mounted.

As can be seen with reference to FIG. 1, the outer surface of the outer window panel 14 may be generally flush with the outer or exterior surface of the sheet metal and/or window panels and/or exterior trim panels or headers of the vehicle to provide a uniform or flush mounted roof window module or the like (such as a side window panel or windshield or backlite or the like). The lower surface of the outer window panel may be adhered or bonded to one or more flanges or attachment surfaces of the vehicle sheet metal or frame or structure, while the inner window panel may generally hang from the outer window panel (for vehicle roof applications) and may also be attached to or engaged with one or more interior trim elements within the vehicle cabin and along the ceiling of the vehicle cabin. As best shown in FIG. 3, the in-cabin surface of the inner window panel 16 may engage and/or be supported at the vehicle sheet metal 24 or other mounting structure to attach the window assembly at the vehicle. The window module may utilize aspects of the window modules described in U.S. patent application Ser. No. 11/933,699, filed Nov. 1, 2007, and published May 8, 2008 as U.S. Patent Publication No. US-2008-0106124, which is hereby incorporated herein by reference in its entirety.

Optionally, and desirably, shade element 18 comprises a conductive shade element, such as an electro-polymeric or metalized polymeric shade element or film or the like, that has a thin rolled up or coiled conductive film, such as a metalized polymeric film or the like, that is responsive to electrostatic action, and that unrolls when a voltage is applied thereto, such as by utilizing aspects of the insulated glazing units described in U.S. Pat. No. 7,645,977, which is hereby incorporated herein by reference in its entirety. The coiled film is coiled or retracted to an open or non-shading position in the absence of a voltage applied thereto, and may at least partially uncoil or extend across the window assembly to a closed or shading position or partially shading position responsive to a voltage applied thereto.

For such an electro-polymeric shade element, the glass window panels may comprise low-‘E’missivity glass and a dielectric polymer may be laminated on or otherwise applied to the low-E surface (the surface facing the cavity) of the lower panel 16 to act as a dielectric between the low-E surface and the retractable coiled-up electrode or shading element (optionally, the dielectric polymer and the shading element may be disposed at the cavity facing surface of the upper or outer window panel while remaining within the spirit and scope of the present invention). A strip of the low-E surface along one of the perimeter edge regions (such as the rear or front perimeter edge region for the roof module or roof window assembly and/or such as a lower perimeter edge region for a side or rear or front window assembly) of the inner or smaller window panel 16 may be exposed (i.e., not coated with the dielectric polymer) around the perimeter of the window panel 16 (or at least at and along the forward and rearward perimeter regions for a shading element that opens and closes in a fore/aft direction with respect to the vehicle, such as shown in FIG. 3, or at and along the lateral or side perimeter regions for a shading element that opens and closes in a cross-car direction with respect to the vehicle) to provide an exposed or non-dielectric-coated strip or region of the window panel on which to attach a lead wire of the shield or shading element. Optionally, it is envisioned that the dielectric laminate on the inner glass surface may be eliminated by establishing a conductive coating on the opposite side (the side not touching the inner glass surface) of the shade element or film.

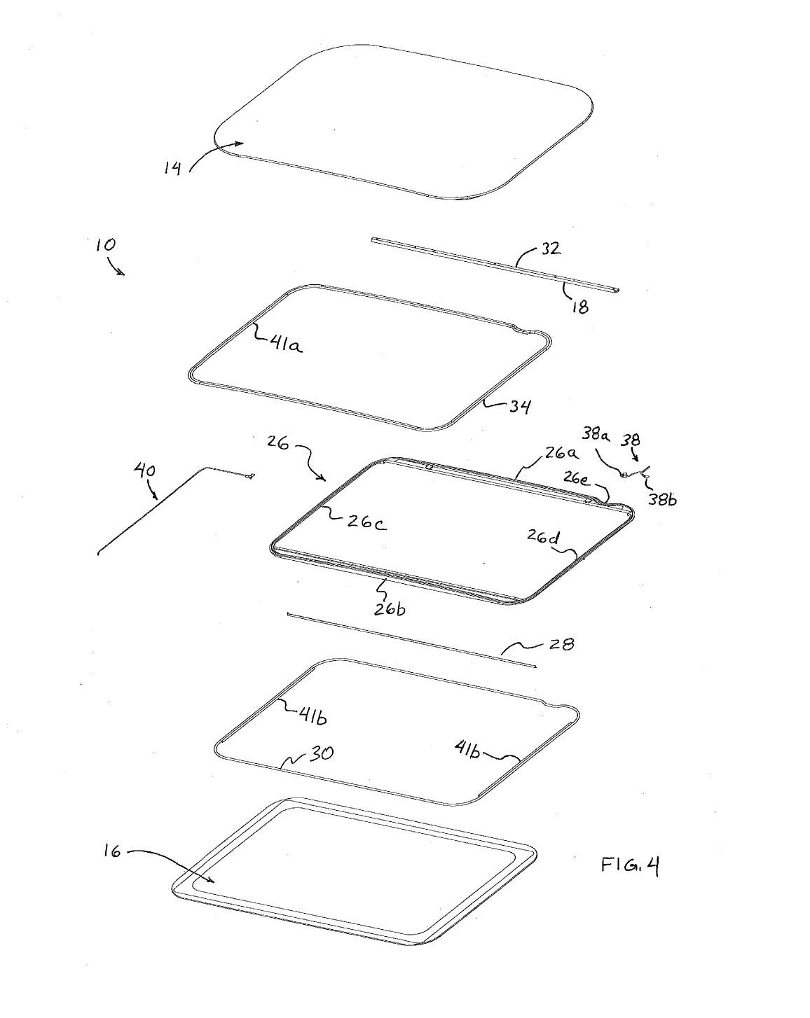

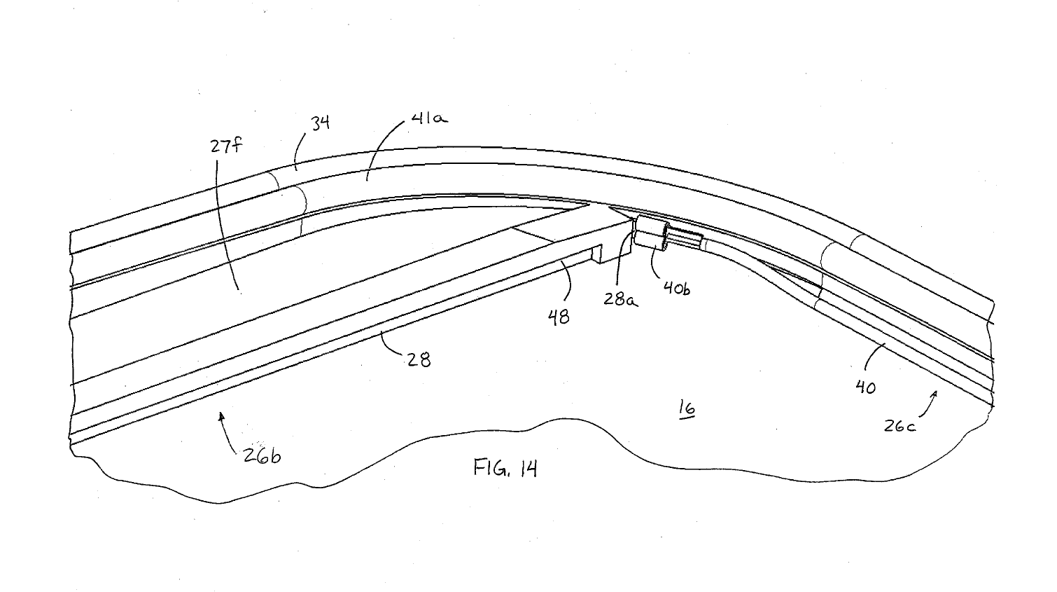

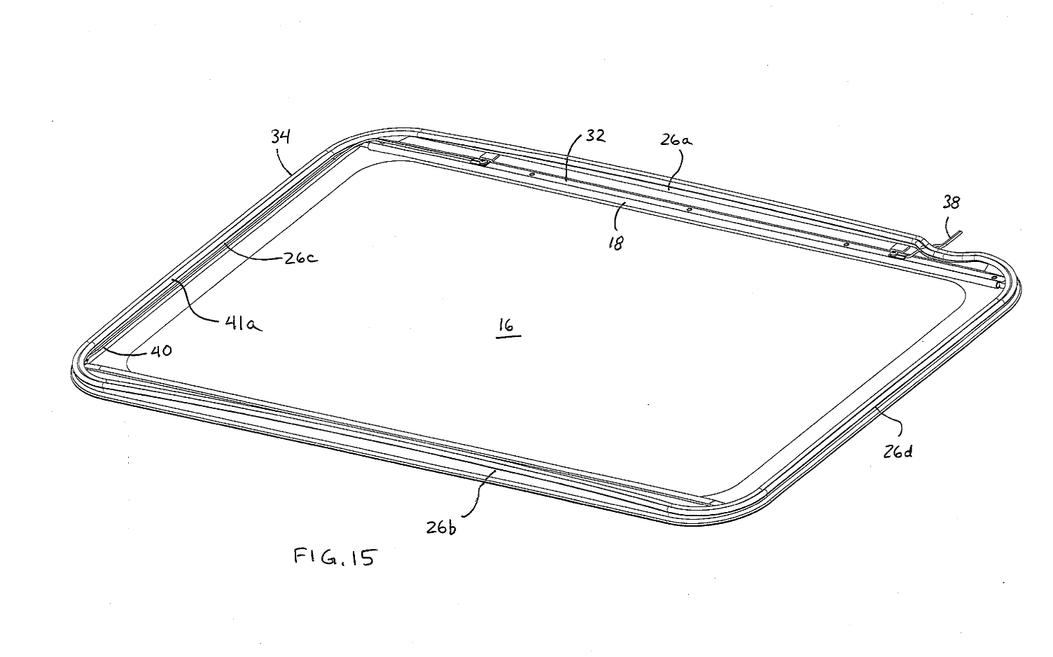

Optionally, and as shown in FIGS. 4, 14 sand 17-20, an end stop or roll stop or stop element 28 (such as an electrically conductive element or strip, such as a metallic plate or bar or wire or element, such as an aluminum rectangular wire or element or the like, or such as a metal-coated plastic or polymeric element, or such as a conductive tape or coating applied at the spacing element or the like) may be disposed at an opposite side portion of the spacing element 26 and at and along a perimeter region of the window panel opposite from where the coiled conductive or metalized polymeric film is disposed. The electrically conductive roll stop or element may comprise any suitable electrically conductive material and may be flat and/or hollow or solid or the like, while remaining within the spirit and scope of the present invention. The roll stop is disposed at and along an opposite side of the perimeter seal from the exposed or non-coated strip or perimeter region of the window panel. The end stop or metallic wire limits or substantially precludes contact of the uncoiled end of the polymeric shade element or film with the dielectric surface of the panel to facilitate faster response times when the shade element is being retracted or recoiled towards its non-shading or coiled position. The end stop 28 functions to help align the unrolled end of the film when it is fully unrolled or deployed and also discharges the unrolled film when the film contacts the end stop 28. The end stop may comprise a metallic material or other suitable material or suitable conductive material, and may be plastic coated or the like, such as coated with a low dissipation factor polymer, such as, for example, polypropylene, fluorinated ethylene propylene (FEP) or polytetrafluoroethylene (PTFE) or the like.

At and along the perimeter region where the coiled shade element or film is attached (such as at the rear perimeter region 16a of the inner or lower window panel 16), a copper tape (or other suitable metallic or conductive element) may be adhered (such as via a conductive adhesive or the like) at a perimeter edge region of the window panel. The copper tape may be adhered to the window panel or substrate inboard of the spacing element 26, and the coiled shade element and/or its support element may be disposed at and/or adhered at the copper strip or tape and at the window panel inboard of the spacing element, such as via a conductive epoxy or paste or the like.

In the illustrated embodiment, the in-cavity surface of the inner or lower window panel is coated with a conductive coating or layer, such as a transparent conductive coating such as indium tin oxide or the like. The coiled film or shade element comprises a conductive film (such as a metalized polymeric film or the like) and has a conductive or metallic side of the film facing the coated surface of the window panel to which it is attached. The metalized polymeric film is coiled and disposed at the window panel with its metal side or surface at the outside diameter of the rolled or coiled film. The film may be cut or formed to the desired width and length and may be tightly wound on mandrels or rods, and then heat soaked in an oven to establish the coiled-up electrode and to further contract the wound film tighter. The mandrel may be removed from within the coiled film prior to attaching the coiled film to its support element or structure (discussed below) and/or prior to attaching the coiled film at the window panel.

The coiled film and/or its support structure or element may be fixtured and bonded along an inboard portion of the spacing element or frame 26. During operation of the roller shade, a voltage may be selectively applied (such as in response to a user input or control signal or the like) between the conductive roller shade and the conductive coating or layer during operation of the roller shade. For example, an electrical wire or lead may be connected to the conductive coating and another electrical wire may be connected to the roller shade (such as to the anchor element or bar at which the roller shade is attached), such that, when power is applied (and a voltage difference is generated between the roller shade and the conductive coating), the roller shade may unroll towards its closed or uncoiled state, and when power is stopped or no longer applied, the roller shade may be coiled or rolled up to its open or coiled state along the perimeter portion of the spacing element or frame.

In order to limit the energy or voltage required to operate the shade and particularly to limit or reduce the energy required to maintain the shade in its deployed position or state, it is envisioned that the window assembly may include a mechanical latch or stop or catch at or near the roll stop to engage the substantially unrolled uncoiled film and hold or retain an end roll portion of the substantially unrolled or uncoiled film, such that the voltage may be reduced or deactivated when the shade film is uncoiled yet the shade film may remain in its uncoiled or shading state. For example, and as shown in FIG. 52, a mechanical stop or arm 19′ may extend (such as via a motorized extension or the like) inward from one or both sides of the frame or spacer (not shown in FIG. 52) and retain or hold the end coil 18b′ of shade film 18′ (such as a permanent end coil at the end of the film when the film is uncoiled, such as a coiled end that is formed by having the end edge 18c′ of the film 18′ coiled over and adhered to the film in a coil shape at the end of the uncoiled film that contacts the end stop 28′) and limit recoiling of the film even when the voltage is reduced or stopped. The mechanical stop 19′ may be extendable responsive to a position sensor 21′ or the like that detects the film and determines when the shade is fully deployed to the end stop 28′.

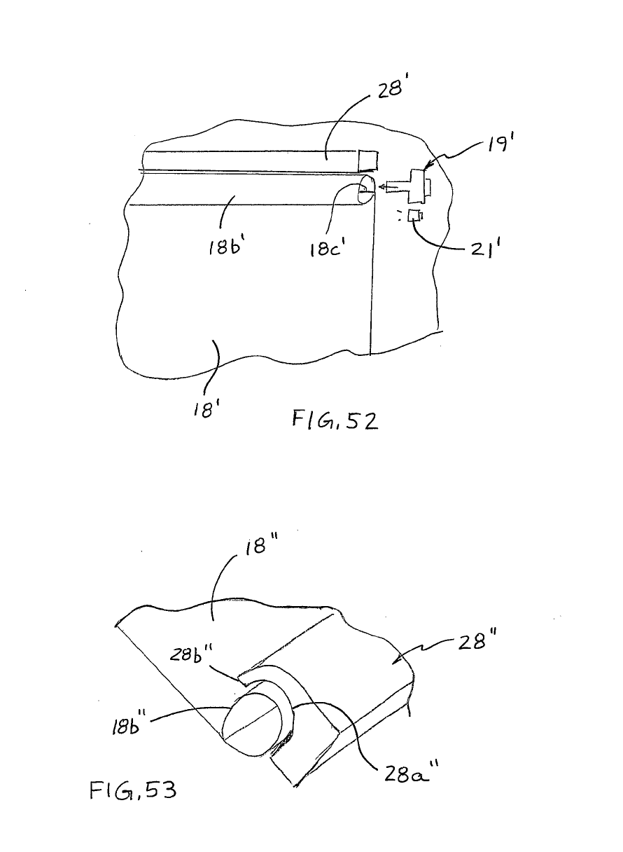

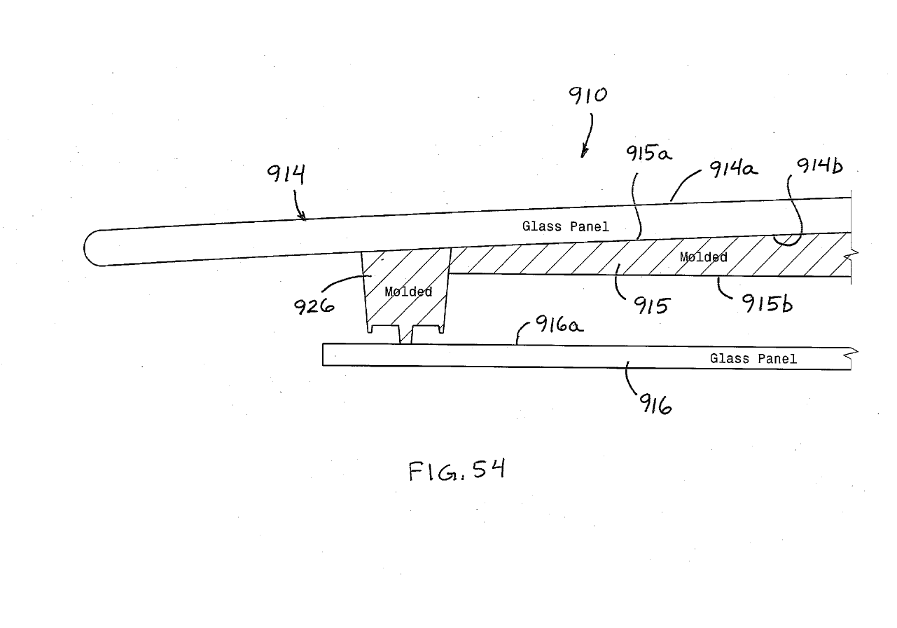

Optionally, and with reference to FIG. 53, the end stop 28″ may be formed to receive the end coil 18b″ of shade film 18″ at least partially therein, such as by having a receiving portion 28a″ that has a lower or narrower entry (defined between the glass surface and a lip or edge 28b″ of receiving portion 28a″) such that, when shade film 18″ is deployed, the end coil 18b″ is urged through the entry and into the receiving portion. When the deployment voltage is reduced, the end coil 18b″ is substantially retained at the end stop 28″. When the shade is to be retracted, the end stop 28″ may release the end coil, such as by pivoting or moving the entry edge slightly away from the glass surface to allow for the coil to retract or by otherwise urging the coil towards its retracted state. Clearly, other means for retaining the end coil of the shade film at or near the end stop when the voltage is no longer applied (or applied at a reduced level) may be implemented while remaining within the spirit and scope of the present invention.

Thus, when the shade is fully extended or uncoiled, the window assembly may automatically mechanically retain the shade film in its uncoiled state (such as responsive to a sensor at or near the roll stop that detects when the film is fully uncoiled). Optionally, a lower or reduced voltage may still be applied to the film and the conductive layer (such as a transparent conductive layer such as an ITO layer or the like) to assist in maintaining the shade flat on or uniformly drawn to the lower window panel (such as a reduced voltage that would not be powerful enough to keep the film in its uncoiled state without the assistance of a mechanical retainer, but that is powerful enough to draw the film substantially uniformly flat and tight against the window panel to avoid any wrinkles or curling of the shade film when in its shading or extended state). Thus, the shade element may be deployed or uncoiled when a high voltage is applied and then mechanically retained at its deployed state and held tight at the glass with a reduced or low voltage applied to the film and the conductive layer.

In the illustrated embodiment, and as best understood with reference to FIG. 4, the spacing element or frame 26 is adhered to the lower or inner window panel 16 (which may include an opaque or substantially opaque coating or layer, such as a ceramic frit layer or the like disposed or established about its periphery where the spacing element is attached), such as via an adhesive bead 30, with the spacing element 26 receiving or retaining the end stop 28 at the lower window panel 16 and along its perimeter portion 26h opposite from its perimeter portion 26a where the roller shade 18 is disposed in its unrolled state. The roller shade 18 is attached at or mounted to a support or anchor element 32 (discussed below), which in turn is mounted at or received at and along portion 26a of spacing element 26, such that the roller shade is disposed at the inner surface of the lower window panel 16. The upper or outer window panel 14 is adhered or attached at the upper perimeter of the spacing element 26 via an adhesive bead 34 or the like to assemble the window assembly and sandwich the spacing element 26 between the window panels 14, 16, with the roller shade disposed at the inner surface (facing the cavity) of the window panel 16.

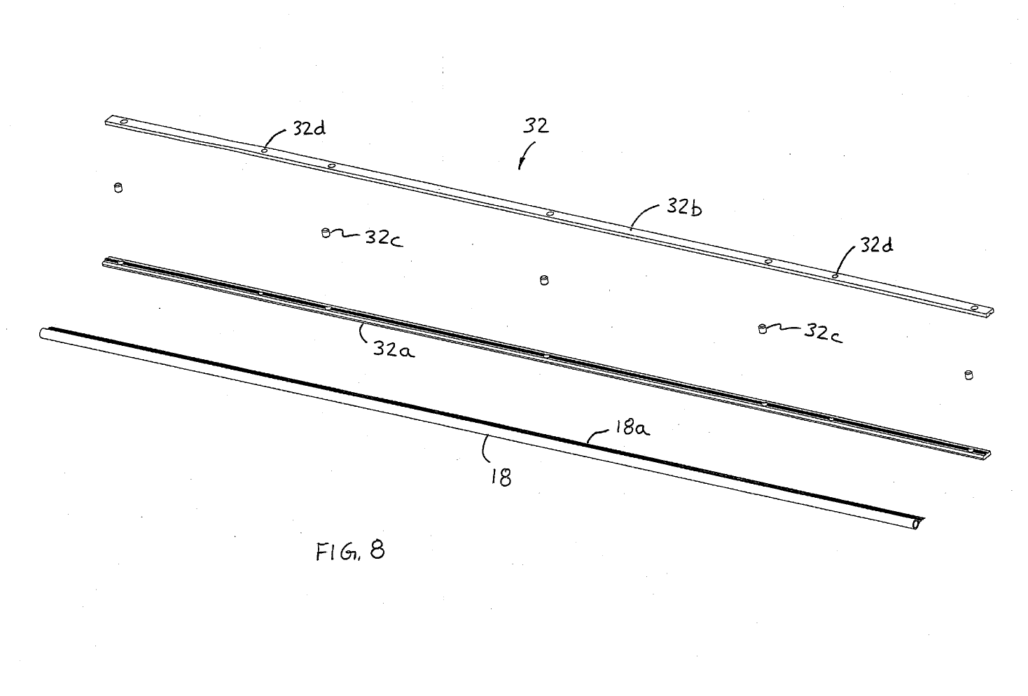

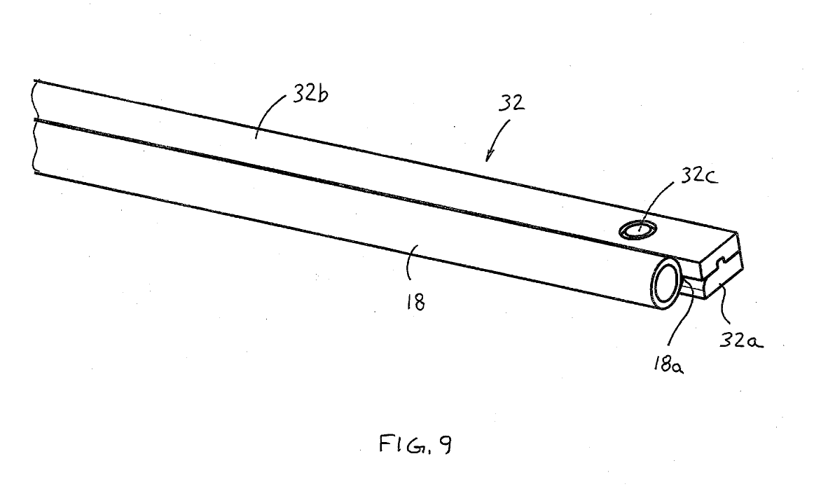

In the illustrated embodiment, the roller shade 18 is attached to and along an elongated support or anchor element 32, which may be generally or substantially rigid to provide support for the roller shade during manufacture of the window assembly. As shown in FIGS. 8 and 9, the roller shade 18 may be coiled and have a base end or mounting end 18a that is received between a pair of support strips or elements 32a, 32b. The support strips 32a, 32b may be secured or retained together to attach the end 18a of the roller shade 18 to the support element via any suitable means. In the illustrated embodiments, a plurality of press pins 32c may be used to retain the strips 32a, 32b together when they are pressed together with the end 18a of roller shade 18 therebetween, and optionally, with the mating surfaces of the strips 32a, 32b having an non-planar form (such as shown in FIG. 9) so as to crimp or bite or otherwise substantially engage the end 18a of the roller shade 18 to limit retraction of the end 18a from the support element 32. The support element may comprise any suitable material, such as metal or plastic materials, and may be attached to the roller shade via any suitable attachment means (such as, for example, fasteners or press pins or the like, or such as a snap together configuration of the two strips or such as a clamshell configuration of two portions with a living hinge type of joint to allow the two strips to fold over one another and clasp together with the end of the roller shade clamped therebetween, and/or the like).

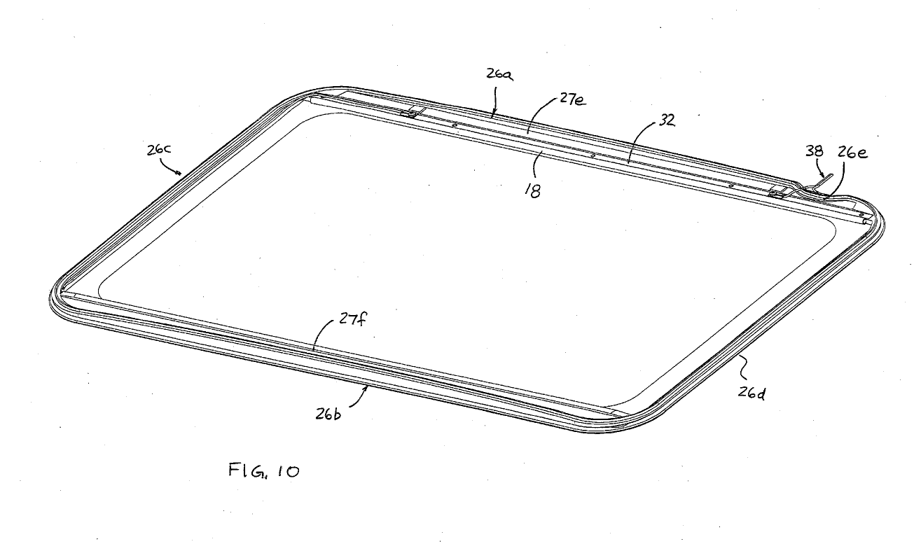

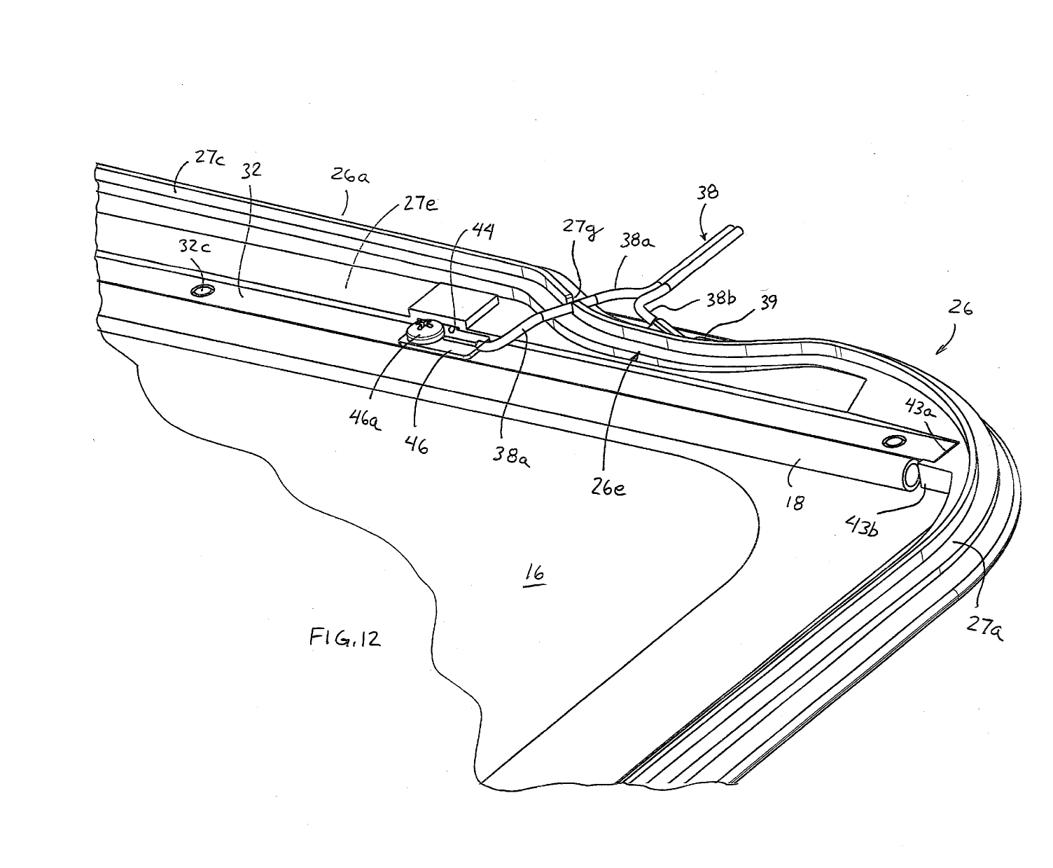

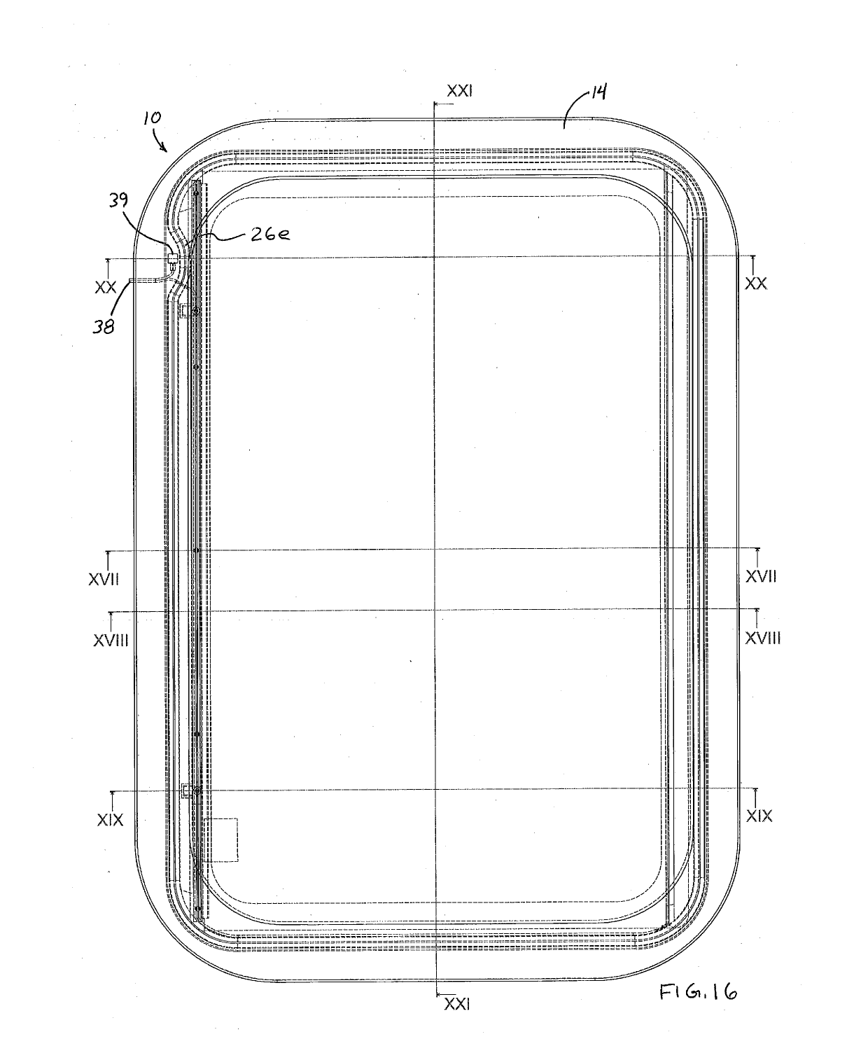

As shown in FIG. 9, the length of the roller shade 18 may be shorter than the length of the support element 32, so that the ends of the support element extend longitudinally beyond the ends of the roller shade 18 so as to be received in mounting portions of the spacing element or frame 26, as discussed below. The strips 32a, 32b may include an electrical connection portion 32d for electrical connection to a wiring harness or wiring lead 38 (FIGS. 4, 10 and 12) to provide power and control to the roller shade 18. The electrical connection to the roller shade may be accomplished via any suitable means, such as, for example, via a wire or lead 38a of a wiring harness 38 extending through a hole or aperture 32d through one of the strips (or electrically connecting to a fastener or conductive element that extends through the hole or aperture) so that the electrical lead 38a can electrically conductively contact or connect to the end or base strip 18a of the roller shade 18 and/or can contact an electrically conductive strip extending along one or both strips or insert molded along one or both of the strips to power or substantially uniformly power the end 18a of the roller shade 18 along its length, or such as via any other suitable powering connection, while remaining within the spirit and scope of the present invention. As shown in FIGS. 12, 16, 20 and 20A, another lead or terminal 38b of wiring harness 38 may be electrically connected at connecting portion or pad or terminal 39 at a conductive coating on the surface of window panel 16 (such as a transparent conductive coating over the surface of the window panel), such as via any suitable electrically conductive connection, such as, for example, a solder connection, adhesive connection, conductive adhesive or conductive epoxy connection, or other connecting means or fastening means, which may electrically connect the lead to the transparent conductive surface or to a silver pad or the like screened onto the surface or the like. In the illustrated embodiment, the electrical connector pad 39 is disposed at a surface of the window panel 16 near its perimeter region and at a portion 26e of the spacing element 26 where the spacing element is narrowed to provide a larger surface area of the window panel outboard of the spacing element to ease the connection process and enhance the electrical connection at the connector pad. Optionally, another wiring element or lead 40 may be electrically connected to another electrical connection portion 32d of support element 32 and may provide electrical power from the roller strip to the end stop 28, as discussed below. Thus, the support element 32 may be attached at the spacing element 26 (as discussed below) and the roller shade may be electrically connected to a wiring harness or lead when the roller shade and support element are attached at the spacing element (with the wiring harness being electrically connectable to a vehicle wiring harness and thus to the power source of the vehicle when the window assembly is normally mounted in a vehicle.

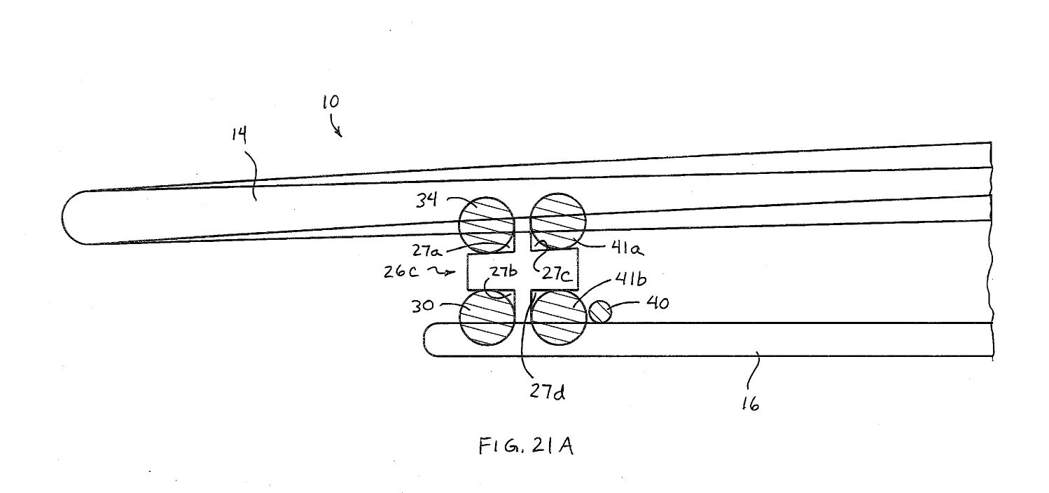

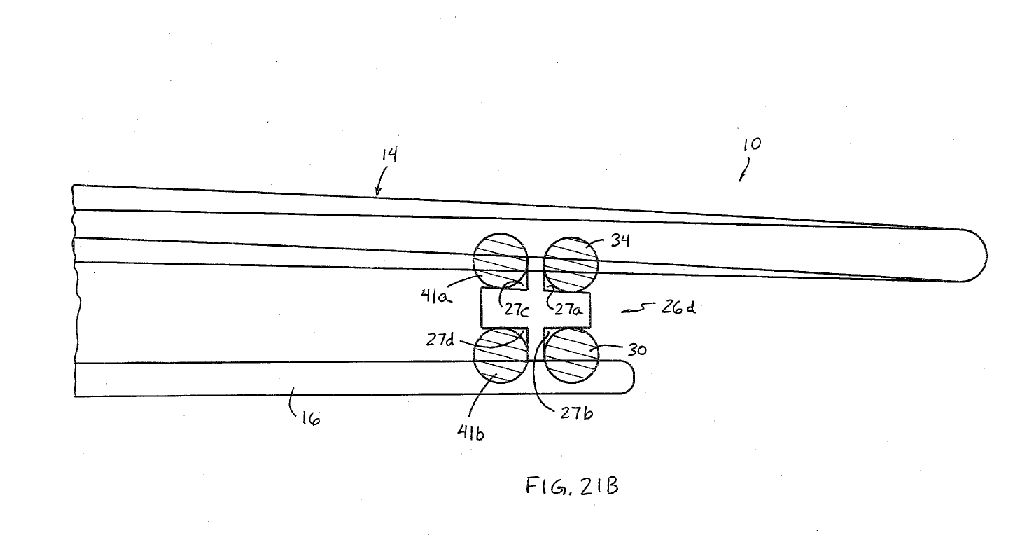

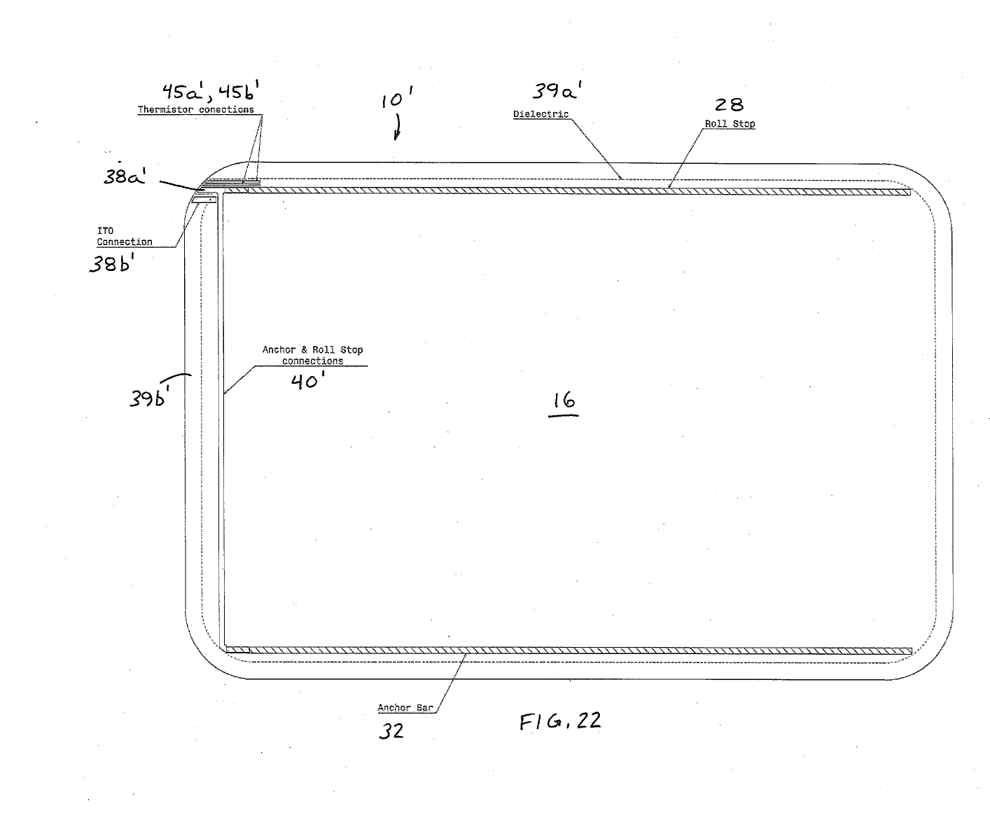

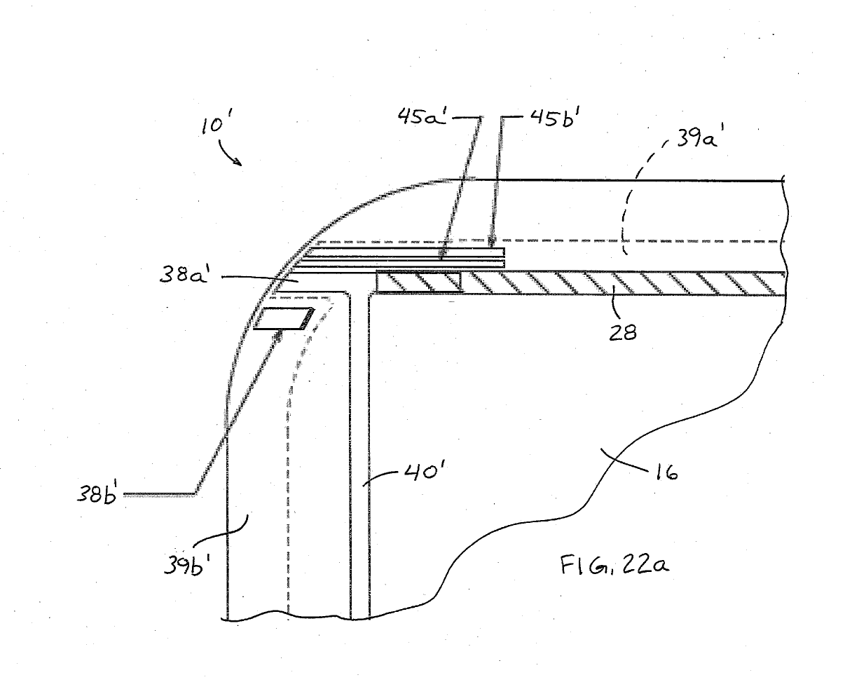

Optionally, the electrical connections to the roll stop and anchor element or bar and to the conductive coating (such as ITO or the like) at the window panel surface may be established via any suitable electrically conductive means. For example, and with reference to FIGS. 22 and 22A, the electrical connectors or contacts 38a′, 38b′ may comprise screened on or deposited busbar connections at or near a perimeter region of the window panel 16. In the illustrated embodiment, the electrical connector or busbar 38a′ is electrically conductively connected to the roll stop 28, and an electrically conductive strip or layer 40′ extends from busbar 38a′ and/or roll stop 28 to the anchor bar or element 32, in order to provide electrical connection to the roll stop and the anchor bar. The electrical connector or busbar 38b′ is disposed or established at the conductive coating 39b′ (such as an ITO coating or the like) and not at the dielectric coating or layer 38a′, in order to provide electrical connection to the transparent electrically conductive layer or coating 39b′ at the surface of the window panel 16. The busbars 38a′, 38b′ and conductive strip 40′ may be established at the window panel via any suitable means, such as via screen printing an electrically conductive material at the window panel. The conductive contacts or busbars may be separated from one another and electrically isolated from one another (such as via isolation lines established through the conductive coating material or the like). Thus, electrical power may be electrically connected to the roll stop and the anchor element and to the transparent conductive coating via electrically connecting an electrical connector (such as a clip or the like) to the busbars 38a′, 38b′, such as by clipping or soldering or otherwise attaching/connecting an electrical connector at or to the busbars 38a′, 38b′.

Optionally, and as also shown in FIGS. 22 and 22A, the window assembly 10′ may include a thermistor or temperature sensor for detecting the temperature of the window assembly, such as the temperature within the interpane cavity of the window assembly or the like. The temperature sensor is electrically connected to a pair of thermistor connections or contacts or busbars 45a′, 45b′, which may be accessible at the periphery of the window panel (such as in a similar manner as the busbars 38a′, 38b′, discussed above).

The thermistor is operable to detect the temperature within the window assembly. Optionally, a control of the window assembly may be responsive to an output of the thermistor to determine an appropriate voltage to apply to deploy the film coil. For example, when the temperature drops, the voltage required to provide a generally constant deploy rate of the shade increases. Thus, the control or controller operates to provide the appropriate voltage and varies the voltage responsive to variations in the temperature in the window assembly.

Optionally, the window assembly or shade system may include a position-sensor that is operable to detect the position of the shade as it is deployed (such as by detecting when the coil reaches a predetermined location during deployment and knowing the time elapsed from the application of the voltage to the time that the coil reaches the predetermined location), and can thus detect the speed of the film coil as it is extending or uncoiling. If the detected rate of deployment is too slow, the controller may increase the voltage applied at the film to increase the deployment rate to be within the desired range of deployment rates.

Optionally, the controller may be responsive to a position or rate sensor for determining faults or failure modes of the window assembly or shade system. For example, if the deployment rate is slower than a threshold level and the controller increases the voltage to speed up the deployment rate, but the rate does not increase an appropriate or expected amount, the system may determine that there is a failure or fault with the shade system. Optionally, the controller may be responsive to both a thermistor and a position or rate sensor, and if the determined deployment rate is not within a particular range or threshold level for a given or determined temperature, the controller and system may determine that there is a failure or fault with the shade system. Thus, for a system with a thermistor and position or rate sensor, the system can readily detect if the shade uncoils at too slow a rate or speed for the given temperature measured by the thermistor.

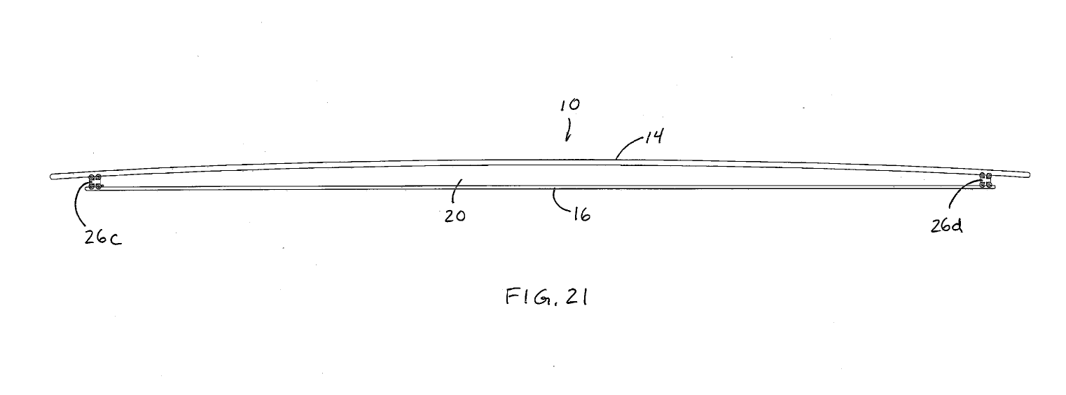

Spacing element or frame 26 comprises a perimeter frame having perimeter portions 26a, 26b, 26c and 26d that encompass or surround and establish the interpane cavity between the window panels 14, 16. In the illustrated embodiment, the perimeter portions 26a, 26b, 26c, 26d each have recesses or notches 27a, 27b established at their upper and lower outboard corners for receiving the respective adhesive bead 34, 30 (and/or optionally a sealant bead or sealing material, such as a butyl sealant bead or the like) therealong to adhere or bond the spacing element or frame 26 to the respective window panels 14, 16 (although optionally, it is envisioned that the spacing element may be overmolded about a perimeter of the lower or inner window panel 16 to bond or attach the spacing element to the window panel). Optionally, and desirably, perimeter portions 26a, 26b, 26c, 26d may include a recess or notch 27c established along an upper inboard corners for receiving a bead of a moisture limiting material or desiccant material 41a (and/or optionally a sealant bead or sealing material, such as a butyl sealant bead or the like) or the like (such as a desiccant material or any suitable hygroscopic substance that induces or sustains a state of dryness (desiccation) in its local vicinity, such as via absorption or adsorption of water, or a combination of absorption and adsorption; some commonly used desiccants include, for example, silica gel, activated charcoal, calcium sulfate, calcium chloride, montmorillonite clay, molecular sieves and/or the like) within the interpane cavity of the window assembly to reduce or limit or substantially preclude moisture buildup within the window cavity. Optionally, the side perimeter portions 26c, 26d may also include a recess or notch 27d established along their lower inboard corners for receiving another bead of a moisture limiting material or desiccant material 41b or the like (and/or optionally a sealant bead or sealing material, such as a butyl sealant bead or the like) to further reduce or limit moisture buildup within the window cavity. Thus, and as can be seen with reference to FIGS. 21, 21A and 21B, the side perimeter portions 26c, 26d are generally cross-shaped, with the vertical webs varying in height along the length of the side perimeter portions to correspond to the curvature of the window panels 14, 16.

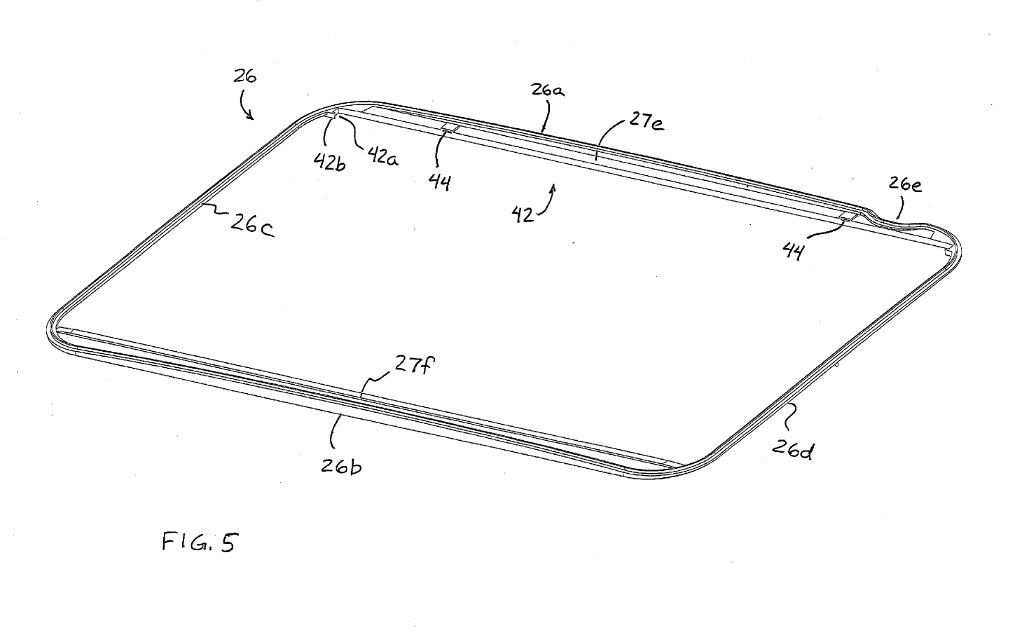

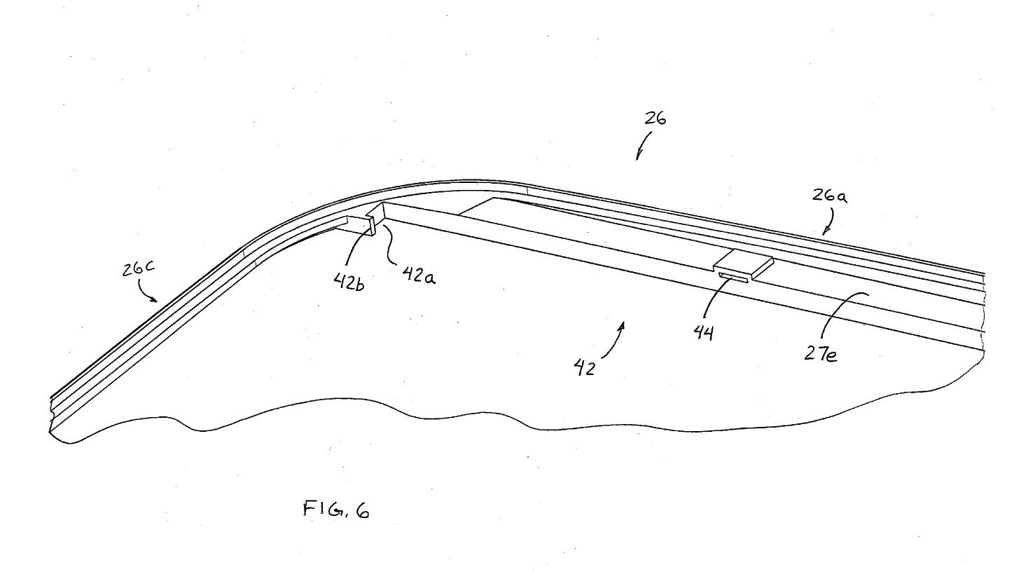

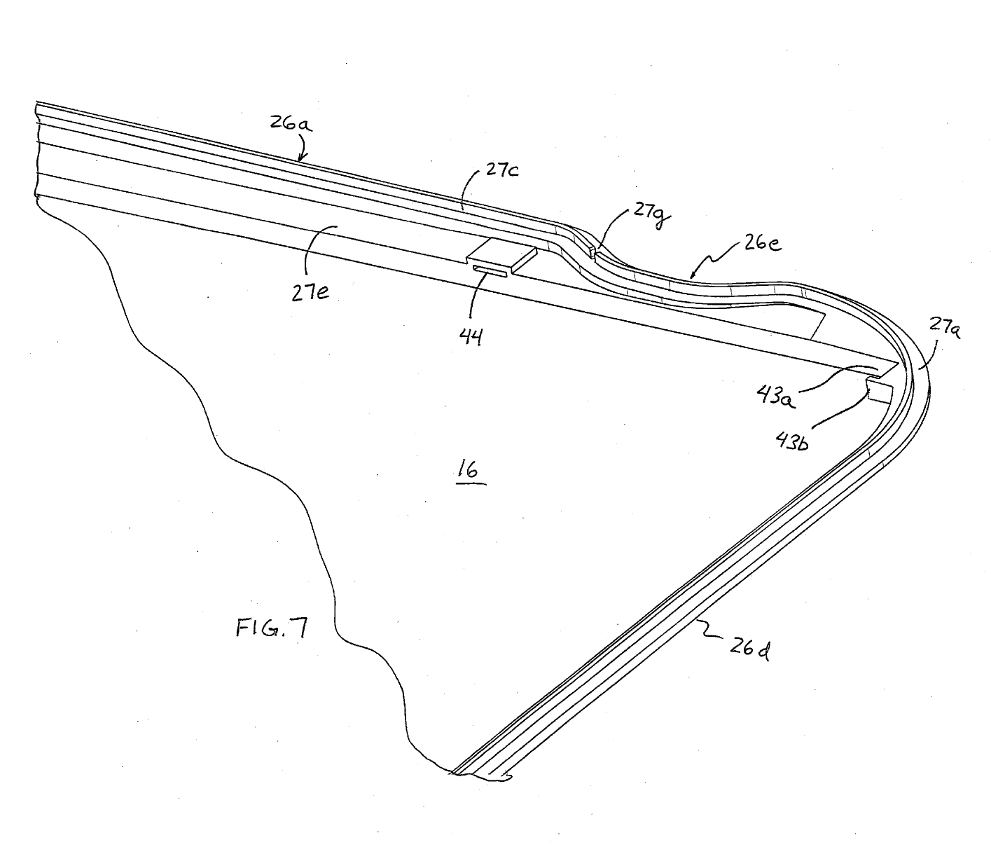

The front and rear perimeter portions or end perimeter portions 26a, 26b also include varying height center or vertical webs that vary in height along the length of the end perimeter portions to correspond to the curvature of the window panels 14, 16. As shown in FIGS. 5-7, and 17-20, end perimeter portion 26a includes an inwardly extending portion 27e that extends inboard into the window cavity to provide a generally straight mounting portion for attaching to or receiving support element 32 and roller shade 18, while end perimeter portion 26b includes an inwardly extending portion 27f that extends inboard into the window cavity to provide a generally straight mounting portion for attaching to or receiving the stop element 28, as discussed below, such that the outer perimeter regions of the window panels and end perimeter portions 26a, 26b may be curved (so as to provide the desired curvature of the front and rear of the window assembly depending on the particular vehicular application of the window assembly) while the inboard portions of the end perimeter portions 26a, 26b may be substantially straight.

As best shown in FIGS. 5-7, end perimeter portion 26a of spacing element 26 is configured for attaching the roller shade at perimeter portion 26a. In the illustrated embodiment, the inboard portion 27e of perimeter portion 26a includes a shade receiver or shade receiving structure 42, which includes a notch or recess 42a, 43a at opposite ends or corners of the perimeter portion 26a, with a tab 42b, 43b at the respective notches 42a, 43a. The notches are formed or configured to receive the ends of the support element 32 therein to position the support element 32 and roller shade 18 at and along the perimeter portion 26a of spacing element or frame 26. The tabs 42b, 43b extend along end portions of the support element that extend beyond the roller shade, so that the roller shade is disposed between the tabs 42b, 43b and the tabs do not interfere with the rolling and unrolling of the roller shade. Although shown and described as having a receiving structure established at the perimeter portion 26a for receiving the support element of the roller shade to attach the roller shade to the spacing element, clearly other means for mounting the roller shade and/or support element at the spacing element may be implemented (such as, for example, a snap-fit or press-fit or interference-fit of the support element in or at the receiving structure, or one or more locking tabs and associated slots or recesses may be established at the support element and/or spacing element to lock or attach the support element at the spacing element, or an intermediate cartridge may receive the support element therein and the cartridge may be received at or attach to the spacing element via any suitable means to locate and retain the roller shade at the spacing element, or the end of the roller shade may be clamped or secured at a clamping portion of the spacing element without any support element or cartridge or the like), while remaining within the spirit and scope of the present invention.

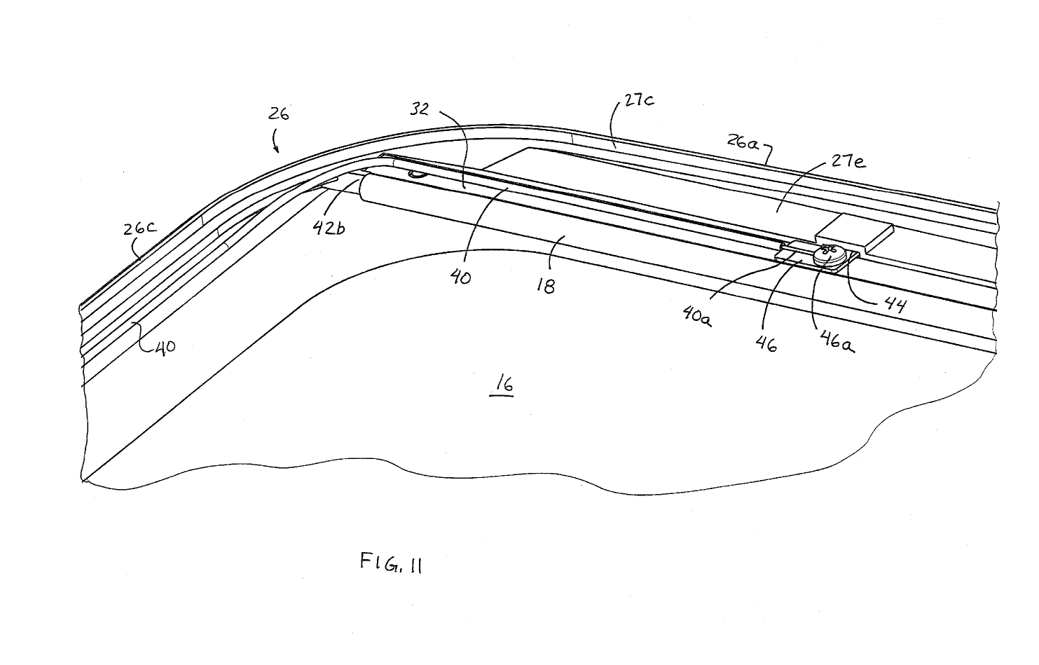

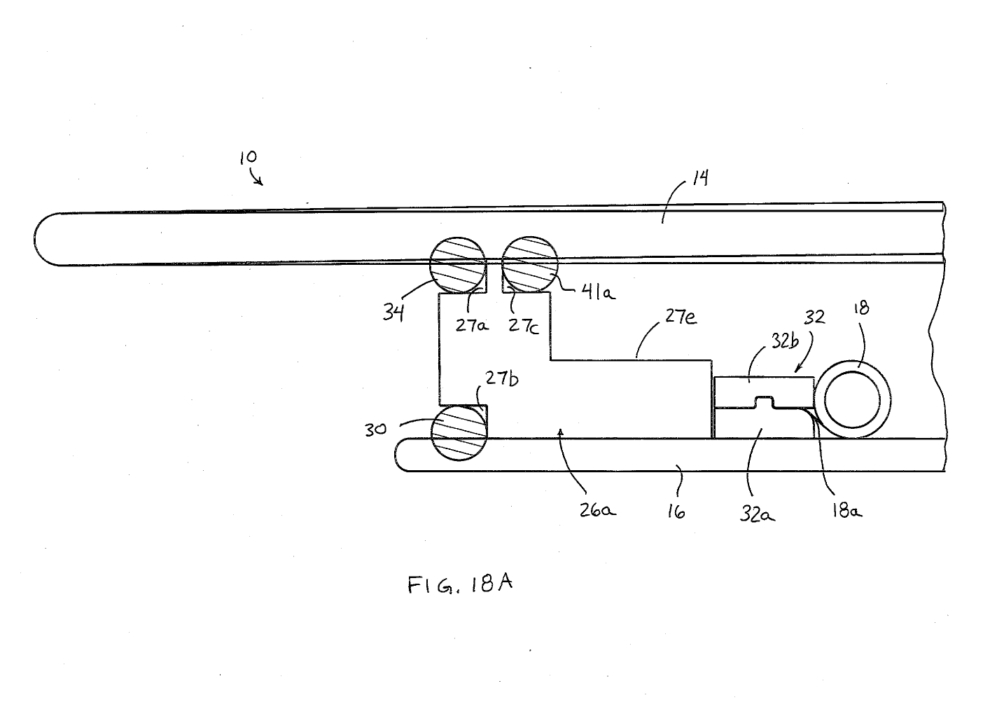

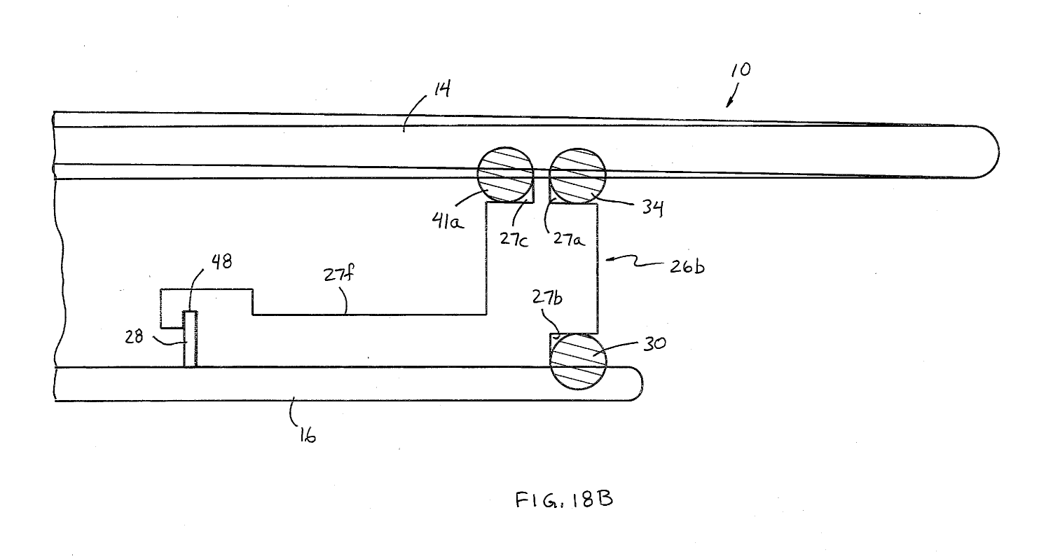

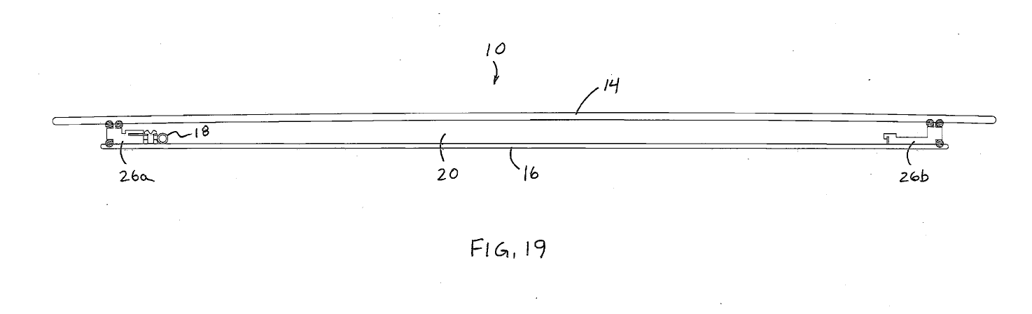

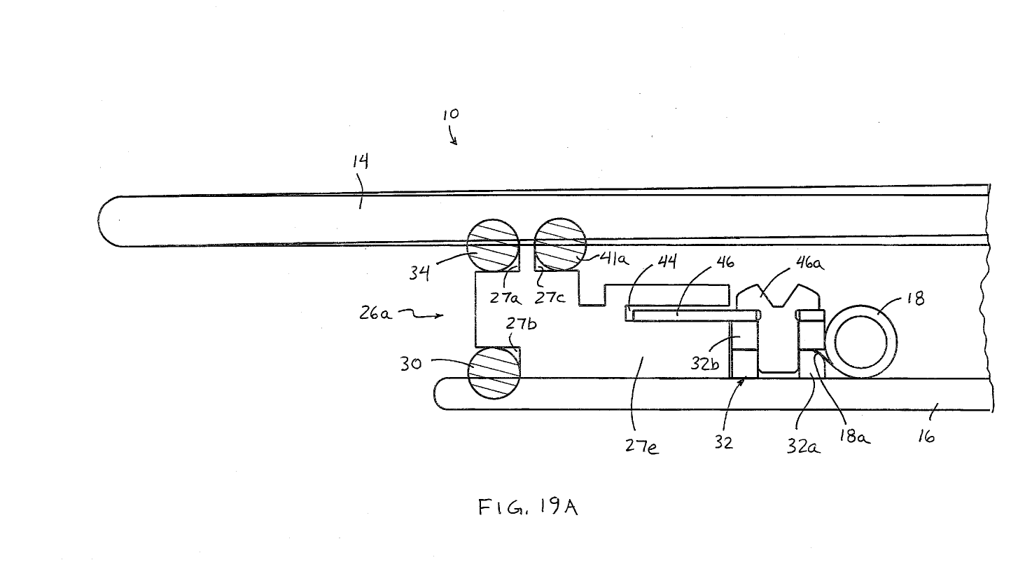

The support element 32 may be retained at the shade receiving structure 42 of end perimeter portion 26a of spacing element 26 via any suitable retaining means. For example, and as best shown in FIGS. 11, 12 and 19A, the inboard portion 27e of end perimeter portion 26a of spacing element or frame 26 may include recesses or slots 44, and, after the support element is received in the shade receiving structure 42, a tab or retaining element 46 may be disposed over the support element 32 and inserted into or received in slots 44 to substantially limit movement of the support element 32 (such as movement in the upward direction in FIG. 19A) when the support element 32 is received in the notches 42a, 43a at the perimeter portion 26a of spacing element 26. Optionally, and as shown in FIGS. 11, 12 and 19A, the retaining element 46 may be secured to the support element 32, such as via a fastener 46a, which may also function to electrically connect an end of a respective wire or lead 38a, 40a to the roller shade 18 or electrically conductive strip at support element 32, with the wire 40 electrically connecting at its other end to the roll stop or stop element 28 at end perimeter portion 26b, as discussed below.

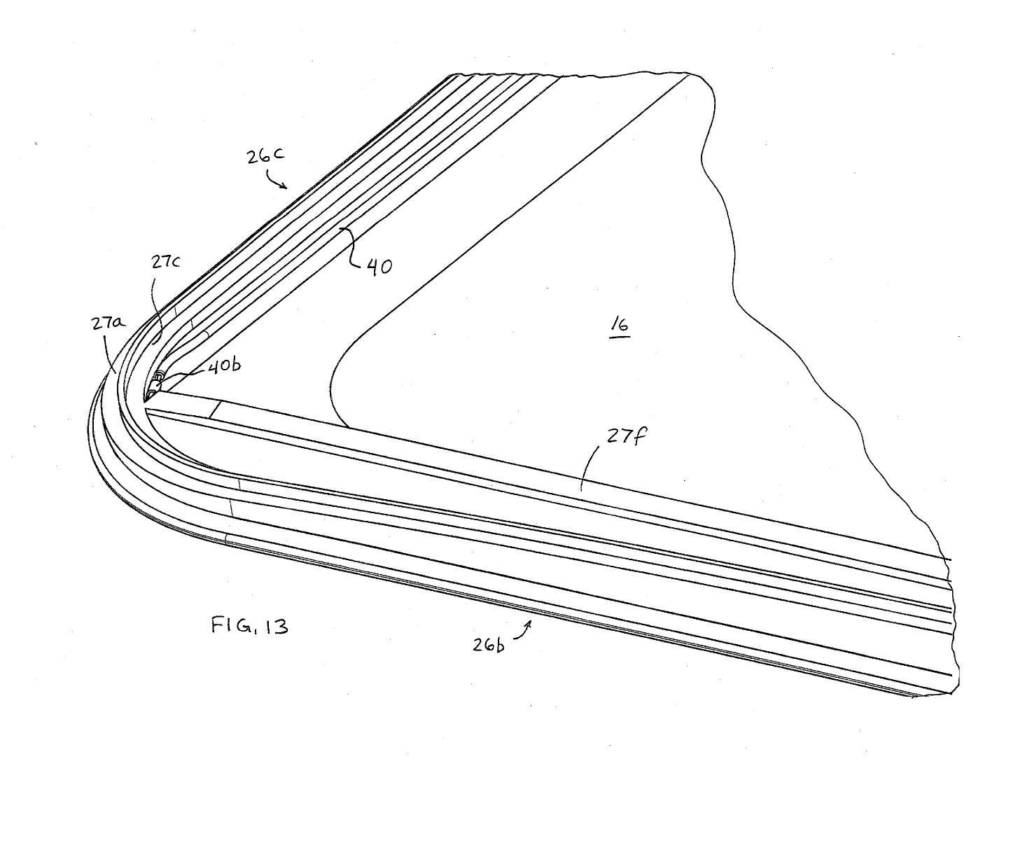

Similar to end perimeter portion 26a of spacing element 26, end perimeter portion 26b includes an inboard portion 27f that extends inboard into the window cavity. Inboard portion 27f is configured to provide a generally straight inboard surface and is configured to receive or support or attach to the roll stop or stop element 28. In the illustrated embodiment, the stop element 28 comprises a metallic strip that is received in a channel 48 established along inboard portion 27f, such that the stop element 28 is retained in the channel 48 at the window panel surface and along the inboard portion 27f of end perimeter portion 26b. One end of the channel 48 may be opened at inboard portion 27f so that an end or connector end 28a of stop element 28 is accessible at the end of the inboard portion 27f for electrical connection to a connector or terminal 40b of wire or lead 40 from inboard portion 27e of end perimeter portion 26a (such as best shown in FIGS. 13 and 14). Optionally, the electrical connection between the roller shade and the roll stop may be established via any suitable electrically connecting means, such as via an electrically conductive tape or trace established along the support element and/or the spacing element and/or the window surface (such as a silver trace established or screened therealong) or such as via an electrically conductive element insert molded in the support element and/or the spacing element or the like. Although shown and described as having a roll stop or stop element at the opposite end of the window assembly from the coiled or rolled up roller shade, it is envisioned that the window assembly may not include such a roll stop (and thus may not include the second wire or lead connecting between the roller shade and roll stop), whereby the end perimeter portion 26b may be otherwise configured without the channel and roll stop and optionally without the inboard portion 27f and generally straight surface, such that the end perimeter portion 26b may be configured in a similar manner as the side perimeter portions 26c, 26d, discussed above.

Thus, the window assembly of the present invention provides a roller shade device or element that is operable to unroll and rollup to close or extend the shade to shade or darken or attenuate light at the window and to open the shade to allow light to pass through the window. The spacer element is configured to attach or adhere or bond to each of the window panels to establish the interpane or window cavity therebetween. The roller shade may be incorporated with a support element that provides enhanced rigidity to the roller shade to limit bending or flexing of the roller shade during manufacture of the window assembly. The support element thus may be readily attached to or received at the spacer element (such as after the spacer element is attached or adhered at one of the window panels, such as the lower or inner window panel, and before the other window panel is attached or adhered to the spacer element), and may be retained therein so that the roller shade is positioned at and on the window panel while in a substantially non-flexible state due to the attachment of the roller shade at and along the generally rigid or relatively rigid support element or anchor element. The present invention thus provides enhanced assembly processing for the window assembly.

For example, an assembly process for manufacturing or assembling a window assembly of the present invention may include providing an inner window panel 16 (which may have an opaque layer or coating established about its perimeter) and a spacing element or frame 26 (which may comprise a molded polymeric frame or the like). An adhesive bead 30 is disposed (such as via an automated dispenser) along the outboard lower notch or recess 27b along the perimeter portions and corners of the spacing element, while a bead of desiccant material 41b may be disposed (such as via an automated dispenser) along the inboard lower notch or recess 27d along the side perimeter portions of the spacing element, whereby the spacing element is urged against the lower window panel (such as via an automated robotic device or the like) to bond the spacing element at the window panel surface and to seal the spacing element against the window panel surface. Optionally, before the spacing element is pressed against the window panel, a roll stop or stop element 28 may be attached to or disposed at an end perimeter portion of the spacer element, whereby the roll stop may be retained thereat via any suitable means, such as via being retained via the engagement of the spacing element with the window panel, such as discussed above.

After the spacing element is adhered to the lower window panel, the roller shade 18 may be attached at the spacing element. For example, and as discussed above, the roller shade may be attached to a relatively rigid support element or anchor element 32 to provide rigidity to the roller shade during the assembly process. The support element may be dropped in or pressed in or otherwise received at or in the shade receiving portion or shade receiver 42 of the inboard portion 27e of the end perimeter portion 26a of the spacing element, whereby the roller shade is disposed at the inner surface of the lower window panel. The support element may be retained at the spacing element via any suitable means, such as a pair of tabs 46 that are disposed over the support element and received in slots 44 in the end perimeter portion to limit or substantially preclude retraction of the support element from the shade receiver of the spacing element (with the opposite ends of the end perimeter portion of the spacing element limiting longitudinal movement of the roller shade and support element and with the inboard portion 27e and tabs 42b, 43b limiting lateral movement of the roller shade and support element, such that the support element (and thus the end of the roller shade attached thereto) is substantially fixed relative to the spacing element and lower window panel.

After or during attachment of the roller shade and support element at the spacing element, the electrical connections may be made to the conductive coating or layer and to the roller shade and optionally to the stop element. For example, the wiring harness 38 may have one end or lead 38b electrically connected at the connector pad 39, while the other lead 38a is routed through a notch 27g in the vertical web of the end perimeter portion 26a of spacing element 26 and connected at the tab 46 to electrically connect to the roller shade, such as via fastener 46a at tab 46 (or optionally, the connector of a wiring harness may clip to or otherwise connect to busbars established at or near the periphery of the window panel, such as shown in FIGS. 22 and 22A and discussed above). Although shown as routed through notch 27g in the spacing element 26, electrical power may be provided to the roller shade in the window cavity via any suitable means, such as through a hole in the spacing element or via an electrically conductive element insert molded in the spacing element or via an electrically conductive tape or coating disposed at the glass surface (and electrically isolated from the transparent conductive coating to which lead 38b is electrically connected) or the like, while remaining within the spirit and scope of the present invention. The other end of the wiring harness 38 may have a connector (such as a plug or socket type connector) for connecting to a wiring harness of the vehicle when the window assembly is normally mounted at the vehicle. Also, although shown as electrically connecting the wire or lead 38a to the roller shade via a fastener 46a, clearly, the electrical connection may be made via any suitable electrically connecting means, such as, for example, soldering, adhering (such as via an electrically conductive adhesive or the like) or otherwise attaching or electrically connecting the terminal end of the wire 38a to the support element and/or the roller shade to provide electrical power to the roller shade when the roller shade is activated.

Optionally, electrically conductive wire 40 may have its first end 40a electrically connected at the tab 46 to electrically connect to the roller shade, such as via the fastener 46a. As best shown in FIGS. 11, 13 and 14, the wire 40 may be routed along support element 32 and along side perimeter portion 26c of spacing element (and generally along the surface of the window panel 16), with its opposite end 40b electrically connected at the exposed connecting end 28a of roll stop 28 (that is exposed at one end of the end perimeter portion 26b of spacing element 26). Thus, when the connecting end of wire 38 is connected to electrical power, power may be selectively applied either to the roller shade and the roll stop or to the transparent conductive coating to either roll or unroll the roller shade, while removing the power may cause the roller shade to unroll or roll in the opposite direction.

After the electrical connections are made, the subassembly (comprising the lower or inner window panel and spacing element or frame) may be ready to be attached to the upper or outer window panel. Thus, a bead of adhesive 34 is disposed around the upper outboard corner (such as at and along the notch or recess 27a), while a bead of moisture limiting material or desiccant material 41a is disposed around the upper inboard corner (such as at and along the notch or recess 27c), with the beads 34, 41a being optionally disposed or applied via an automated or robotic dispensing device or system. The upper or outer window panel 14 is then moved toward and into engagement with and urged against the upper edges of the spacing element 26 and against the adhesive bead 34 and desiccant bead 41a (such as via an automated robotic device or the like) to adhere and seal the window panel 14 at the spacing element 26 to complete the window assembly.

The window assembly 10, when fully assembled, may be disposed at an opening in a vehicle and secured or mounted thereat or therein via any suitable mounting or attaching means. For example, the outer perimeter of the outer or upper window panel may be bonded or adhered to a metal frame or the like at the vehicle, or the window assembly may be attached to and/or supported by a separate frame that is attached to the vehicle. Optionally, the window assembly may include mounting hardware or the like that is attached to corresponding mounting structure or hardware at the vehicle to mount the window assembly at the vehicle.

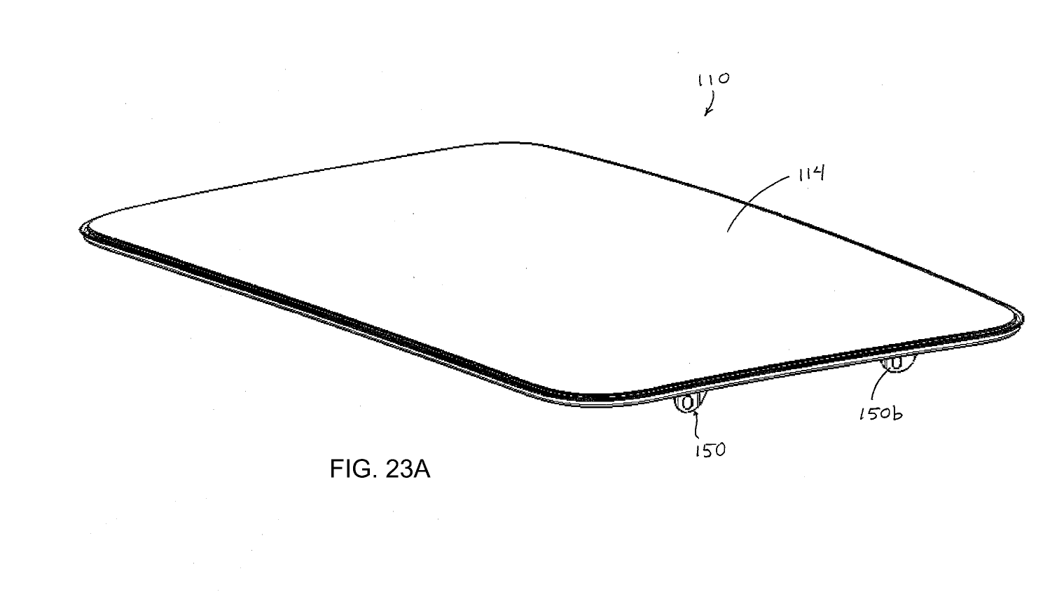

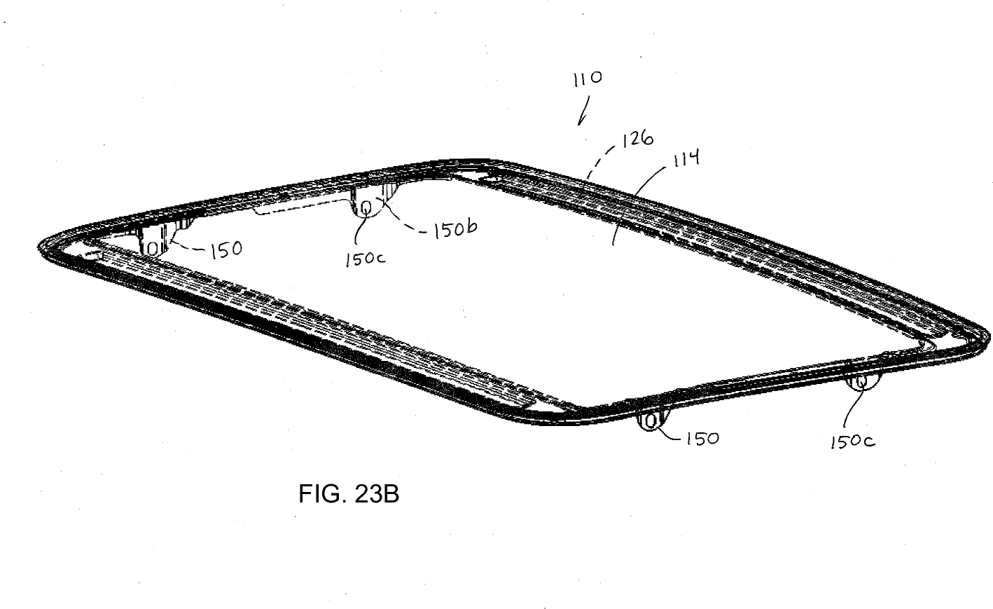

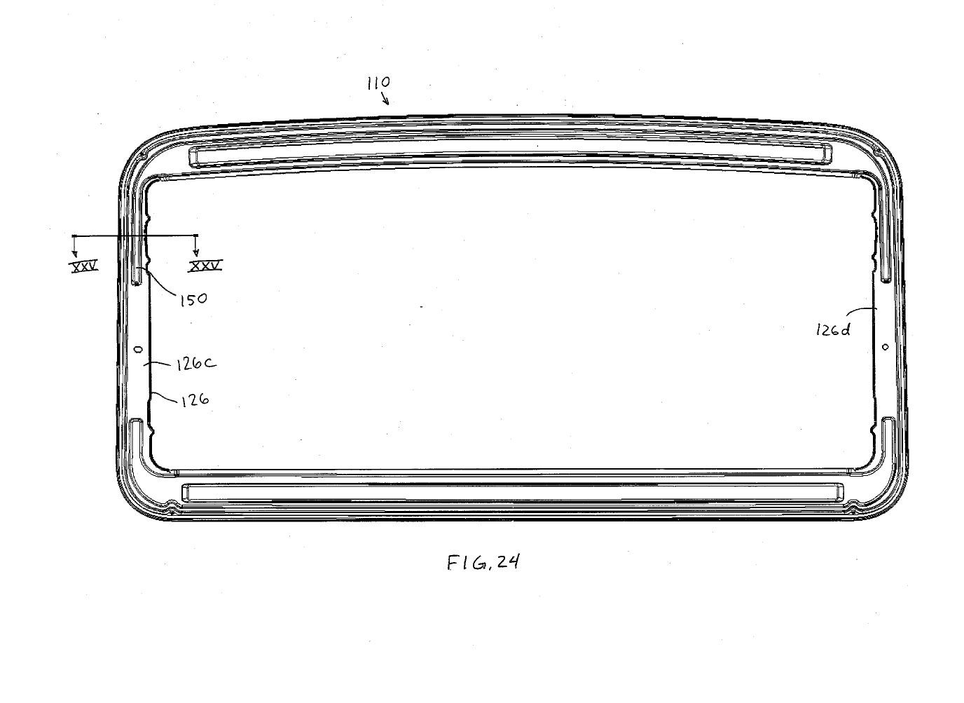

For example, and with reference to FIGS. 23A-25, a window assembly 110 may include inner/lower and outer/upper window panels 116, 114 spaced apart and attached together via a spacing element or frame 126, with a roller shade (not shown in FIGS. 23A-25) disposed within the interpane cavity 120, such as in a similar manner as described above. The window assembly 110 includes mounting brackets 150 along the side perimeter regions of the window assembly for mounting the window assembly to brackets and the like at the vehicle (such as for mounting the window assembly at brackets and elements that impart movement of the window assembly, such as tilting or sliding, such as for a movable vehicle sunroof or the like).

As can be seen with reference to FIGS. 23A-25, the spacing element or frame 126 extends around the perimeter of the window assembly and may be overmolded at the perimeter edge region of one of the window panels, such as the upper window panel 114 as shown in FIG. 25. The frame 126 includes the mounting brackets 150 insert molded at the side perimeter regions 126c, 126d, such that the mounting brackets 150 are integrated in the window assembly and need not be separately attached to the window assembly during the manufacturing process. In the illustrated embodiment, and as shown in FIG. 25, the frame 126 is overmolded over the brackets 150 and around a perimeter edge 114a of the upper window panel 114 and along the lower surface 114b at the perimeter region of the upper window panel 114, and the perimeter frame 126 is bonded or adhered (such as via an adhesive bead or layer 130) at the upper or inner surface 116a of the lower window panel. However, the perimeter frame may be adhered or bonded to both window panels, or the perimeter frame may be overmolded over the perimeter region of the lower window panel (with the mounting brackets insert molded therein), while remaining within the spirit and scope of the present invention.

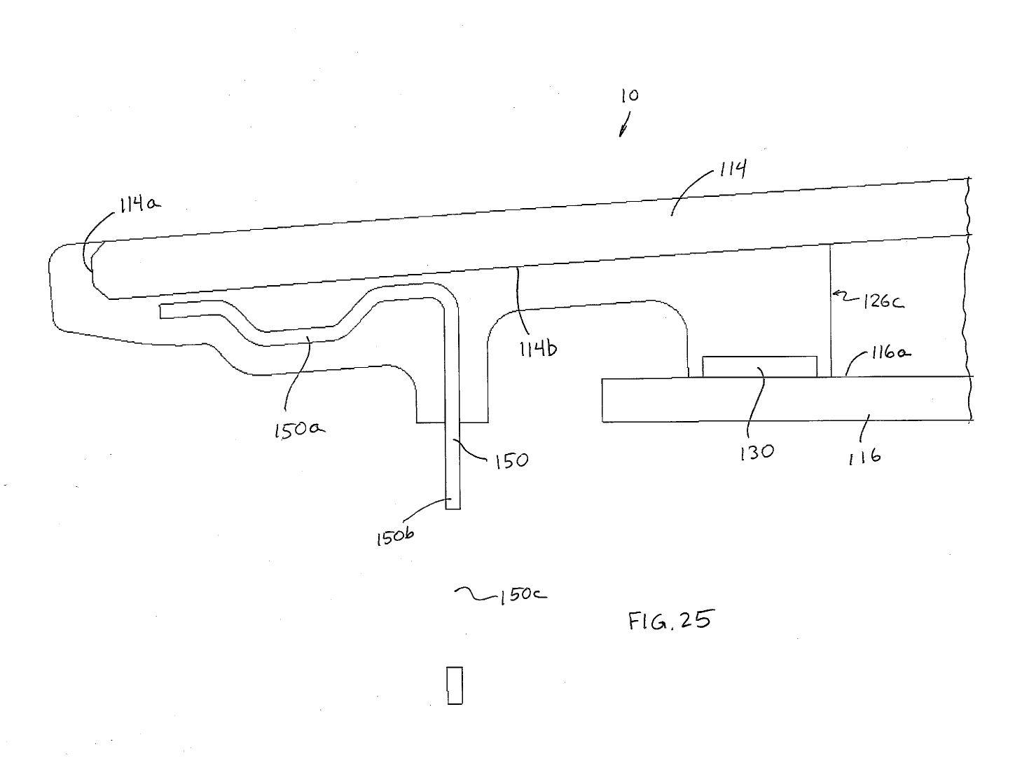

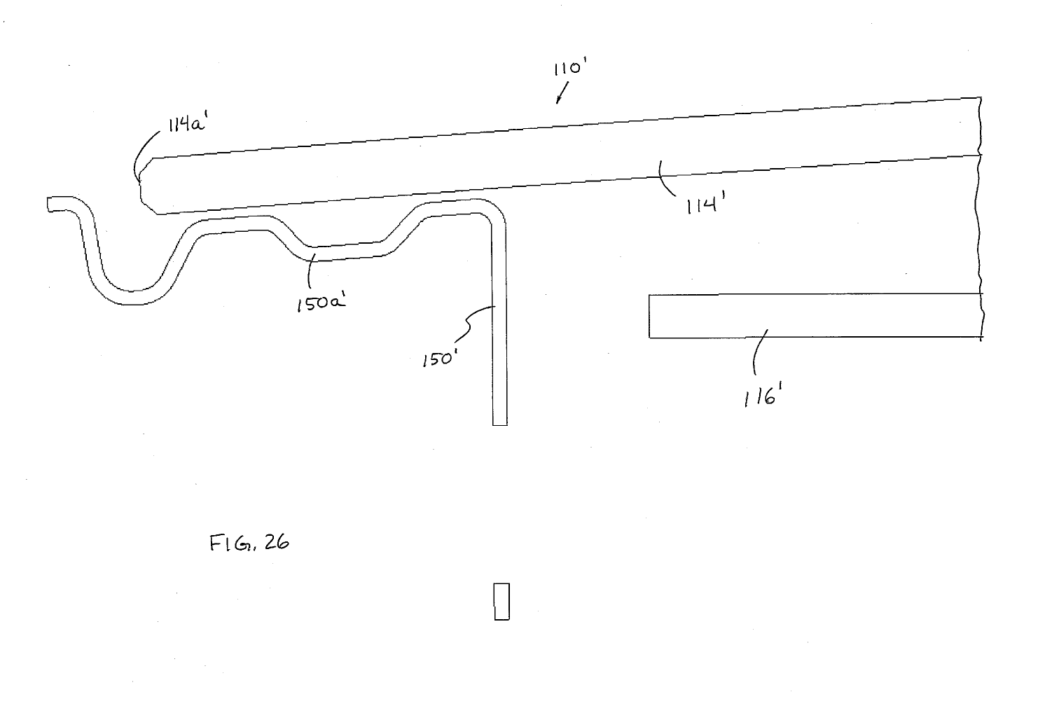

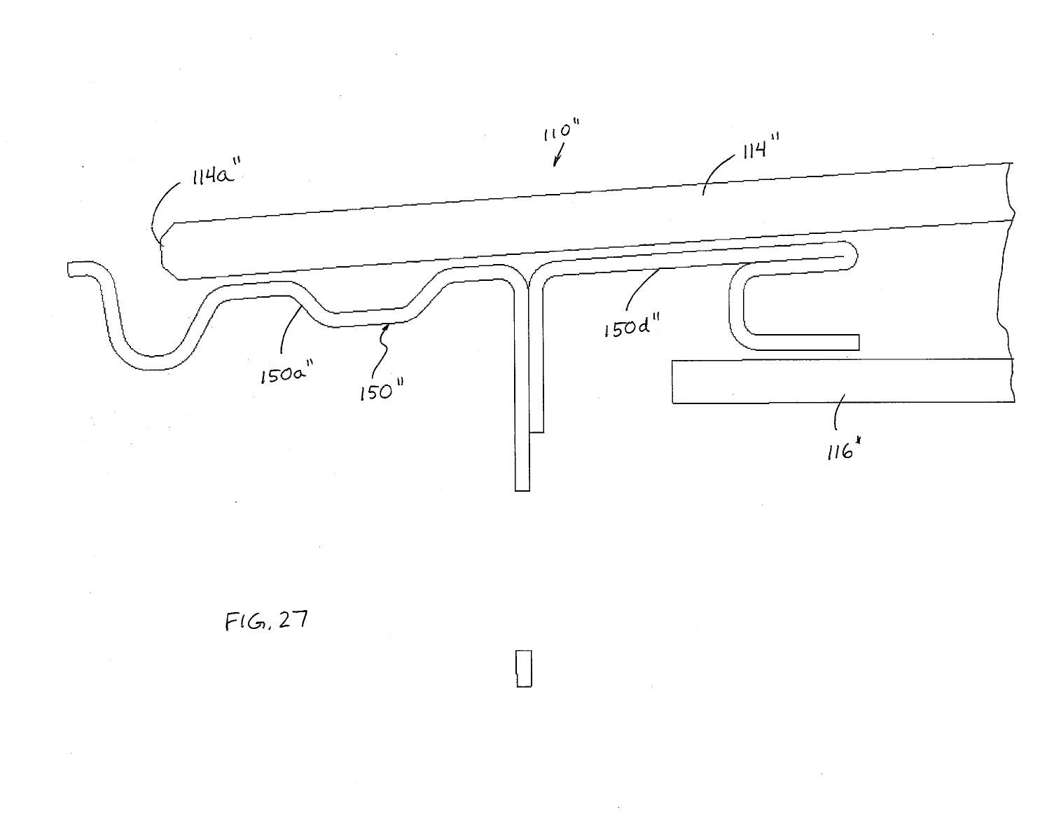

As shown in FIG. 25, the mounting bracket 150 may comprise a metallic bracket that has a window attaching portion 150a disposed generally at the lower surface 114b of the upper window panel, and a vehicle attaching portion 150b that extends downward from the window attaching portion and includes an aperture 150c for mounting the bracket 150 and thus the window assembly 110 to the vehicle structure. Optionally, other bracket forms or configurations may be implemented at the window assembly, while remaining within the spirit and scope of the present invention. For example, and with reference to FIG. 26, a window assembly 110′ may include a mounting bracket 150′ that has a larger window attaching portion 150a′ that extends beyond the outer perimeter edge 114a′ of the upper window panel 114′. The side perimeter portion of the spacing element or frame (not shown in FIG. 26) may be overmolded over the bracket 150′ and may also be overmolded over the perimeter region of the upper window panel 114′ (or lower window panel 116′) or may be adhered or bonded to one or both of the upper and lower window panels 114′, 116′. Optionally, and as shown in FIG. 27, a window assembly 110″ may include a mounting bracket 150″ that has a larger window attaching portion 150a″ that extends beyond the outer perimeter edge 114a″ of the upper window panel 114″ and has an inboard bracket portion 150d″ that extends inboard and may be disposed at least partially between the upper and lower window panels 114″, 116″. The side perimeter portion of the spacing element or frame (not shown in FIG. 26) may be overmolded over the bracket 150″ and may also be overmolded over the perimeter region of the upper window panel 114″ (or lower window panel 116″) or may be adhered or bonded to the upper and lower window panels 114″, 116″. The perimeter spacing element or frame of window assemblies 110, 110′, 110″ may be substantially similar to the spacing element or frame 26 discussed above with respect to window assembly 10, and the window assemblies 110, 110′, 110″ may include a roller shade and other components similar to window assemblies 10, 10′, such that a detailed discussion of these aspects of the window assemblies need not be repeated herein.

Although shown and described as comprising a sunroof or moonroof for a vehicle, it is envisioned that the shaded window assembly of the present invention may be suitable for a variety of applications. For example, an upper portion of a windshield may comprise the spaced apart window panels with a spacer element and roller shade as described above, with a perimeter trim panel or trim strip extending along the lower edge of the dual panel construction. Thus, the driver may selectively darken or shade the upper portion of the windshield (or optionally, the windshield portion may automatically darken responsive to one or more ambient light sensors or glare sensors at the vehicle) to limit glare or sunlight passing through the upper portion of the windshield, such as when driving towards the sunrise or sunset. Optionally, aspects of the window assembly of the present invention may also or otherwise be applied to a rear backlite of a vehicle (either shading the entire rear backlite or a portion of the rear backlite) or a side window of a vehicle or the like. For applications where the shade element unrolls to shade only a portion of the window or windshield, the dual pane construction may only be at that portion of the window or windshield, or the dual pane and spacing element construction may apply to the entire window or windshield, with the roller shade being controlled or limited or sized to unroll only to cover or shade or darken a selected portion of the window or windshield (such that the roller shade only partially unrolls over part of the window or windshield or such that the roller shade is cut or formed so that, when fully unrolled, it extends over or encompasses only a portion of the window or windshield). Other window configurations and roller shade constructions may be implemented while remaining within the spirit and scope of the present invention.

Optionally, multiple coiled films may be used to provide different shading applications. For example, a coiled shade element or film may be disposed at and coiled/uncoiled along the inner or lower window panel and a second coiled shade element or film may be disposed at and coiled/uncoiled along the outer or upper window panel (or along an intermediate window panel disposed between the outer and inner window panels), to provide up to three degrees of shading if each film provides a different degree of shading (for example, a first degree of shading may be provided when only the first film is uncoiled, while a second degree of shading may be provided when only the second film is uncoiled and a third degree of shading may be provided when both films are uncoiled). Optionally, two (or more) coiled films may be disposed adjacent to one another or otherwise on the same window panel, with each film covering or shading a different portion of the window when uncoiled. For example, a first film may be disposed at the forward or rearward perimeter region to extend and cover one side (such as the driver side) of the window, while the other or second film may be disposed at the forward or rearward perimeter region to extend and cover the other side (such as the passenger side) of the window, with each film being coiled and uncoiled responsive to a separate user input. Optionally, a first film may be attached along one side of the window and a second film may be attached along the other side of the window, whereby the films may uncoil towards the center region of the window to selectively cover or shade a respective side of the window assembly, such as in response to a respective user input or the like. Other configurations and quantities of films may be disposed within the interpane cavity to individually shield or shade respective portions of the window panels while remaining within the spirit and scope of the present invention. The films thus may, for example, be coiled at the front perimeter region or the rear perimeter region (or one film coiled at the front perimeter region and one film coiled at the rear perimeter region) or the films may be coiled at one or both side perimeter regions or the films may be coiled at a central region and may uncoil towards one or more of the front, rear and side perimeter regions, while remaining within the spirit and scope of the present invention.

When uncoiled, the film or films may provide a desired degree of shading at the window assembly, and may be provided in any suitable color, depending on the particular application of the window assembly. For example, the film or films may be painted or inked or screen printed or coated with a dark or black coating to provide a dark or black colored shading of the window assembly, or the film or films may be painted or inked or screen printed or coated with any other colored coating or layer or the like to provide the desired appearance of the shaded window assembly. Optionally, for example, the film or films may be colored or tinted or patterned (such as with a vehicle manufacturer logo or any desirable or suitable pattern or icon or image or the like) to match the interior or exterior color scheme or trim scheme of the particular vehicle or vehicle manufacturer, or the film or films may be colored or tinted to match a selected color scheme as selected by the vehicle manufacturer or the vehicle owner or the like, such as by utilizing aspects of the mirror assemblies described in U.S. Pat. Nos. 7,289,037; 7,626,749; and/or 7,255,451, which are hereby incorporated herein by reference in their entireties.

Optionally, the film may have a reflective layer or reflective property, so as to reflect light and/or UV radiation away from the window and away from the interior cabin of the vehicle. Optionally, the film may comprise polarization properties and may darken when it encounters UV radiation (or the film may automatically extend or close or cover the window panel when a threshold degree of UV radiation is detected or sensed at the window assembly, such as via a controller that, responsive to a detection of a threshold level of UV radiation, energizes the shade to extend or deploy or uncoil the film).

Optionally, the film may be formed without an ink layer. For example, the film material or substrate may be already colored or darkened, such as by having a pigmentation additive added to the film substrate so the film substrate itself is formed at the desired or selected color and opaqueness. Such an additive may obviate the need for the inking process and may provide a more durable film (because, with the pigmentation additive as part of the film material itself, there is a reduced chance of scratching or marring an inked surface at the surface of the shade film). Optionally, an ultraviolet (UV) or infrared (IR) pigmentation may be added to the film substrate or may be disposed at the surface of the film to provide a desired UV/IR protection or filter at the shade film.

The film or films may provide any desired or appropriate degree of shading and thus may function to block or attenuate a desired or appropriate percentage of light incident at the window assembly. For example, the film may block or attenuate at least about forty percent of the visible light incident at the window assembly, and preferably may block or attenuate at least about sixty percent of the visible light incident at the window assembly, more preferably at least about eighty percent of the visible light incident at the window assembly (or the film may block or attenuate less than about forty percent of the visible light incident at the window assembly), and it is envisioned that the film may block up to about one hundred percent of the visible light incident at the window assembly (so as to provide a generally or substantially opaque or non-light-transmissive window or sunroof), depending on the particular application of the window assembly and desired shading of the window when the shading element is deployed. The degree of light transmissivity or light attenuation of the film or shade element may be varied by varying the thickness of the ink layer or coating on the polymeric film roll or by including a metallic coating or light absorbing layer or light reflecting layer at the polymeric film roll or the like.

The perimeter spacer element or frame is disposed around the perimeter of the smaller window panel of the window assembly and may comprise any suitable material. For example, the spacer may comprise an extruded (or otherwise formed, such as via molding or the like) rubber product with a polyisobutylene (PIB) adhesive and peel liner on two (opposite) edges, whereby the peel liner may be removed from one edge of the spacer for attachment of the spacer to one of the window panels (such as the smaller or inner window panel) and the peel liner may be removed from the opposite edge for attachment of the spacer to the other of the window panels (such as the larger or outer window panel). The spacers may be formed to have the desired profile so as to provide the desired spacing along the perimeter edge regions of the window assembly. For example, the forward and rearward spacing portions or elements may have a thicker central region and may taper or curve towards thinner end regions, while the side spacing elements may be substantially uniform or may provide any other desired or selected profile to correspond with the contours or curvatures of the cavity facing surfaces of the window panels. Separate corner spacers may be provided to space and seal the window panels at the corner regions, or the front, rear and side spacing elements may abut one another to seal at the corner regions, or a unitary perimeter spacing element may be formed that is disposed around the entire periphery of the window panel. After the spacers are attached to one of the window panels (such as the panel to which the coiled shade element or film is attached, such as the lower or inner window panel), the peel liner may be removed from the opposite edge of the spacer and the other window panel (such as the outer or larger window panel) may be affixed or adhered to the spacers. Optionally, after the window assembly is so assembled, the atmosphere within the interpane cavity may be at least partially displaced, such as with an inert gas, such as Argon or the like. Optionally, a resilient material, such as an RTV silicone or the like, may be used to fill the space outboard of and along the spacing elements to the edge of the smaller or inner glass.

The coiled film or shading element (or elements) is coiled or retracted to an open or non-shading position in the absence of a voltage applied thereto, and may uncoil or extend across the window assembly to a closed or shading position responsive to a voltage applied thereto. The voltage may be selectively applied via actuation of a user input or the like within the vehicle (such as a button or switch in the cabin of the vehicle, such as at an interior rearview mirror assembly of the vehicle) or the voltage may be automatically applied in response to a sensor or control (such as a control that actuates the shading element to shade the window responsive to a temperature sensor determining that the in-cabin temperature or external temperature has reached a threshold level or the like). The control unit or user input and power source may be attached to electrical connectors of a wire harness or leads of the finished window module or assembly, such as via a quick-connect plug and socket type connection or the like. The shading element may be operable via any suitable powering means. For example, the shading element may operate at about 530 VDC or thereabouts (or more or less) with a parasitic draw of about 150 to about 160 microamps or thereabouts (or more or less). The voltage may vary depending on the film roll and tightness of the film roll when coiled in its retracted state.

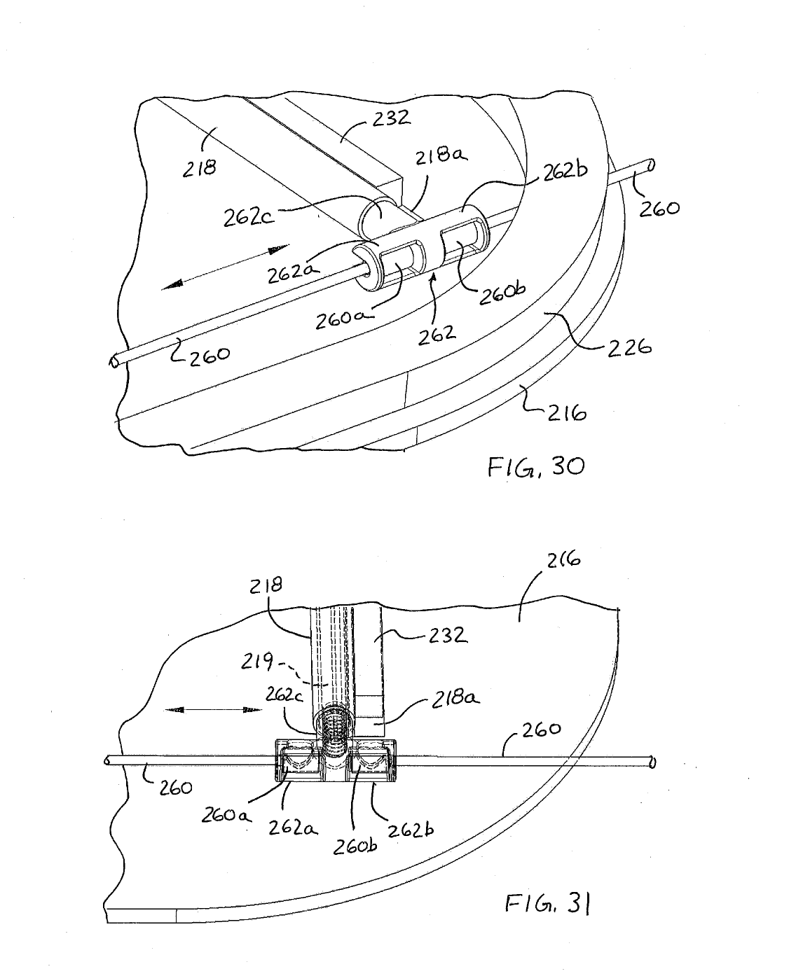

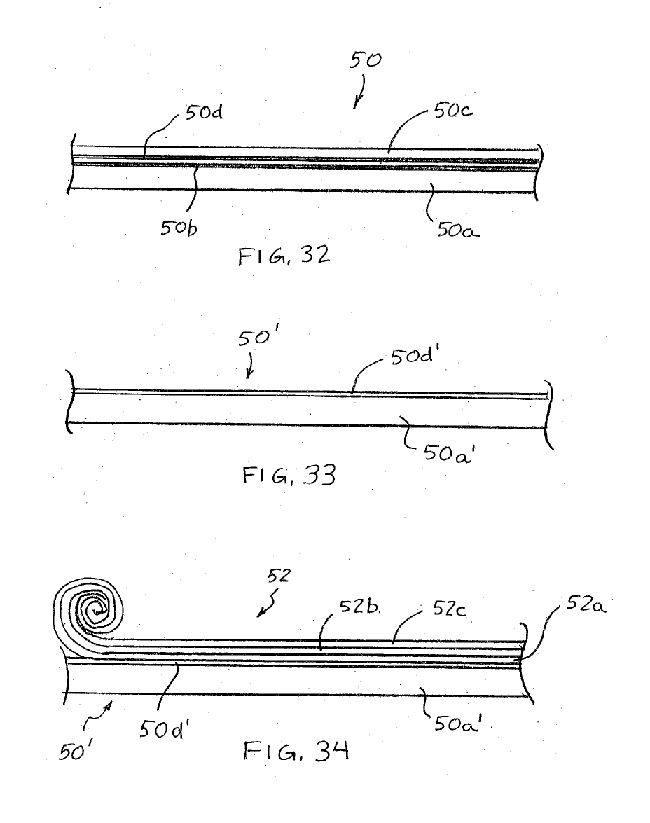

As discussed above, the lower window panel may comprise a dielectric laminate. For example, and with reference to FIG. 32, a lower window panel 50 may comprise a glass panel or substrate 50a, with a polyvinyl butyral (PVB) layer 50b disposed thereon, and with a thin glass sheet 50c (such as a thin glass sheet having a thickness of around 0.5 mm to around 0.7 mm or thereabouts) having a transparent conductive layer 50d (such as a layer of indium tin oxide or the like) disposed at or over the PVB layer 50b. As shown in FIG. 32, the ITO layer 50d of the thin glass sheet 50c interfaces or mates with the PVB layer 50b of the glass substrate 50a when the glass window panel is laminated.

Optionally, a lower window panel of a shaded window assembly may have a transparent conductive layer (such as ITO or the like) disposed at an upper surface thereof, and a dielectric layer (such as a thin glass or clear PET film or the like) laminated or adhered to the ITO layer (such as via a thin layer of adhesive at the dielectric layer and between the dielectric layer and the ITO coated glass surface). In such an application, during operation of the shade, a charge is provided to the conductive ITO layer, and some of that charge may be stored in the adhesive layer after the shade has been operated (which may result in malfunctioning of the shade or reduced performance of the extension/retraction of the shade).

For example, during operation of the shade, the film and the conductive layer on the glass surface are charged (at opposite polarities) to cause the film to unroll across the glass surface. When the charge is removed or the shade is deactivated, the film coils back up to its coiled position or state, but typically leaves a small charge on or in the dielectric layer. Such a charge, in a pure dielectric material, would have no way to dissipate.

Thus, it is desirable to provide an electrically conductive or resistive property to or at the dielectric material, such as by providing a dielectric material that is not a pure dielectric material. This can be accomplished by providing a slightly electrically conductive or slightly or highly resistive quality or characteristic to the dielectric layer to allow the residual charge left at the dielectric layer to dissipate. For example, an anti-static coating may be provided on or at or in the dielectric material (such as an anti-static layer or an anti-static additive or the like), in order to allow the charge to dissipate after the shade is deactivated and retracted.

Optionally, the window assembly may have a metallic additive or electrically conductive material or elements (such as small electrically conductive or metallic particles or elements) disposed in the adhesive material (so as to provide an at least partially electrically conductive adhesive) that adheres the dielectric layer to the ITO coated surface, such that the electrically conductive material in the adhesive enhances the dissipation of electrical charge in the dielectric layer and adhesive layer and limits or prevents stored charge at the dielectric layer and/or the adhesive layer. Such an electrically conductive adhesive material (disposed at or between the dielectric layer and the ITO coated layer) provides enhanced performance of the shade and limits or precludes stored charge at or in the adhesive that may cause malfunctioning of the extension/retraction of the shade. Optionally, the dielectric layer may be provided with an ITO layer established on the lower surface of the dielectric layer, whereby the dielectric layer and ITO layer laminate or construction may be laminated or adhered to the glass surface.

Optionally, it is envisioned that an adhesive that contains or comprises such a metallic additive may be used between the dielectric layer and the glass surface (with no electrically conductive layer or ITO layer established thereat), such as a bare glass surface or non-conductive surface. The conductive material or elements in the adhesive (or an at least partially electrically conductive adhesive) may then provide the electrical conductivity to operate the shade, while also allowing for enhanced dissipation of the electrical charge in the adhesive, thereby providing enhanced performance of the shade and limiting or precluding stored charge at or in the adhesive that may cause malfunctioning of the extension/retraction of the shade.

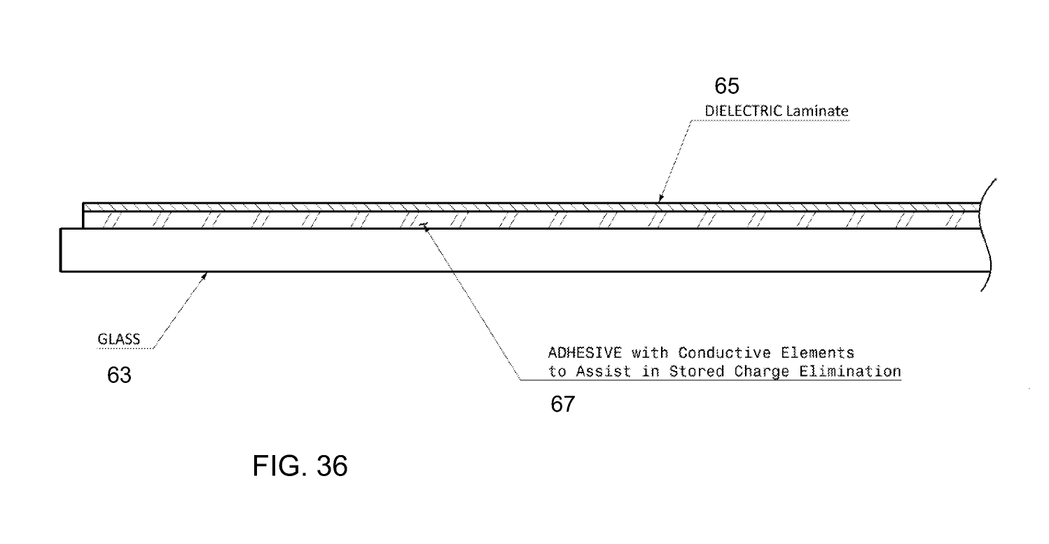

For example, and with reference to FIG. 36, a lower window panel 63 may have a dielectric laminate 65 disposed at its upper surface and attached or adhered to the upper surface of the lower window panel via a layer of adhesive 67. The adhesive 67 contains electrically conductive elements to assist in stored charge reduction or elimination. The upper surface of the window panel 63 may or may not have a transparent conductive layer or coating (such as ITO or the like) established thereat.

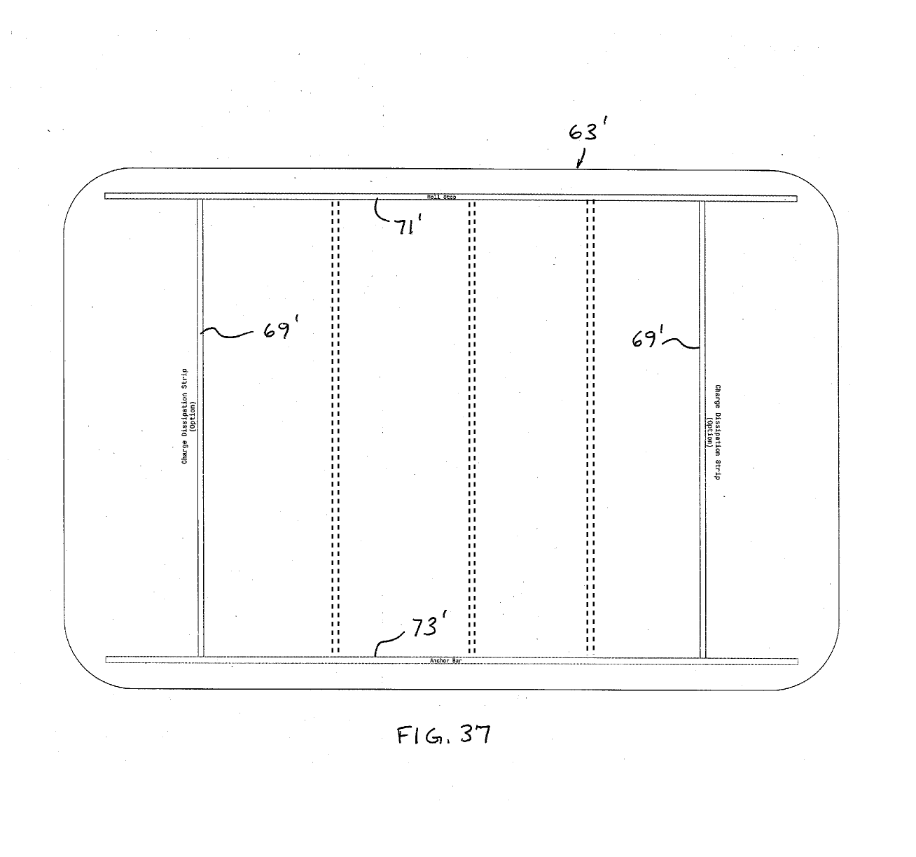

Optionally, and with reference to FIG. 37, a lower window panel 63′ may have one or more charge dissipating strips 69′ (such as the two strips 69′ or such as more than two strips such as shown in phantom in FIG. 37) disposed along the panel and between the roll stop 71′ and the anchor bar 73′. The charge dissipating strips 69′ may comprise any suitable charge dissipating material, and may comprise a transparent charge dissipating material disposed as one or more layers or strips across the window panel. The width of the strips and the spacing between the strips may be selected depending on the particular application of the window panel and the desired degree of dissipation and/or conductivity provided by the strips. Optionally, the charge dissipating strips may be disposed at and along an outer portion of the window panel, such as along the frame portion of the window assembly, whereby the strips may or may not be transparent, since they may be disposed at a location that is not readily viewable by a person viewing the window assembly from inside or outside of the vehicle. The charge dissipating material or strips function to assist in stored charge reduction or elimination, such as in a similar manner as discussed above.

Optionally, it is envisioned that a plurality of very small strips or micro strips of an electrically conductive material may be established at or in and along the dielectric layer at the window panel and between the anchor stop and the end stop. Such micro strips provide channels or raceways or busbars to channel out the residual charges left at the dielectric layer and thus provide a path or paths for the charge to dissipate (whereby the residual charge dissipates to the conductive strips and flows along the strips to the end stop and/or anchor stop and away from the dielectric material). It is envisioned that such micro strips or charge dissipating strips, if established to be sufficiently electrically conductive, may obviate the need for the jumper wire between the anchor stop and the end stop.

It has been found that it is desirable or preferred to incorporate the thinnest layer of dielectric at the window panel to reduce the voltage required to uncoil the film. However, if the dielectric layer is too thin, there is a risk of low life cycles and early failure and electrical shorting during operation of the shade. The applied voltage sufficient or selected for extending or uncoiling the film is selected or determined as a function of the dielectric constant and the dielectric thickness. For example, a dielectric layer having a thickness of about 19 micrometers may require about 650 volts to uncoil at a desired rate, while a similarly constructed dielectric layer having a thickness of about 12 micrometers may require only about 450 volts to uncoil at a similar desired rate. The thickness of the dielectric layer is selected to be as thin as possible to require a lower voltage level to deploy the coil (by providing the charged conductive surfaces on the film and glass surface to be as close as reasonable or possible), while being sufficiently thick to avoid shorting and to last the selected or desired or appropriate life cycles.

It is desirable to provide a coiled film with a small diameter of the coiled film. Typically, the larger diameter that the coil is, the easier it is to uncoil or deploy, because a smaller diameter coil increases the spring constant of the coiled film and thus requires a greater applied voltage to uncoil. The greater force (or greater applied voltage) to extend the film also results in a greater rate or speed of return or recoil of the film when the voltage is no longer applied. It is desirable to have the inner coil (such as the innermost or end coil at the distal end of the coil from the anchor stop, such as the end coil that is adhered or fixed to provide a fixed end coil of desired or selected diameter) approach zero mm in diameter, while still meeting the performance requirements of the shade film (such as retracting at the desired rate, such as about 12 inches per second, under targeted operating conditions while meeting the durability and life cycle requirements of the vehicle manufacturer).

Optionally, it is envisioned that the dielectric laminate at the surface of the inner or lower glass panel may be eliminated by establishing a conductive coating on the opposite side of the shade element or film (the side not touching the inner glass surface). For example, and with reference to FIGS. 33 and 34, a lower window panel 50′ may have a transparent conductive coating or layer 50d′ (such as a layer of ITO or the like) disposed at an inner surface of the glass substrate 50a′ (the surface facing the outer or upper window panel, which is not shown in FIGS. 33 and 34), and the shading element or film 52 may comprise a laminated film with a base dielectric layer 52a, a conductive layer 52b (such as an ITO layer or the like) and an ink layer 52c, such that the dielectric layer is part of or incorporated in the film and is removed from or not disposed at the lower window panel.

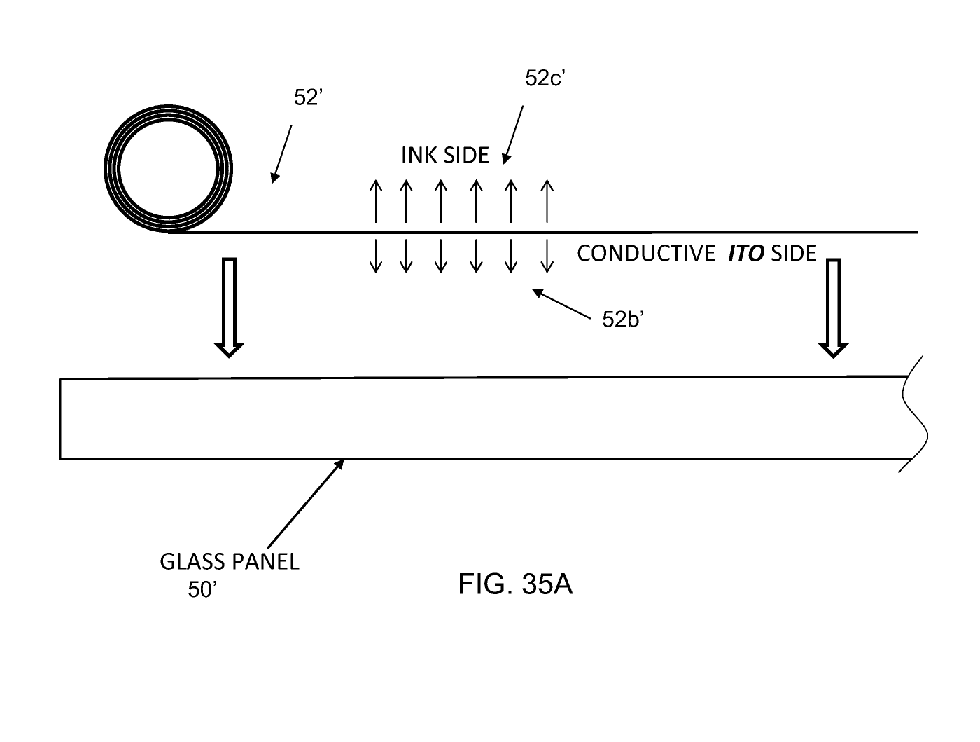

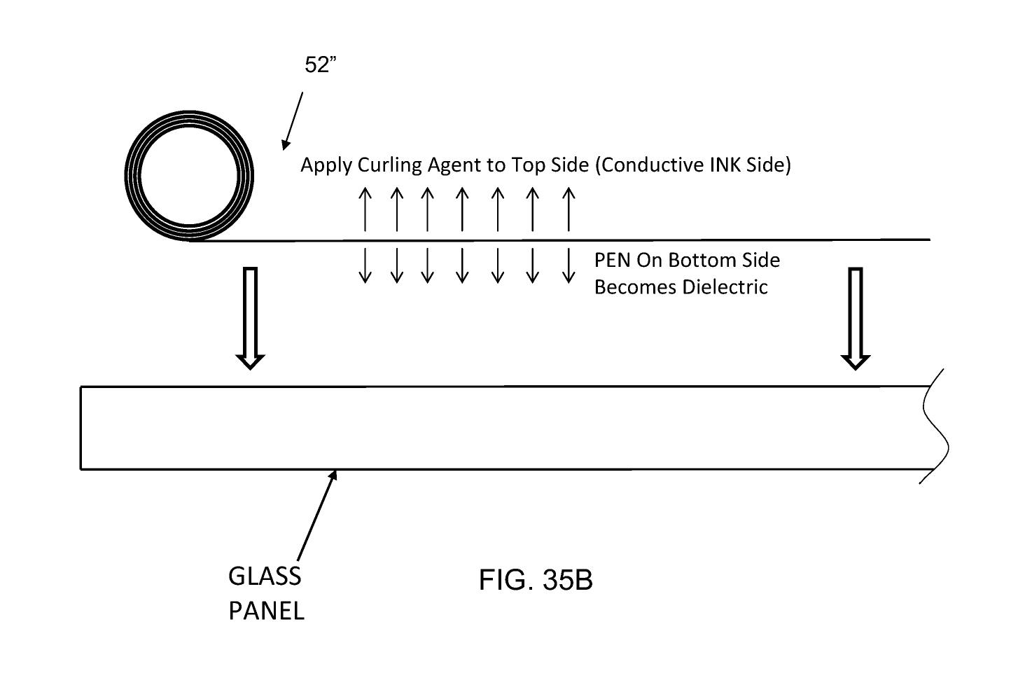

Optionally, and as shown in FIG. 35A, the shading element or film 52′ may have an ink layer 52c′ at its upper surface and an ITO layer 52b′ (or other conductive layer) at its lower surface that is disposed at the surface of the lower window panel 50′. Optionally, and as shown in FIG. 35B, the shading element or film 52″ may have a suitable curling agent applied at its upper surface (where the conductive ink layer is disposed). With such a configuration, the Polyethylene Naphthalate (PEN) at the lower surface of the shading element or film 52″ becomes dielectric.

Optionally, one or both of the upper and lower window panels may be tinted or darkened. For example, the lower window panel of the window assembly may be tinted or darkened or rendered partially opaque or partially non-transmissive of visible light (and/or UV light). Such a tinted window panel may assist in heat reduction, light blockage and hiding of imperfections, and may also reduce glare that may be caused by the mirror-like finish of the PEN film.

The shading element or film and the window assembly may be constructed via any suitable manufacturing means. For example, the shading element or film may be cut to the desired size and shape (from a larger sheet of the film or film material), and may be wound around a mandrel or rod. Optionally, a larger sheet or film material (that is larger than the eventual size of the shading element, such as wider and/or longer than the shading element designed dimensions) may be placed on a vacuum table to draw the sheet onto the table so it is suctioned down onto the table and secured relative to the table for cutting. Optionally, a larger sheet or film material may be placed on a charge plate, such as on a glass sheet or substrate with a charge plate disposed under the glass sheet, whereby, when the charge plate is energized, the film is drawn down against the glass sheet and held in place at the glass sheet during the cutting process. Such a charge plate film retaining system provides substantial securement of the sheet of film material during the cutting process and provides a smooth cutting surface (the surface of the glass sheet or substrate) so that a cutting instrument can readily and smoothly cut the film sheet to the desired size and shape, without encountering holes or the like in the cutting surface (such as may be encountered at a vacuum table cutting surface). The cutting process preferably is done in a “clean room” environment to limit or substantially preclude particles, such as dust or dirt particles, from being drawn to the sheet or film material during the cutting process. Optionally, and desirably, the clean room or chamber or environment for performing the cutting process and/or the assembly process of the window assembly is maintained at a desired relative humidity level or range, such as, for example, within or between about 20% RH to about 35% RH or thereabouts.

Optionally, the sheet or film material may be wound or coiled around a rod or axle as a large coil (that may have a selected or appropriate width for the shading element application and that has a length sufficient to be cut into multiple shading elements), and a free end of the coiled film may be wound around a mandrel and the larger coil may be unwound while the film is wound around the mandrel and then the film may be cut to the desired length, such that an appropriate sized shading element film or sheet is wound around the mandrel. The coiled film and mandrel may be then be heated to cure the sheet material. Optionally, the coiled film and mandrel may be first disposed in a sealed tube (such as a metallic tube with end caps that function to substantially seal the ends of the tube and to support the ends of the mandrel so the coiled film does not contact the inner surface of the metallic tube) and then placed on a conveyor that transfers the coiled film through an oven or heating device.

After the film is cut to the desired or appropriate size and shape for the shading element application, the shading element is disposed at the lower or inner window panel. For example, the free end of the coiled shading element may be clamped or otherwise affixed at the frame portion (such as described above) and then uncoiled from the mandrel across the lower window panel. Optionally, the end of the shading element that is distal from the clamped or affixed end may be coiled into a loop and glued or secured in the loop configuration, in order to provide an initial coil at the end of the shading element when the shading element is fully extended.

When the shade or film coil is installed at the lower window panel, it is desirable to determine the amount of force it takes to uncoil or extend the shade film for a particular window panel or assembly. This is because the amount of voltage required to properly extend or uncoil the shade is dependent on or a function of how much force is needed to uncoil the coiled shade. Thus, the present invention provides a force gauge to measure the spring constant of a shade as it is uncoiled across the window panel. The gauge measures and records the force it takes to push/unroll the shade (such as via having a portion of the gauge that pushes at the coil along the window panel to at least partially uncoil the film along the window panel). The higher the spring constant is for the coiled film, then the more voltage the shade will require to properly unroll, and a higher spring constant has been found to assist in limiting stored charge in the film. It is preferable to provide a low spring constant to allow for operation with a reduced voltage, but it is also preferable to provide enhanced limiting of stored charge in the film. Thus, it is important to know the spring constant for a particular shade or film coil, so the appropriate voltage can be applied to that particular window assembly to provide the proper operation of the window assembly and shade.

The spring constant may be affected by the tightness of the coiled shade or film and/or the thickness of the ITO layer at the film and/or the thickness of the Polyethylene Naphthalate (PEN) layer or substrate at the lower surface of the shading element or film. The present invention accounts for variations that may occur in these aspects of the coiled shading element or film by measuring the uncoiling force or spring constant of the coiled film to determine the preferred or appropriate voltage or power level to be applied to the film for proper operation of that particular window assembly and shade. Such an approach provides enhanced performance of the shade via measurements made during the manufacturing of the window assembly.

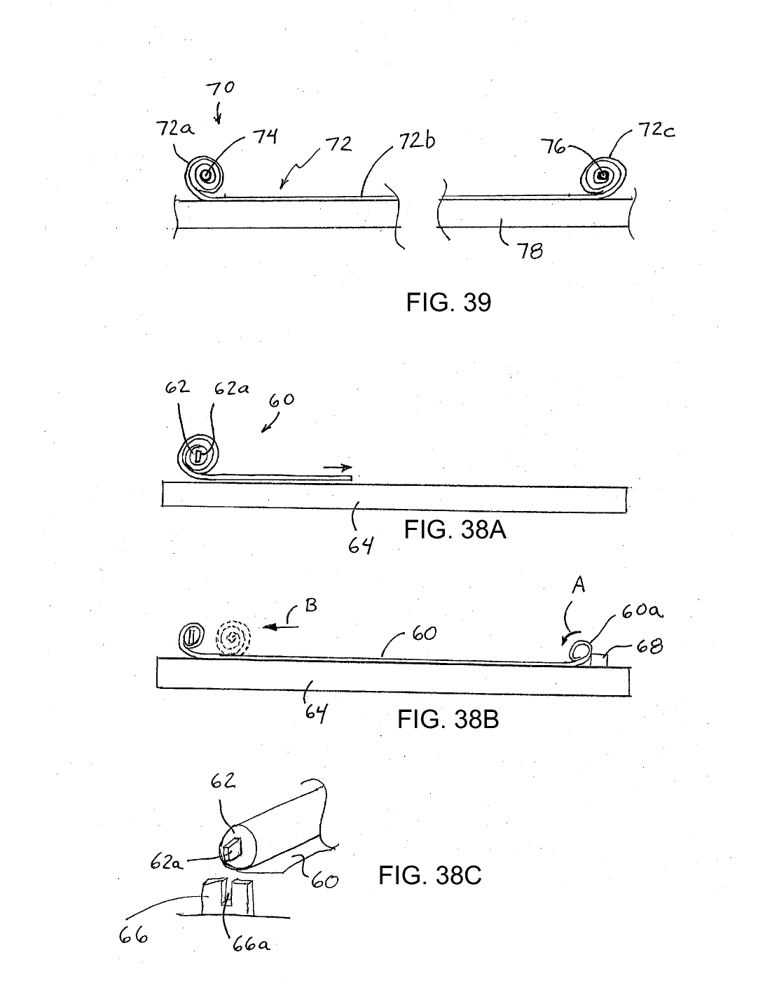

Optionally, and with reference to FIGS. 38A-C, a shading element or film 60 may be wound around a mandrel or rod 62 and disposed at a lower or inner window panel 64. In the illustrated embodiment, the mandrel or rod 62 has an end portion or protrusion 62a that is attached to or mounted at a mounting element or bracket 66 at the window panel 64 (such as at part of the frame or the like of the window panel). The mandrel or rod 62 may be rotatable to allow for extension of the film by unwinding the film from the rod 62 (such as shown in FIG. 38A). As can be seen in FIG. 38B, after the film is unwound to its fully extended state, the distal end 60a of shading element 60 may be coiled or partially coiled and adhered or secured in that shape or form (where the coiled distal end may be at a stop element 68 or the like when the shading element is fully extended or unwound). The shading element may then coil about its distal end 60a when it is coiled or retracted, with the mandrel or rod 62 securing or retaining the fixed end of the shading element at the frame portion and/or window panel.

In the illustrated embodiment, the rod end protrusion 62a comprises a non-circular shaped protrusion that is non-rotatably mounted at or received in a bracket or retaining element 66, such that the protrusion or mounting ends of the rod are non-rotatably attached at the window panel. Thus, when the protrusions 62a are mounted at the brackets 66 at the window panel (such as via being received in a slot 66a of the bracket such as shown in FIG. 38C), the film or shading element 60 may be unwound via pulling at the free end 60a, with the rod 62 rotating relative to the mounting protrusions 62a to allow for unwinding of the shading element 60 and extension of the shading element 60 across the window panel. When fully unwound or extended, the distal or free end 60a may be partially coiled (such as shown at arrow A in FIG. 38B) and the shading element may retract and extend in a similar manner as discussed above (so that the film coils around the free end 60a such as shown at arrow B in FIG. 38B), with the mandrel and mounting protrusions being generally fixed and non-rotating relative to the brackets 66 and window panel 64.

Optionally, both ends of the shading element may be wound around rotatably driven mandrels or rods to impart movement of the shading element across the window panel. For example, and with reference to FIG. 39, a shading element or device 70 may comprise a film 72 that has one end coiled around and/or attached to a first mounting mandrel or rod 74 and another end coiled around and/or attached at a second mounting mandrel or rod 76. Each of the rods is rotatably drivable in a coiling direction to coil the film 72 around the respective rod, while, during rotatable driving of one rod (such as via a rotational drive motor or the like), the other rod may freely rotate in its uncoiling direction to allow for uncoiling of the film from the non-driven rod. Such an arrangement may allow for two or more different types of shading features via the same or common shading device.

For example, and as shown in FIG. 39, the film 72 may comprise two or more segments or sections 72a, 72b, 72c, with each section providing a different degree of shading. For example, section 72a may comprise a transparent or substantially transparent or clear film section, while film section 72b may provide a partially opaque or reduced light transmitting film section (as compared to film section 72a) and film section 72c may provide a substantially opaque or, non-light-transmitting film section. Optionally, film 72 may provide gradient transition sections between the different transmissivity film sections to provide a smooth or less-abrupt change in shading during operation of the shading element or device 70.

Thus, when rod 76 is rotatably driven in a counterclockwise direction in FIG. 39, the film 72 may be coiled onto rod 76 and uncoiled from rod 74, such that transparent film section 72a is disposed or positioned at the window panel 78. When it is desired to shade or partially shade the window assembly, rod 74 may be rotatably driven (in the clockwise direction in FIG. 39) to coil film section 72a onto rod 74, while film 72 partially uncoils from rod 76, such as to position partially opaque film section 72b at the window panel (such as shown in FIG. 39). Further rotatable driving of rod 74 in that direction coils film 72 further onto rod 74 and uncoils film 72 further from rod 76, such that film section 72c may be disposed at or positioned at the window panel. Rotational driving of rod 76 (in the counterclockwise direction in FIG. 39) winds the film in the other direction to reposition the section 72b or 72a at the window panel. Thus, either rod 74, 76 may be selectively rotatably driven in a coiling direction to provide or dispose a desired or selected or appropriate shading film section (having a desired or selected or appropriate degree of shading or color or pattern or the like) at the window panel. The rods may be selectively rotated via respective rotational drive motors or the like disposed at one or both ends of the respective rods and operable responsive to a user input or drive control input or the like.

Although discussed above as providing three different degrees of shading via selective rotation of the rods, clearly, the shading element may provide two different degrees of shading or more than three different degrees of shading, depending on the particular application and desired shading options for the shading element or device. Also, although discussed above as providing different degrees of shading or light transmissivity, clearly, the shading film may have different sections that have or provide different colors or different degrees of reflectivity or different degrees of UV protection or different patterns or icons or images or the like, while remaining within the spirit and scope of the present invention. The rotational driving and film change may be responsive to a user input (such as a user input or switch or button actuatable by the driver or occupant of the vehicle) or may be automatically controlled via a control input, such as responsive to one or more ambient light sensors or temperature sensor or UV sensor or the like at the vehicle, or the like.

As discussed above, the shade or film may be uncoiled or extended across a window panel that may be curved in the direction of uncoiling, while the window panel may be substantially planar or non-curved in the direction along the longitudinal axis of the coiled shade or film. It has been found that maintaining the flatness along the non-curved direction of the lower window panel provides enhanced performance of the shade. Thus, it is desirable to maintain the flatness of the lower window panel within or below a selected tolerance to avoid using glass panels with warpage and/or surface irregularities and/or the like across the lower window panel that are above the specified tolerances and that thus may affect the performance of the shade. Thus, it is desirable to have a lower glass panel with controlled surface tolerances.

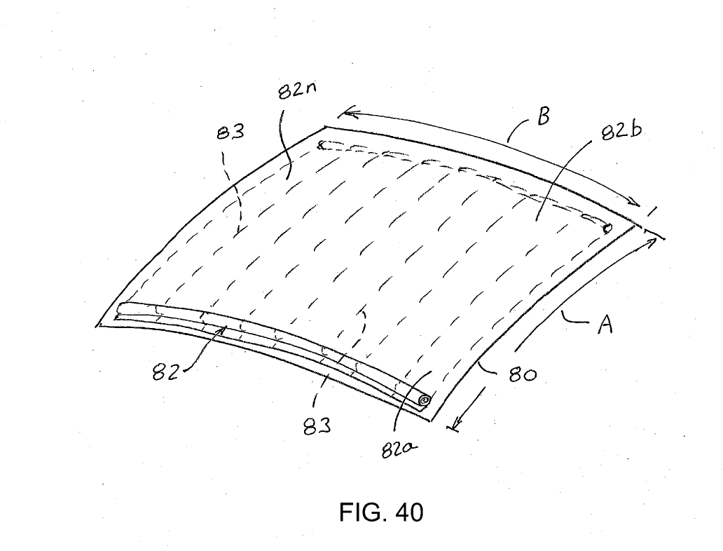

Optionally, it is envisioned that the shade or film may be adapted or configured to allow for flexing of the film to accommodate or conform to a window panel that is curved along the longitudinal axis of the coiled shade or film when the shade or film is uncoiled or extended. For example, and with reference to FIG. 40, a window panel 80 may be curved along a first dimension A and may also be curved along a second dimension B. A shading element or film 82 is disposed at the window panel 80 and is extendable and retractable to provide the desired shading of the window panel; such as in a similar manner as discussed above. The shading element or film 82 is configured to flex along the longitudinal axis of the coiled film (along the dimension B of the window panel) so that the shading element or film conforms to the curved surface of the window panel as it is uncoiled across the window panel.

For example, the shading element may comprise a flexible or elastic material that flexes or stretches to allow for flexing of the film as it is uncoiled to accommodate the curved surface. Optionally, the shading element may comprise elastic portions or elastic joining sections 83 between strips of the film material, so as to join multiple narrow strips 82a, 82b, 82c, . . . 82n of the film together to allow for stretching between the strips to accommodate or conform the overall film or shading element to the curved surface of the window panel when it is uncoiled across the curved window panel. Optionally, the shading element may comprise multiple strips of film material that are closely spaced together and unconnected or unjoined, whereby the individual film strips cooperate to provide the shading at the window panel and together conform generally to the curvature of the window panel as the film strips are uncoiled across the window panel. Optionally, other means for flexing or stretching the film material to accommodate or conform to the curvature of a curved window panel may be implemented while remaining within the spirit and scope of the present invention.

Optionally, the shading element of the present invention may be partially extended across a window panel to provide selective shading of a portion of the window panel. For example, a shading element may be selectively uncoiled and may stop the uncoiling at one or more locations between its fully coiled and fully uncoiled/extended positions, in order to provide shading of only a portion of the window assembly. For example, the window panel may have segmented electrostatic strips along the sides of the film path, whereby the strips may be individually energized or controlled to cause the film to uncoil in a step-by-step manner. The film thus may be selectively uncoiled a first amount to cover or shade a first portion of the window assembly (such as in response to a user input or the like), and, if desired, the film may be further uncoiled a second amount to cover an additional portion of the window assembly (such as in response to a user input or the like), and the film may be further uncoiled a third amount to cover an additional portion of the window assembly (such as in response to a user input or the like) and may continue to be selectively uncoiled additional amounts until the film is fully uncoiled or fully extends across the window panel. The window assembly thus provides selective control of the amount of shading across the window panel, such as for situations where a user may only want shading where the sun is hitting, while leaving the rest of the window panel open or unshaded. Optionally, the shading element may comprise different degrees of shading (such as via different shading sections of the shading element such as discussed above), whereby a user may selectively move a selected shading section a selected or desired amount across the window panel to provide the desired or selected degree of shading at a portion of the window panel.

The window assembly may comprise any suitable frame or sealing element or structure that establishes a substantially sealed interpane cavity in which the shading element is disposed. Optionally, the window assembly may include a breathing or pressure regulating element or device or feature, which allows the interpane cavity pressure to be regulated or controlled. For example, the pressure regulating feature may comprise a bladder or pump element that may allow for air to escape the interpane cavity to maintain the pressure generally constant, such as when the temperature of the window assembly increases (and the pressure in the cavity increases). Likewise, the pressure regulating feature may allow for air to enter the interpane cavity when the temperature of the window assembly decreases (resulting in a decrease or partial vacuum in the interpane cavity pressure).

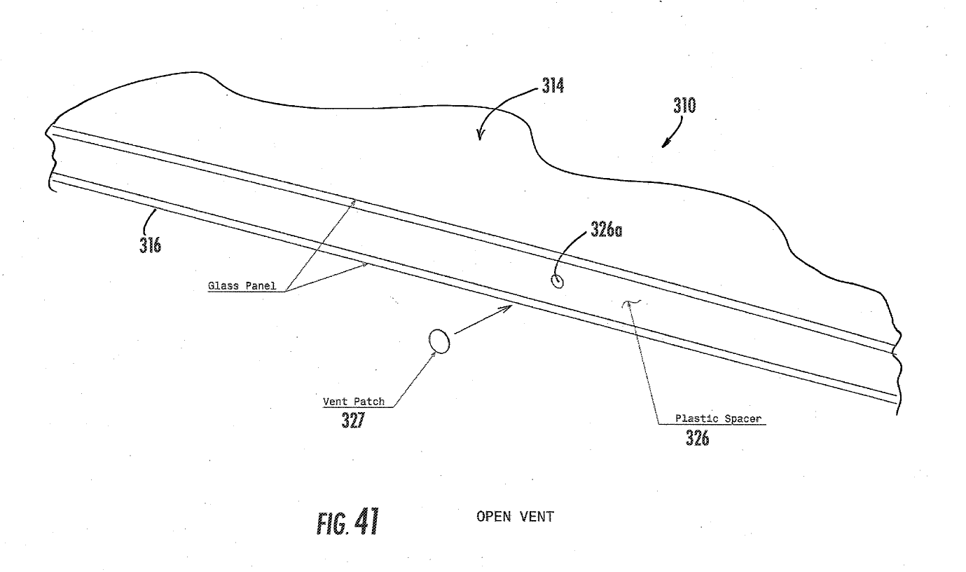

Optionally, and with reference to FIG. 41, a window assembly 310 may have upper and lower window panels 314, 316 and a spacer or frame 326 (such as in a similar configuration as discussed above), with the frame 326 having an aperture or hole 326a formed through a wall of the frame, whereby a vent patch 327 may be inserted into the hole 326a to plug the hole, while allowing air flow through the hole and vent patch to regulate or modulate the pressure within the cavity of the window assembly. Optionally, and such as shown in FIG. 42, a vent or vent patch 327′ may be threaded into a threaded aperture or hole 326a′ in the spacer or frame 326′ (which spaces and attaches the upper and lower window panels 314′, 316′ in a similar manner as discussed above), whereby the vent patch 327′ plugs the hole, while allowing air flow through the hole and vent patch to regulate or modulate the pressure within the cavity of the window assembly 310′.

The pressure regulating feature may comprise a sealed bladder or separate container, such that the addition and/or subtraction/venting of air relative to the cavity is accomplished with clean air and the interpane cavity, when air is added thereto, does not receive outside air that may include contaminants or debris or dust particles or the like. Optionally, the pressure regulating feature may include a filtering mechanism or filter that filters particles and contaminants from the air that is flowing into the cavity to limit or substantially preclude intrusion of contaminants or particles into the cavity. In such an application, it is envisioned that the air that flows into the cavity when the cavity pressure drops may be outside air that is substantially filtered as it enters the cavity.

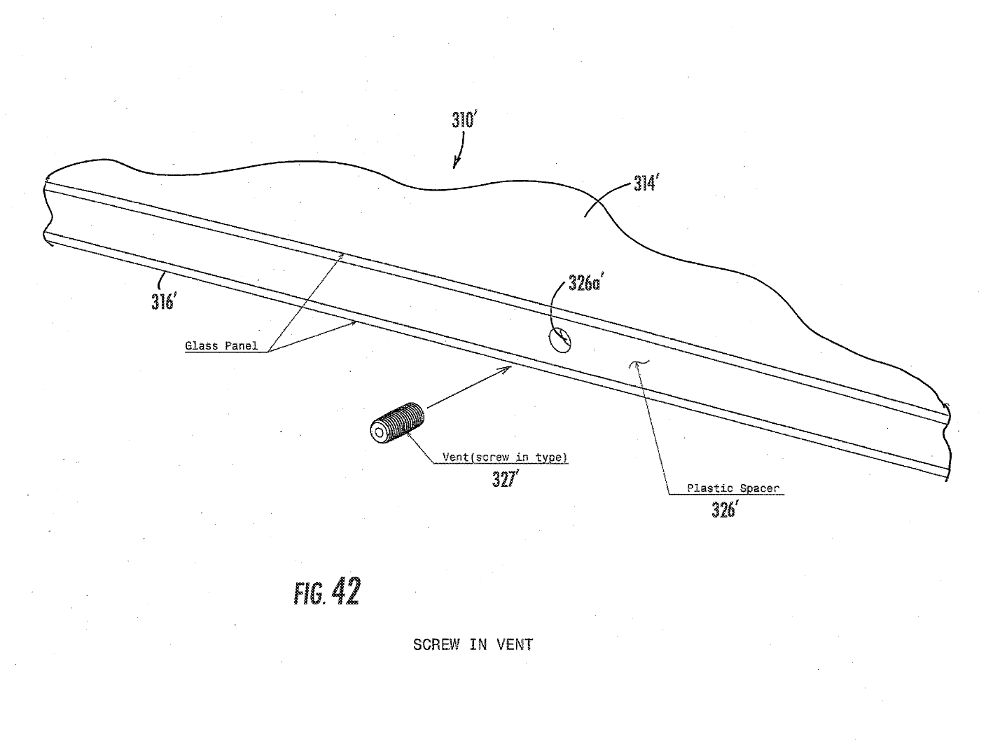

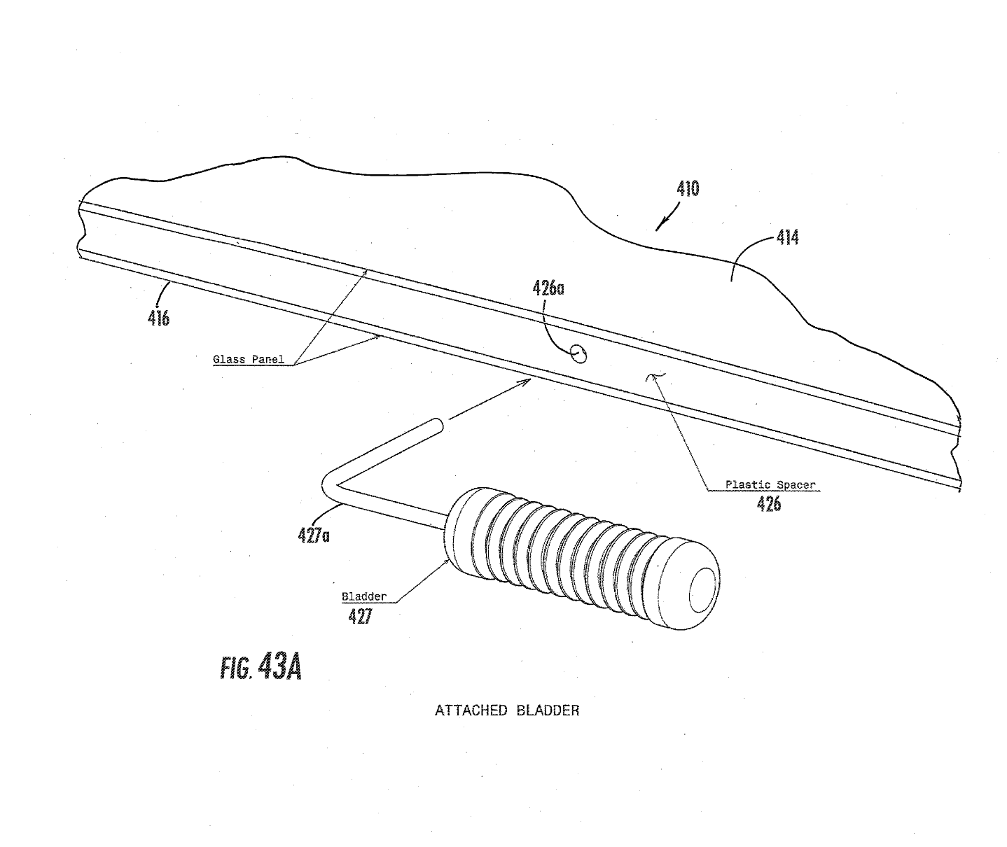

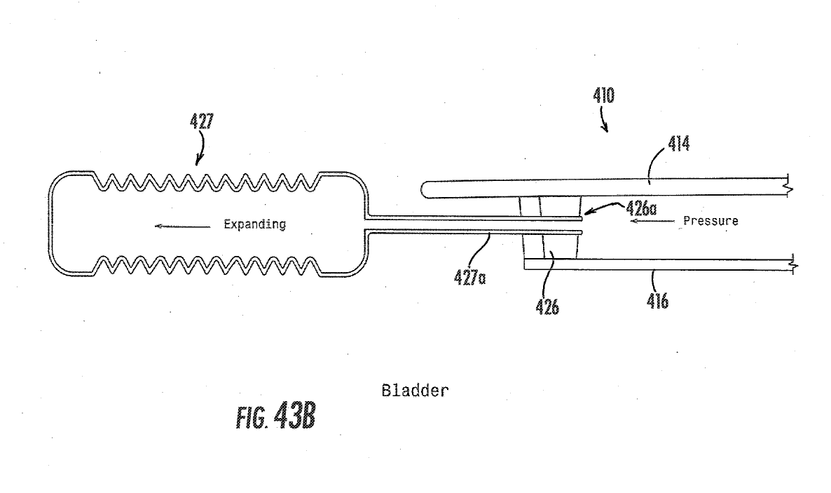

Optionally, and as shown in FIGS. 43A and 43B, a window assembly 410 may have upper and lower window panels 414, 416 and a spacer or frame 426 (such as in a similar configuration as discussed above), with the frame 426 having an aperture or hole 426a formed through a wall of the frame, whereby a tube or conduit 427a of a bladder or pressure regulating device 427 may be inserted into the hole 426a to connect the bladder 427 with the interpane cavity of the window assembly. Thus, when the pressure in the interpane cavity increases beyond a threshold level, the bladder 427 may expand to relieve the elevated pressure and, when the pressure in the interpane cavity decreases beyond a threshold level, the bladder 427 may contract to regulate the pressure within the interpane cavity of the window assembly. The bladder or pressure regulating device may comprise any suitable device or container that may expand and contract to receive air or gas from the interpane cavity when the interpane cavity pressure increases and to expel air or gas into the interpane cavity when the interpane cavity pressure decreases, in order to maintain the interpane cavity pressure at or near a desired or constant level.

Optionally, the window assembly may include a desiccant material or a desiccant canister or the like that functions to remove moisture that may be in the air or gas within the interpane cavity of the window assembly. For example, and with reference to FIG. 44, a window assembly 410 includes an upper window panel 414 and a lower window panel 416 and a spacer or frame 426, such as in a similar manner as described above, and includes a desiccant canister or tube or container 429 that is connected to or in fluid or air or gas communication with the interpane cavity of the window assembly (or optionally may be disposed in the interpane cavity), so as to remove moisture that may be present in the air or gas within the interpane cavity. In the illustrated embodiment, the desiccant canister 429 is connected to a line or tube or conduit 431 that passes through an aperture in a sidewall of the spacer 426. Thus, the desiccant canister may draw moisture that is present in the air or gas within the interpane cavity out of the interpane cavity and absorb the moisture in the desiccant material within the canister.

Optionally, the desiccant canister or tube or container may be installed directly at an aperture at the side of the spacer or frame (with no additional tubing or conduit), and the desiccant canister may have vent patches or valves at either or both ends of the canister to assist in regulating the interpane cavity pressure. Optionally, the canister may be detachably attached at the conduit 431, so that the canister may be readily removed and replaced when the desiccant material is saturated. The conduit 431 thus may extend from the sidewall of the spacer 426 and to a location within the vehicle (such as a compartment in the headliner of the vehicle) where a user may readily access the canister to remove and replace the canister. Optionally, the desiccant canister may be selectively heated or automatically or periodically or episodically heated to recharge the desiccant material and canister.

In the illustrated embodiment, the desiccant container is piped or connected to the aperture in the spacer 426 via conduit 431, which provides a venting function or pressure regulation function. For example, the conduit 431 may include one way check valves that allow flow of air or gas in one direction and limit or preclude flow in the other direction. As shown in FIG. 44, desiccant canister 429 is connected to an inlet conduit 431 that connects to the window assembly 410 and is also connected to a venting conduit 433 that vents the canister 429 to atmosphere. Inlet conduit 431 includes a venting one-way check valve 431a. Desiccant canister 429 also has a venting/inlet conduit 433, which has an inlet check valve 433a that allows air to enter the conduit 433 and the canister 429 (and the window assembly 410 via conduit 431), such as when the interpane cavity pressure decreases.

Thus, if the pressure in the interpane cavity of the window assembly 410 increases, venting check valve 431a at conduit 431 allows for air or gas to flow from the interpane cavity, through inlet conduit 431 and out venting check valve 431a. If the pressure in the interpane cavity decreases, inlet check valve 433a allows for air to flow into conduit 433 and into desiccant canister 429 and into conduit 431 and into the window interpane cavity. Optionally, the inlet conduit 431 may include a second one-way check valve 431b that limits air flow into the desiccant canister during such an increase in pressure in the interpane cavity, while a second or venting check valve 433b may be disposed at conduit 433 to allow for venting of air within desiccant canister 429. The check valves 431a, 433a, 433b may comprise any suitable one-way flow valve.

Although shown and described as having a desiccant canister or element disposed outside of the window cavity, it is envisioned that such a moisture absorbing element or canister may be disposed inside the sealed interpane cavity. For example, a desiccant canister or material may be disposed into a hollow anchor element and/or roll stop of the window assembly, with the hollow element or stop having at least one aperture formed therethrough so that the desiccant material is vented to the interpane cavity to draw and collect or absorb moisture present in the interpane cavity of the window assembly. Optionally, the desiccant element or canister may also or otherwise be disposed along or partially along one or both of the side walls of the frame or spacer and within the interpane cavity.

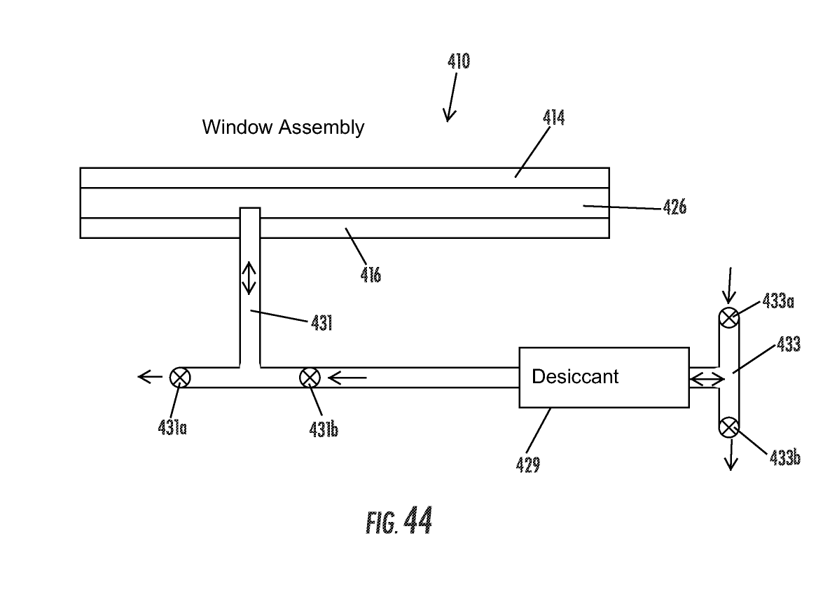

Optionally, and as shown in FIG. 45, a window assembly 510 may have upper and lower window panels 514, 516 and a compressible/expandable spacer or frame 526 (which spaces and attaches the window panels in a similar manner as discussed above). The frame 526 may comprise a flexible or compressible/expandable structure (such as Z-shaped structure or portion 526a as shown in FIG. 45) to allow for expansion of the frame (and thus enlargement of the interpane cavity) when the interpane cavity pressure increases and to allow for compression of the frame (and thus contraction of the interpane cavity) when the interpane cavity pressure decreases. The spacer 526 may be adhered or attached or molded at the upper and lower window panels via any suitable means (such as via an adhesive 527 disposed, within a recess 526b of the spacer to provide the appropriate amount of adhesive at a selected bond line thickness to bond the spacer to the window panel). Thus, when the pressure in the interpane cavity increases beyond a threshold level, the Z-shaped portion 526a of frame 526 may elongate or expand to increase the interpane cavity size or volume and thus to relieve the elevated pressure and, when the pressure in the interpane cavity decreases beyond a threshold level, the Z-shaped portion 526a of frame 526 may fold or compress or contract to regulate the pressure within the interpane cavity of the window assembly.

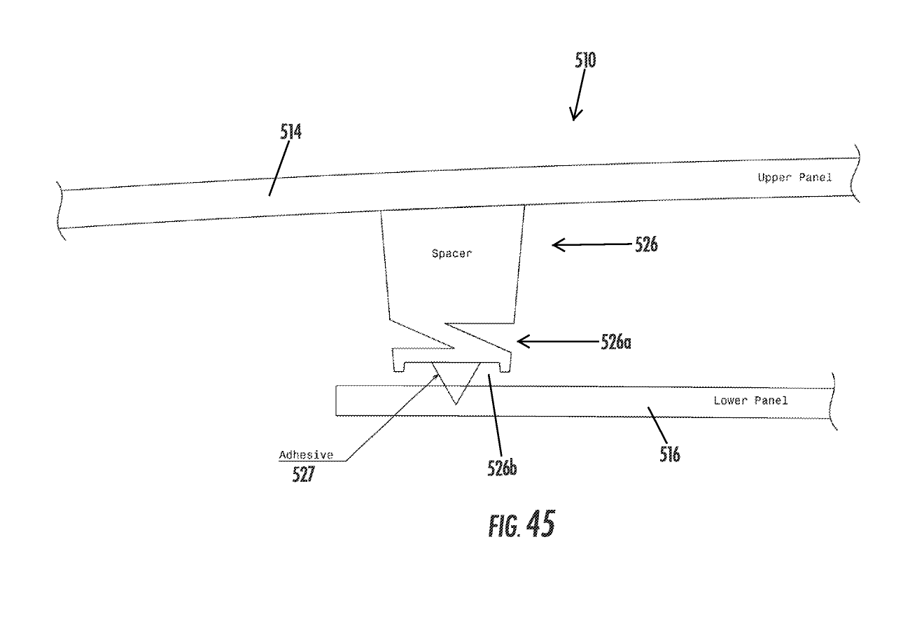

Other forms of spacers or frames may be implemented to provide the desired expansion and contraction of the spacer during pressure fluctuations within the interpane cavity of the window assembly. For example, and with reference to FIG. 46, the spacer or frame 526′ of a window assembly 510′ may be formed with a C-shaped or V-shaped notch 526a′ to provide a living hinge or active hinge 526d′ type configuration. The spacer 526′ may include a raised stop or bump 526c′ at the notch 526a′ to maintain partial separation or gap at the notch even when the spacer is in its compressed state (as shown in FIG. 46). The spacer 526′ may be adhered or attached or molded at the upper and lower window panels via any suitable means (such as via an adhesive 527′disposed within a recess 526b′ of the spacer to provide the appropriate amount of adhesive at a selected bond line thickness to bond the spacer to the window panel).

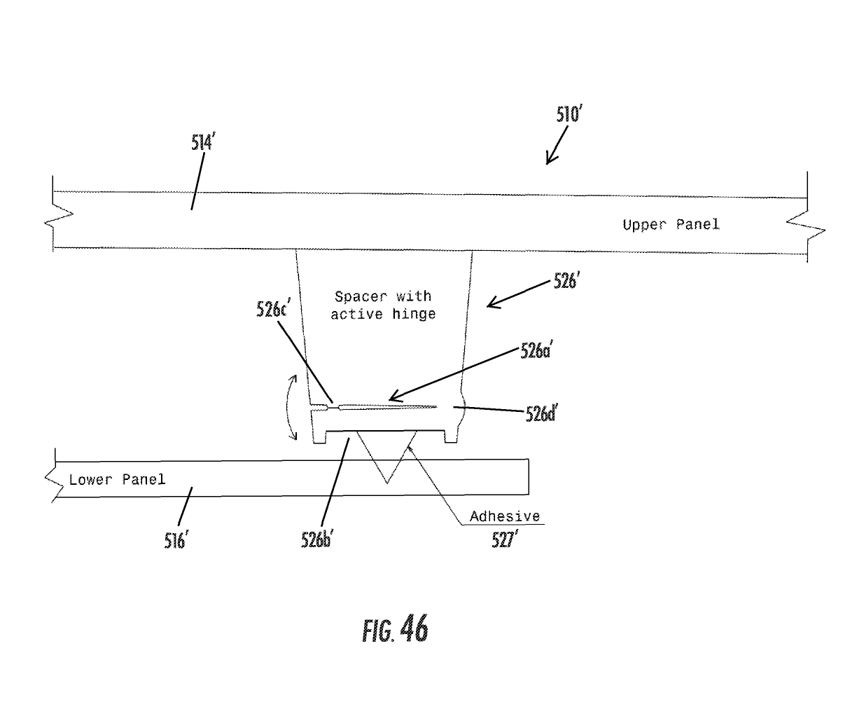

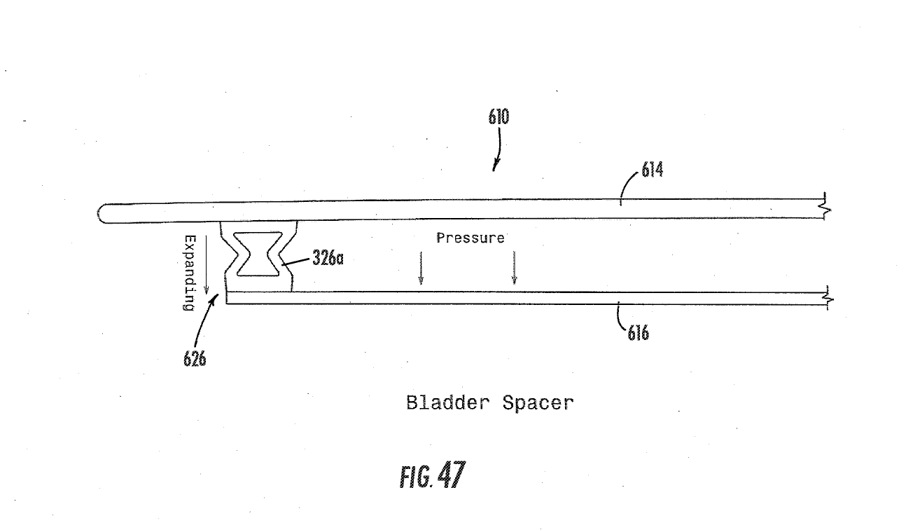

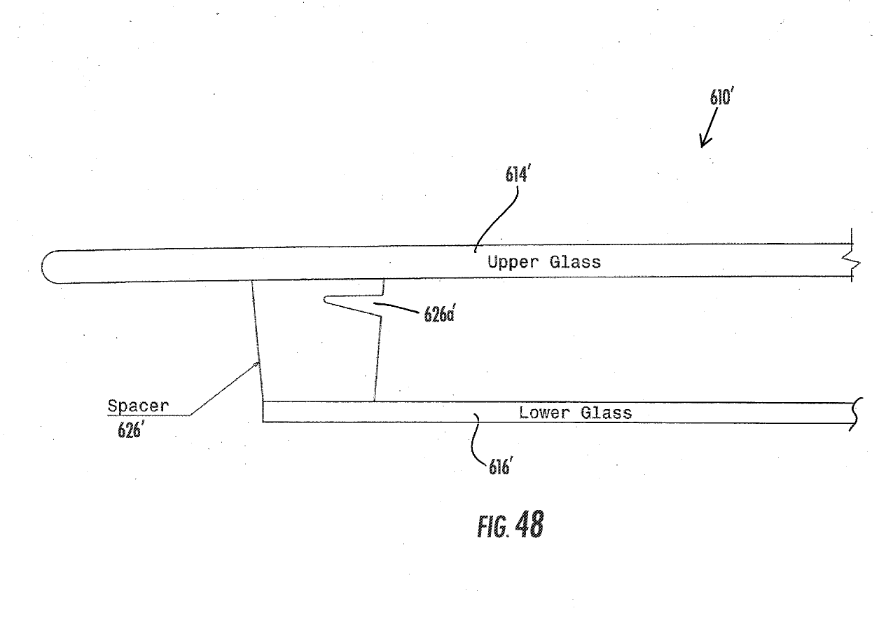

Optionally, the spacer may be otherwise formed. For example, and with reference to FIG. 47, the spacer 626 of a window assembly 610 may comprise an accordion type structure with side walls 626a that fold or flex as they extend/retract responsive to pressure changes within the interpane cavity between the upper window panel 614 and the lower window panel 616. Optionally, and as shown in FIG. 48, the spacer 626′ of a window assembly 610′ may comprise a notch 626a′ that allows for flexing and expansion/contraction of the frame to allow for relative movement between the upper and lower window panels 614′, 616′ to generally maintain the interpane cavity pressure within a desired or acceptable or selected pressure range.

Optionally, the pressure regulating feature may be responsive to a pressure sensor in the cavity to maintain the pressure at a desired level. For example, a pump or bladder or pressure regulating device may be operable to flow air into the cavity when the cavity pressure drops below a lower threshold level and/or the pump or bladder or pressure regulating device may be operable to draw air from the cavity when the cavity pressure rises above an upper threshold level. The pump or bladder or pressure regulating device may include a valve that is openable when the pressure is to be adjusted and is closed when the interpane cavity pressure is within or between the upper and lower threshold levels. The window assembly thus may have a substantially sealed interpane cavity (with the spacing and/or sealing frame or element sealed against the inner surfaces of the spaced apart window panels), and the pressure regulating device provides control of the interpane cavity pressure when the window assembly is exposed to a wide range of temperatures, such as typically occurs during use on a vehicle over the lifetime of the vehicle including operation of the vehicle in different seasons and climates and weather conditions.

Optionally, the window assembly may have a gas disposed within the sealed cavity that enhances the operation of the shade. For example, the window assembly cavity may include a sulfur hexafluoride gas (or the like) disposed within or inside of the insulated glass unit. Such a gas in the window cavity functions to impede or reduce the movement of the charges to the dielectric surface of the window panel (and thus may partially or substantially neutralize positive and negative charges within the unit) and aids in limiting or substantially precluding “stored charges” and unwanted ionization, which can affect the shade's operation and may limit the shade's ability to extend and retract properly. Thus, the addition of such a gas in the sealed interpane cavity of the window assembly provides enhanced performance of the shade during use of the shade and window assembly. Optionally, a venting element or device (such as discussed above) may be disposed at a vent hole and, desirably, the vent hole may be established towards an upper region of the sidewall of the spacer or frame, since the sulfur hexafluoride (SF₆) gas (or the like) is heavier than air and may reside toward the bottom of the interpane cavity, whereby the venting feature may vent the air that is within the interpane cavity and may not vent the gas disposed therein.

Optionally, the sealed interpane cavity may be filled with a gas via a vacuum filling process. For example, the sealed window assembly may have a fill port at one portion of the seal and a vacuum port at another portion of the seal (such as at an opposite side of the window panel from the fill port), and the fill port may be exposed to the gas (such as via placing that portion of the window assembly within a chamber filled with the gas) and the vacuum port may have a vacuum or negative pressure or reduced pressure applied thereto, whereby the air within the interpane cavity is drawn out through the vacuum port and the gas within the chamber is drawn into the interpane cavity via the fill port. Optionally, other means for vacuum filling the interpane cavity with a gas may be implemented. For example, the sealed window assembly may have only a fill port, and the window assembly may be exposed to a negative pressure or vacuum or reduced pressure, and then the fill port may be exposed to the gas and the negative pressure may be removed or may be vented to atmosphere, whereby the gas is drawn into the low pressure cavity (such as in a similar manner as used for filling electrochromic mirror reflective element cells with an electrochromic medium, and such as described in U.S. Pat. No. 7,255,451 and/or U.S. patent application Ser. No. 13/099,554, filed May 3, 2011 (Attorney Docket DON01 P-1703), which are hereby incorporated herein by reference in their entireties). The fill port (and vacuum port if applicable) are then plugged and sealed to seal the gas within the interpane cavity.

Optionally, the window assembly may include a gas or oxygen sensor within the insulated and sealed glass unit for sensing the gas composition within the interpane cavity. Such a sensor is operable to detect a change in gas composition and thus may detect when a crack or leak occurs at the glass panel or panels or spacer element. For example, if a sensor detects oxygen in the sealed interpane cavity, then the system determines that there may be a crack or leak in the window assembly, and an alert may be generated so the window manufacturer is alerted to a potentially faulty seal or window panel and/or the driver of a vehicle equipped with the window assembly is alerted of a potentially faulty seal or window panel and thus may take the vehicle and window assembly in for service.

Optionally, the window assembly may also or otherwise utilize high frequency polarity switching to counteract any stored charge that may be stored at the window panel.

The spacing frame elements or frame may be sealed at or to the inner surfaces of the window panels via any suitable means, such that the window panels are retained together and the interpane cavity established between the window panels is substantially sealed. For example, the spacing frame elements may be adhered to the panel surfaces, with one or more adhesive beads and/or sealant beads and/or desiccant beads and/or the like disposed thereat, such as discussed above. Optionally, the spacing frame elements may be welded (such as via infrared (IR) welding or the like) at the window panel surface or surfaces and/or to other spacing frame elements, in order to substantially secure or attach the window panels together and to substantially seal the interpane cavity.

For example, and with reference to FIG. 49, a frame element 726 is attached to a window panel 714 (such as the upper or outer window panel in FIG. 49), and is configured to mate with and attach to the other window panel 716 (such as the lower or inner window panel in FIG. 49). The mating surface 716a of the window panel 716 may be primed and/or the mating surface 726a of the frame element 726 may be primed, and the window panel 716 and/or frame element 726 may be substantially heated (such as via infrared radiation or induction heating or the like), whereby the heated mating surfaces are pressed together to weld or melt the frame element 726 to the window panel 716, thereby attaching the window panels together and sealing the interpane cavity via the welding of the frame element to the window panel (the frame element may also be similarly attached or welded to the window panel 714, such as via an initial welding or bonding process). For example, a perimeter frame may be attached or adhered or welded to a first window panel via any suitable means, and a shading element (not shown in FIG. 49) may be disposed at the frame such as in a similar manner as discussed above, and then the mating surfaces of the perimeter frame and/or the second window panel may be heated (such as via any suitable heating means) and the perimeter frame and second window panel may be pressed together and then cooled and/or cured to substantially bond and seal the perimeter frame relative to the window panels, with the shading element disposed in the sealed interpane cavity established between the window panels and bounded by the sealed perimeter frame.

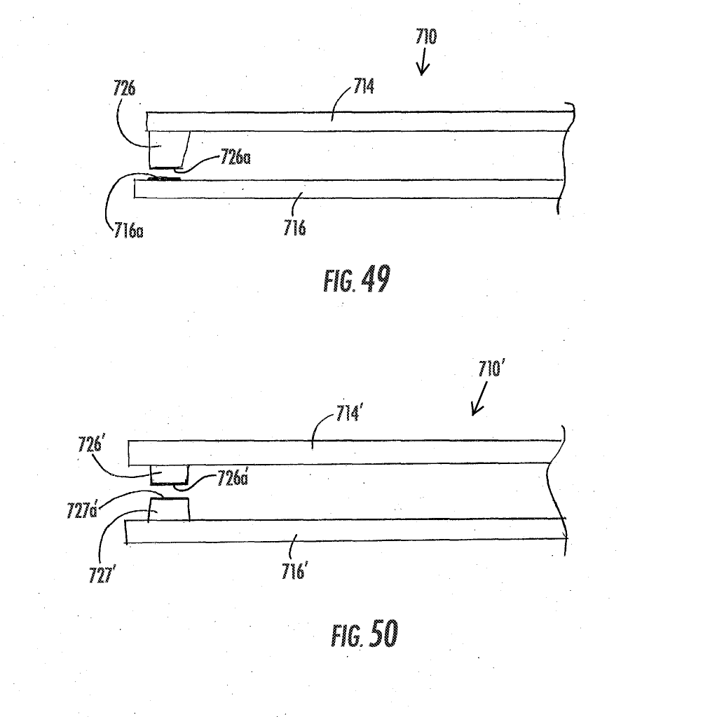

Optionally, and with reference to FIG. 50, a first frame portion 726′ may be attached or adhered or welded or bonded to a first window panel 714′ and a second frame portion 727′ may be attached or adhered or welded or bonded to a first window panel 716′, such as via any suitable attaching and sealing means. After the shading element (not shown in FIG. 50) is attached to or disposed at an appropriate one of the frame portions and window panels, the window panels may be positioned at one other as shown in FIG. 50. The mating surface 726a′ of first frame portion 726′ and the mating surface 727a′ of second frame portion 727′ may be primed (such as via application or robotic application of a suitable priming coating or material) and the mating surfaces 726a′, 727a′ may be heated (such as via any suitable heating means, such as infrared radiation or induction heating or the like), and then pressed together to weld or melt the frame elements 726′, 727′ to one another, thereby attaching the window panels together and sealing the interpane cavity via the welding of the frame elements together (and optionally with the frame elements similarly attached or welded to the respective window panels, such as via initial welding or bonding processes). Thus, a first perimeter frame portion may be attached or adhered or welded to a first window panel via any suitable means, and a second a perimeter frame portion may be attached or adhered or welded to a second window panel via any suitable means, and a shading element may be disposed at a leg or section of one of the frame portions such as in a similar manner as discussed above, and then the mating surfaces of the perimeter frame portions may be heated (such as via any suitable heating means) and the perimeter frame portions may be aligned with one another and pressed together and then cooled and/or cured to substantially bond and seal the perimeter frame portions together, with the shading element disposed in the sealed interpane cavity established between the window panels and bounded by the sealed perimeter frame portions.

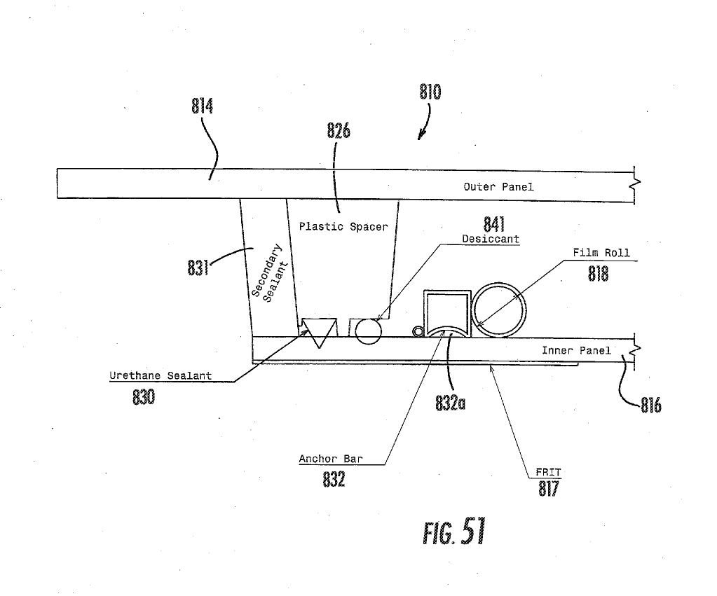

Optionally, and with reference to FIG. 51, a window assembly 810 includes an outer or upper window panel 814 and an inner or lower window panel 816, with a spacer or frame element 826 attached thereto. As shown in FIG. 51, the spacer 826 may have a bead of urethane sealant 830 or the like along an outboard channel or portion and a bead of desiccant 841 or the like along an inboard channel or portion of the frame or spacer. A secondary sealant 831 may be disposed around the periphery of the window assembly and outboard the spacer or frame. The frame or spacer 826 may be attached or adhered or bonded or welded to the window panels via any suitable means, such as discussed above. Optionally, a substantially opaque layer 817 (such as a ceramic frit layer or the like) may be disposed at the outer or lower surface of the lower window panel 816, so as to substantially conceal from view the frame 826 and film roll 818 and anchor bar 832 to a person viewing the window assembly from within the vehicle at which the window assembly is installed.

The film roll 818 is anchored at the anchor bar 832, such as via any suitable means such as discussed above. Optionally, and as shown in FIG. 51, the anchor bar 832 may have a concave lower surface 832a that has a curvature so that the lower edge regions of the bar 832 engage the coated surface of the lower window panel across the panel. Such a concave bar configuration limits or substantially precludes flat spots or areas along the anchor bar that may affect the contact of the anchor bar at the inner surface of the inner or lower window panel. Optionally, the roll stop may also or otherwise have such a concave contact surface to enhance contact of the roll stop at the window panel surface.

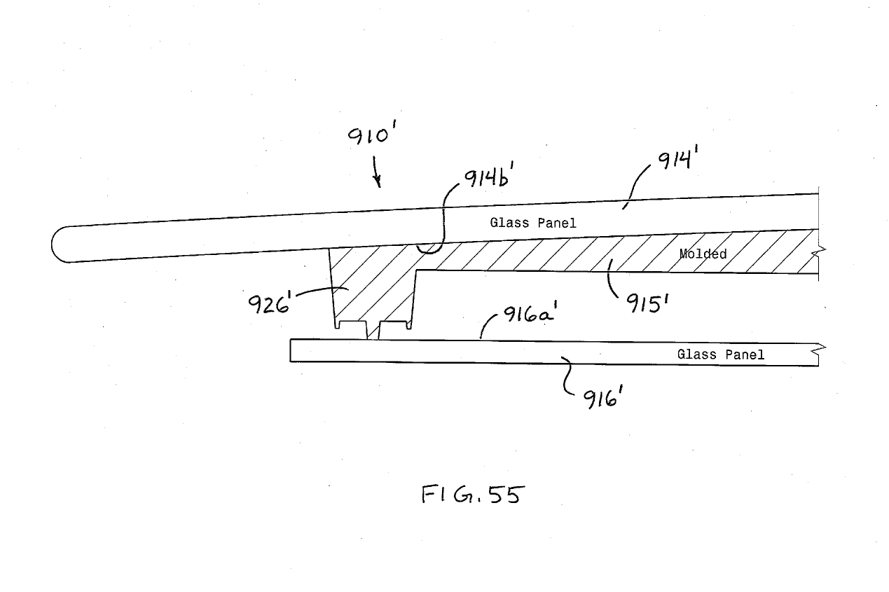

Optionally, the upper window panel of a window assembly of the present invention may comprise a complex curved outer surface and a non-complex curved inner surface, with the inner surface having a curvature in one direction that generally corresponds to the curvature of the lower window panel. For example, and with reference to FIG. 54, an upper window panel configuration 914 of a window assembly 910 may comprise a complex curved outer surface 914a and a complex curved inner surface 914b, with a molded insert element 915 that has a complex curved outer surface 915a and a non-complex curved inner surface 915b, with the inner surface 915b being generally planar or having a curvature in one direction that generally corresponds to the shape or form of the lower window panel 916. The insert element 915 mates with and may be adhered or bonded or established at the inner surface 914b of the outer or upper window panel 914 and the spacer 926 may also be bonded or adhered at the inner surface 914b of the outer or upper window panel 914. The spacer 926 is bonded to the inner surface 916a of the inner window panel to assemble the window panels together and establish the interpane cavity therein (where a shade element of the types described herein may be disposed). Thus, the outer panel configuration provides an inner surface 915b that is formed to correspond to the shape or curvature of the inner panel 916, while the outer surface of the outer panel 914 is curved to correspond to the curvature of the exterior of the vehicle. Thus, a substantially uniform gap or spacing is provided between the inner surface of the lower window panel and the inner surface of the upper window panel/structure.

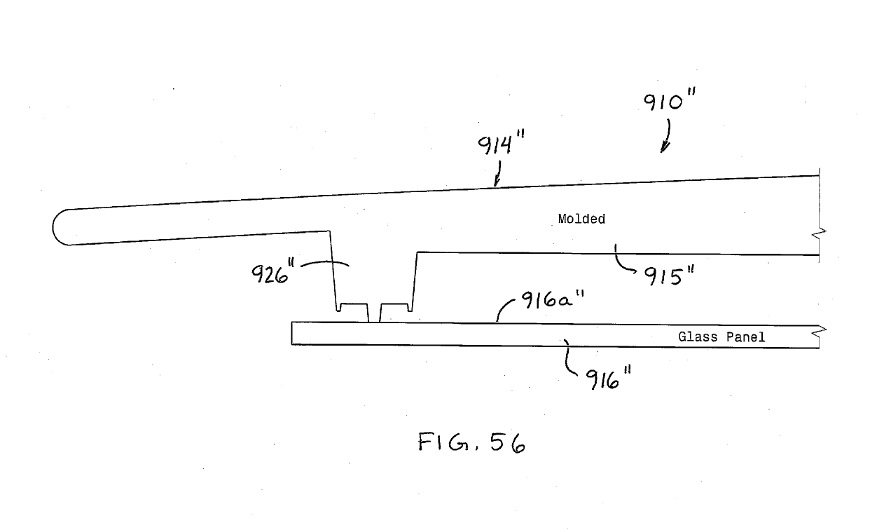

Optionally, and with reference to FIG. 55, the molded insert element 915′ of a window assembly 910′ may be integrally or unitarily formed or molded (such as via injection molding or the like) with the spacer 926′, whereby the insert and spacer structure is bonded to or molded to or otherwise attached at the inner surface 914b′ of upper window panel 914′ and then the spacer 926′ is attached or bonded or adhered to the inner surface 916a′ of lower window panel 916′. Optionally, and with reference to FIG. 56, the upper window panel 914″ of a window assembly 910″ may be integrally formed or molded (such as via injection molding or the like) to include the insert portion 915″ and/or the spacer portion 926″ (such as with both the insert portion and the spacer portion and the window panel portion being integrally molded or formed as a unitary structure, such as shown in FIG. 56). Such a unitary structure may comprise any suitable material, such as a polycarbonate material or an acrylic material or the like. The mating surface of the spacer portion 926″ may then be bonded or adhered or attached at the inner surface 916a″ of the lower window panel 916″ such as in a similar manner as described above. The window assemblies 910, 910′, 910″ of FIGS. 54-56 may be otherwise similar in construction and function as the window assemblies described above and below, such that a detailed discussion of the shade or film and other components/features need not be repeated herein.

Optionally, although described above as an electro-polymeric shade element, it is envisioned that the interpane cavity shading element may comprise any other suitable type of shade element that may be disposed in the cavity or sandwiched between the window panels. For example, the shade element or shading means may include other suitable shading means, such as electro-optic shading means, such as for example, liquid crystal shading devices or electrochromic shading devices and/or suspended particle devices (SPD) or an organic light emitting diode (OLED) element, or the like. In order to facilitate use of such shading means, the window assembly may provide a substantially constant or uniform gap between the inner and outer window panels (while still providing a complex curved outer panel). For example, the outer or upper window panel may be formed or molded with a complex curved outer surface and a non-complex curved inner surface (or an insert may be formed or molded to conform with a complex curved inner surface of the outer panel while providing a non-complex curved inner surface), such that the inner surface of the outer panel (or the inner surface of the insert element) is generally parallel with the inner surface of the inner panel.

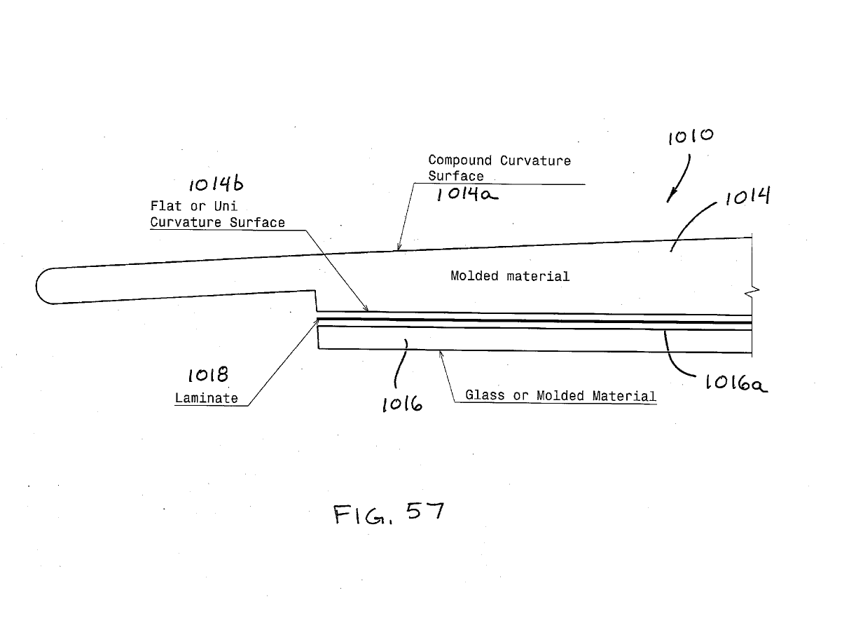

Optionally, for example, a window assembly may provide an outer window panel with a complex curved outer surface and a non-complex curved inner surface, whereby the inner surface of the outer window panel (which may be generally planar or may be curved in one direction to generally correspond the curvature of the inner surface of the inner window panel) may be generally parallel to the inner surface of the inner window panel, with a laminate or film type of shade sandwiched between the opposing, generally parallel surfaces. For example, and with reference to FIG. 57, a window assembly 1010 includes an outer window panel 1014 that has a complex curved or compound curvature outer surface 1014a and is formed (such as by molding or injection molding or the like) to have a generally planar or non-complex curved or flat or uni-curvature inner surface 1014b, which is generally parallel to or corresponds with the inner surface 1016a of the inner window panel 1016. In the illustrated embodiment, a shade element 1018 is disposed between the surfaces 1014b and 1016a and may be laminated therebetween or sandwiched therein to provide a laminated or pressed film element or shade element (such as a liquid crystal display element or an organic light emitting diode element or a suspended particle devices element or the like), with the generally parallel and corresponding opposed surfaces 1014b, 1016a maintaining the laminate element therein to avoid any wrinkles or irregularities that may otherwise occur in such a construction. The upper window panel and lower/insert element construction may comprise a molded or formed construction (such as a polycarbonate or acrylic material or the like) or the upper window panel may comprise a glass or polycarbonate or acrylic panel with a molded or formed insert element adhered or bonded or attached or established or molded at the complex curved inner surface of the upper window panel (such as in a similar manner as discussed above with reference to FIGS. 55 and 56). The lower window panel may comprise a glass window panel or may comprise a molded or formed polycarbonate or acrylic panel or the like.

The molded or formed outer panel and/or the insert element is formed to provide an inner surface that generally corresponds with the shape or curvature of the lower panel, and may provide a narrow gap or cavity between the window panels. Such a narrowed gap is suitable for use of an SPD or OLED or LCD shading element or device. Thus, the present invention provides a means for allowing and using a complex curved upper panel and a non-complex curved lower panel (such as a lower panel that is curved in one direction and generally flat in the other), and allows for use of shading elements or devices that may be laminated at and between the closely spaced apart inner surfaces of the inner and outer panels (while avoiding any wrinkling or buckling of the laminated materials). Optionally, an SPD material may be formed with its upper and lower layers or films having the complex curvature of the respective inner surface of the upper and lower window panels, such that the complex curved SPD film fits between and conforms to the correspondingly formed or shaped window panels.

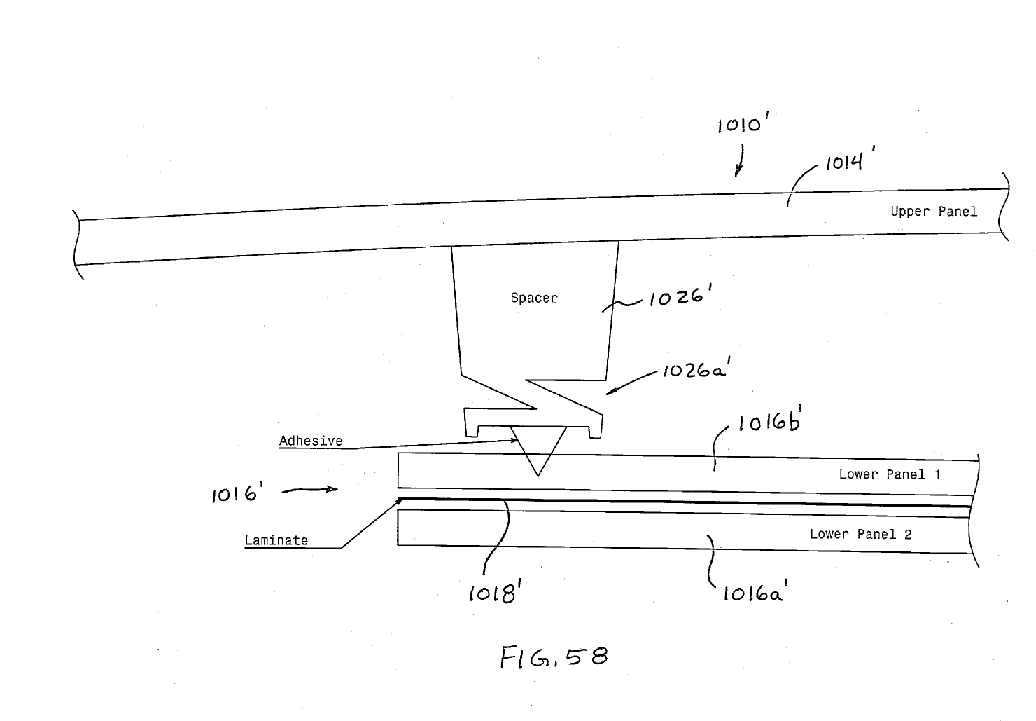

Optionally, and with reference to FIG. 58, a window assembly 1010′ includes a complex curved outer window panel 1014′ and a generally planar or non-complex curved inner window panel assembly 1016′, with a spacer or frame element 1026′ attached thereto and establishing an interpane cavity between the window panels. As shown in FIG. 58, the lower window panel assembly or construction 1016′ comprises a laminate with a lower or outer lower panel 1016a′ and an upper or inner lower panel 1016b′, with a film element or shade element 1018′ disposed or sandwiched or laminated therebetween. The lower window panel assembly 1016′ thus contains the shade element (such as an SPD or OLED or LCD shading element or device or the like) in the small and uniform or substantially uniform gap between the panels 1016a′, 1016b′, while the upper or outer window panel 1014′ provides the desired or selected surface curvature for the exterior of the vehicle. The spacer 1026′ provides or establishes the appropriate spacing between the upper window panel 1014′ and the lower window panel construction 1016′ so that the upper window panel 1014′ may be at the exterior surface of a vehicle (such as at the roof of a vehicle) and the lower or inside surface of the lower window panel construction may be at the interior trim or headliner of the vehicle. Optionally, and as shown in FIG. 58, the spacer 1026′ may comprise an expandable and collapsible spacer element (and may have a generally Z-shaped portion 1026a′) to allow for expansion and contraction of the window assembly to accommodate pressure fluctuations in the interpane cavity between the upper and lower panels 1014′, 1016′, such as in a similar manner as described above. Optionally, other means for venting or controlling or regulating the pressure within the interpane cavity may be implemented (such as via vents or bellows or bladders or the like), such as in a similar manner as described above.

Thus, the present invention provides for a window assembly with an outer window panel having a curved outer surface of one shape or form and an inner window panel having a curved or flat inner surface of a different shape or form. Thus, the window assembly may have upper and lower window panels with different shapes or forms or curvatures, while providing a shade feature at or between the window panels, such that an outer surface of the window assembly may have one curvature or shape and an inner surface of the window assembly may have another curvature or shape. A spacer element may be implemented to provide a desired or appropriate or selected spacing or gap between the window panels. The curvatures or shapes and/or gaps are selected based on the particular application of the window assembly. Although shown and described as having a complex curvature at the outer window panel (such as at the outer surface of the outer or upper window panel) and a non-complex curvature at the inner window panel (such as at the inner surface of the inner or lower window panel), the outer window panel may have a non-complex curvature that is different than the non-complex curvature of the inner window panel and/or the inner window panel may comprise a generally planar or flat window panel, while remaining within the spirit and scope of the present invention.

Optionally, the window assembly may include any other suitable type of shade element that may be disposed in the cavity or sandwiched between the window panels and that may be coiled or otherwise retracted to a retracted position and uncoiled or extended to an extended or shading position within the interpane cavity. For example, the shade element may have a coiled sheet or film that may be disposed in the interpane cavity and uncoiled and coiled via a motor that imparts rotation to the coiled sheet or that imparts translational movement of the sheet along and within the interpane cavity of the window assembly (such as via moving a leading end of the sheet along the cavity and optionally with one or more guide elements or channels along the sides of the cavity that receive the side portions of the shading element therein to guide the shading element between its shading and non-shading positions). For example, the shade element may utilize aspects of any other suitable interpane sun shade or screen assembly, and may utilize aspects of the shades or screens described in U.S. patent application Ser. No. 11/243,783, filed Oct. 5, 2005 and published Apr. 20, 2006 as U.S. Publication No. US-2006-0082192, which is hereby incorporated herein by reference in its entirety. Optionally, the shade element may comprise any suitable shading or opaque (or partially opaque) panel that slides between the window panels in an interpane cavity, such as via a motorized drive system or via a manually movable user input device or mechanism or the like.

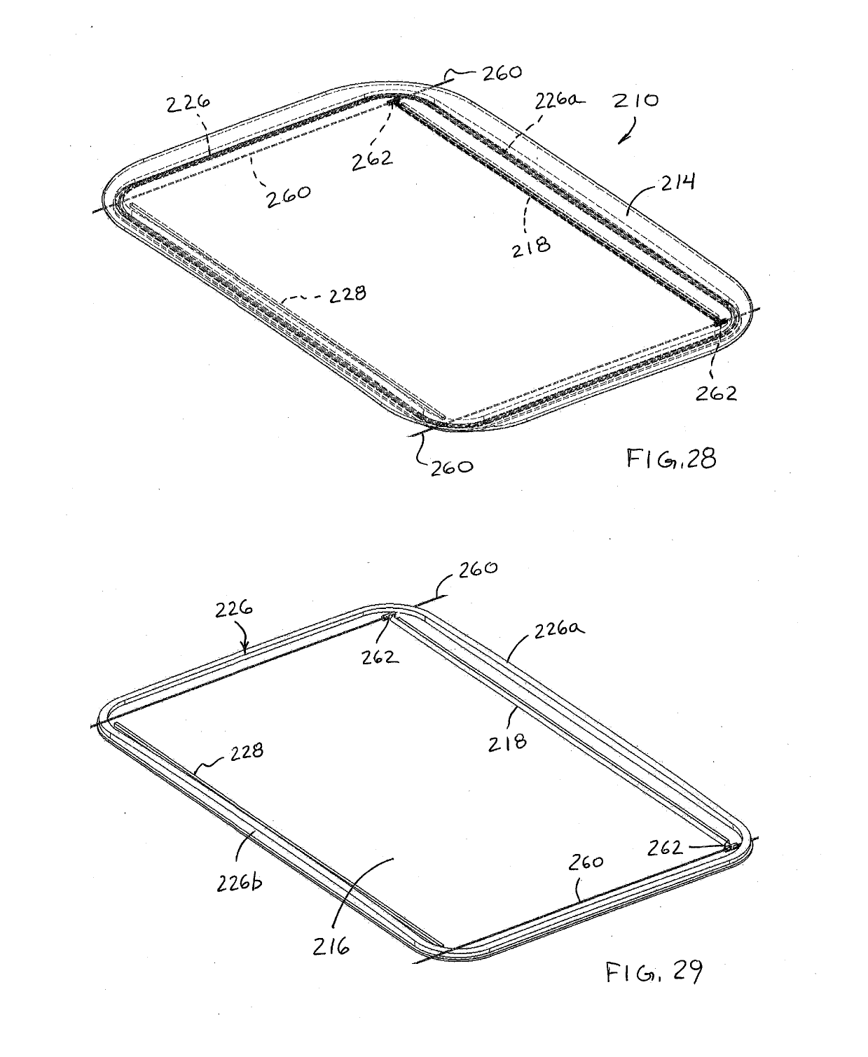

For example, and with reference to FIGS. 28-31, a window assembly 210 may include inner/lower and outer/upper window panels 216, 214 spaced apart and attached together via a spacing element or frame 226, with a roller shade 218 disposed within the interpane cavity, such as in a similar manner as described above. Roller shade 218 is extended/unrolled and retracted via movement of a pair of linkages 260 disposed along the sides of the window assembly and parallel to the direction of rolling/unrolling of the shade 218. In the illustrated embodiment, the linkages 260 comprise parallel arranged cables attached at or to a connector 262 at respective ends of a rod 219 of the roller shade 218 (and around which the shade or foil or shading element is coiled). The cables 260 may comprise a single cable at each side of the window assembly with the ends 260a, 260b of the cable 260 connected to the connector 262, such that movement of the cable in either direction (such as via any suitable two way drive motor or motors) causes a respective end 260a, 260b of the cable 260 to pull at the connector 262 to move the rod 219 to move along the window assembly in the window cavity in either direction to roll up or unroll the shade 218.

As shown in FIGS. 30 and 31, each connector 262 comprises a generally T-shaped connector with opposite ends 262a, 262b configured to receive and retain respective ends 260a, 260b of cable 260 therein (such as via any suitable attachment/connection means, such as having a slotted end that receives an enlarged end or slug or tab at the end of the cable to limit pull out of the cable from the connector when the enlarged end is received in the slotted portion of the connector). The rod 219 attached at a center portion 262c of connector 262, and may be rotatably received therein or attached thereto, such that the rod may rotated as it is moved along the window assembly to roll/unroll the shading element. (optionally, the rod may be fixedly attached at the center portion and may have a sleeve or bushing disposed over the rod that rotates relative to the rod to facilitate rolling and unrolling of the shading element) as the rod is moved along the window assembly via movement or pulling by the cables 262. As shown in FIGS. 30 and 31, an end 218a of the shading element 218 is fixed at the window panel 216 via a support or anchor element 232 (which may or may not be part of the frame element or portion 226a at that end or perimeter region of the window assembly) that anchors or retains the end 218a of shading element 218 at the window panel 216 so that movement of connectors 262 and rod 219 away from and toward the anchor 232 cause rolling and unrolling of the shading element or foil at the window panel 216. An end stop or roll stop or stop element 228 is disposed at window panel 217 at the opposite end of the window assembly 210 for the rod and uncoiled shading element to hit to limit over travel of the cables and connectors when the shading element is fully extended or unrolled. The end stop may also function to correct for any misalignment of the rod and shading element across the window that may occur if one cable moves at a slightly different speed as compared to the other cable when unrolling the shading element. The end stop 228 may be part of or spaced from the perimeter frame portion 226b.

Thus, the window assembly 210 provides for rolling and unrolling of a shading element within the window cavity and between two window panels via mechanical movement of a rod or structure around which the shading element is coiled. The cable or cables at each end of the shading element may be moved via any suitable moving means or drive system. For example, a cable drive system may be employed that drives or moves the cables in either direction (if more than one drive motor is used to drive the two or more cables, the drive motors are preferably synchronized to operate in tandem or cooperatively operate the move the respective connector in the same direction and at substantially the same speed). As shown in FIG. 30, the cable 260 passes through a passageway or recess of the perimeter frame or frame element 226 (such as through a passageway formed through the frame element 226 or through a recess formed at the frame element and between the frame element and the window panel). The passageway or recess allows for movement of the cable relative to the frame element and window assembly to facilitate movement of the connectors 262 and rolling/unrolling of the shading element 218 (and preferably provides a seal or substantial seal at the cable to substantially seal the window cavity. The drive system or motor or motors that move the cables may be actuated via user input or may be automatically actuated to shade or unshade the window, such as in response to a cabin temperature in the vehicle or a light sensor in the cabin of the vehicle or the like.

Thus, the window assembly 210, provides the option to pull the shade along the glass window panel via pulling a rod or wire or other type of cross structure within the film roll. The rod may be moved via any suitable drive system, such as a cable system (such as shown) or a rack and pinion gear system or a magnetic drive system or the like. The window assembly 210 thus provides a mechanical shading system without the need for the electrical charging of the glass panel surface for the extend/retract cycling such as discussed above. The window assembly thus provides a mechanical type of shading system for pulling/moving a shading element or film or foil or substrate within an insulated window assembly or unit.

The window assembly or module thus provides an integrated window assembly and shade device, with the shading element disposed within the interpane cavity of the window assembly. The motor or drive system or control for the shade device may be incorporated as part of the window module, and electrical connections may be readily made to the drive motor or system via connection of a vehicle wiring harness to one or more connectors accessible at the window module. The drive system and/or any components required for imparting the desired movement or extension/retraction of the shade element may be disposed at and/or along one or more of the perimeter overhang regions and/or inboard or outboard of the perimeter sealing/spacing element, and may be hidden or concealed from view by the darkened frit layer at the outer window panel.

The window assembly or module may be mounted to the vehicle via any suitable mounting or attachment means, and may utilize aspects of the window modules described in U.S. patent application Ser. No. 11/933,699, filed Nov. 1, 2007, and published May 8, 2008 as U.S. Patent Publication No. US-2008-0106124, which is hereby incorporated herein by reference in its entirety. For example, the upper or outer window panel may be bonded or adhered to one or more flanges of the sheet metal of the vehicle to attach the window assembly or module at the vehicle (with the darkened frit layer hiding the bonding area of the window assembly and sheet metal or flanges), such as in a similar manner as a typical or known or conventional single pane glass window panel may be conventionally attached at a vehicle roof. The inner or lower window panel may be supported at the outer window panel via the sealing or spacing element. Thus, for example, for a sunroof or moonroof application, the lower window panel may generally hang from the upper window panel and sealing/spacing element, and in in-cabin trim element or headliner may abut or frame the perimeter edges of the lower window panel to provide a generally flush or framed in appearance at the interior of the vehicle to a person viewing the window assembly from within the vehicle cabin when the window assembly is normally mounted at the vehicle.

Optionally, the window assembly or module may include a frame portion at or around the lower window panel and/or sealing/spacing element to provide a mounting surface or attachment surface or flanges for attaching one or more interior trim elements or headliners or roofliners to the window assembly or module when it is normally mounted at the vehicle. The frame portion of the roof modules or assemblies of the present invention may comprise any suitable material, and may comprise a polymeric or plastic frame portion, such as a PVC frame portion that provides an encapsulation of the upper and side perimeter portions of the glass roof panel. The frame portion may be formed utilizing aspects of the frame portions or encapsulated window modules of the types described in U.S. Pat. Nos. 6,669,267; 6,729,674; 6,572,176; 6,394,529; 6,299,235; 6,220,650, which are hereby incorporated herein by reference in their entireties.

The glass window panels may be bonded or secured to frame or header portions (such as by utilizing aspects of the window modules described in U.S. patent application Ser. No. 11/933,699, filed Nov. 1, 2007, and published May 8, 2008 as U.S. Patent Publication No. US-2008-0106124, which is hereby incorporated herein by reference in its entirety) and the frame and/or header portions may be bonded or secured to the vehicle sheet metal via any suitable bonding material or adhesive, such as a butyl seal and/or a urethane or the like, such as via curing of a bonding or an adhesive material and utilizing bonding processes of the types described in U.S. Pat. Nos. 6,298,606; 6,128,860; 5,966,874; 5,704,173; and/or 5,551,197, which are hereby incorporated herein by reference in their entireties. For example, the window panels may be bonded to a header or the vehicle sheet metal by an adhesive, such as a urethane adhesive, including a one part or two part urethane adhesive, an epoxy adhesive, an acrylic adhesive, a polyvinylbutyral adhesive, a silicone adhesive, or the like. Reference is made to U.S. Pat. Nos. 4,364,214; 4,364,595; 6,299,255; and 6,220,650, which are hereby incorporated herein by reference in their entireties, for examples of suitable adhesives. Optionally, and desirably, the outer glass window panel may include a frit layer at the perimeter regions that is substantially opaque (such as a dark color or black) and, therefore, provides a concealing function and may further facilitate the adhesion or bonding of the panel to the vehicle.

Optionally, the shadable window assembly, such as a sunroof or the like, may be openable and closable via moving the window panel between an opened position and a closed position. In such an application, electrical connection is made to the shading element to selectively power the shading element to shade or tint the window panel as desired. Optionally, the electrical connection may only be made when the window panel is closed, whereby the moving of the window panel to its closed position makes the electrical connection (such as between electrical contacts or terminals at a portion of the window panel and at the frame or supporting structure at the vehicle). Optionally, the electrical connection may be maintained throughout the range of movement of the window panel, so that electrical powering or control of the shading element may be provided irrespective of the position or degree of opening/closing of the window panel. Such continuous electrical connection may be made via any suitable means, such as via a flexible wire or cable or a pigtail wire or cable (such as a coiled wire similar to what is known to be used in telephone cords and the like) or sliding electrical contacts or the like (and such electrical connections may utilize aspects of the window assemblies described in U.S. patent application Ser. No. 12/850,864, filed Aug. 5, 2010 (Attorney Docket DON02 P-1625), and/or PCT Application No. PCT/US2011/051506, filed Sep. 13, 2011 (Attorney Docket DON02 FP-1737(PCT)), which are hereby incorporated herein by reference in their entireties). For example, a flexible or foldable or coiled or spooled wire or cable may have an end attached to electrical terminals at the vehicle (such as to electrically connect to a vehicle wiring harness) and another end attached to electrical terminals at the window panel (such as to electrically connect to the shading element or device). The wire or cable may extend or unfold or uncoil as the window panel is moved towards its opened or closed position and may retract or fold or coil as the window panel is moved towards its closed or opened position.

Optionally, the window assembly may include one or more electrical accessories disposed or established thereat. For example, the window assembly may include one or more user inputs and/or (and particularly for a sunroof or moonroof application) a video display screen or the like. For example, user inputs may be established at the lower or inner surface of the lower or inner glass panel so as to be readily accessible to the driver or occupant of the vehicle equipped with the window assembly. The user inputs may comprise any suitable inputs, such as buttons or switches or the like, and may be established or disposed at the glass surface or at a module or housing (such as a console or housing at a perimeter region of the window assembly).

Optionally, it is envisioned that one or more touch sensors (such as capacitive touch sensors) may be established at the glass surface, and one or more icons or indicia may be provided at the glass surface to indicate to a user what function the user input or touch sensor provides. Such touch sensors may comprise any suitable type of touch sensors, such as capacitive touch sensors, and may utilize aspects of the touch sensors (and indicators) described in PCT Application No. PCT/US2011/056295, filed Oct. 14, 2011 and published Apr. 19, 2012 as International Publication No. WO 2012/051500, and/or PCT Application No. PCT/US10/51741, filed Oct. 7, 2010 and published Apr. 14, 2011 as International Publication No. WO 2011/044312, and/or PCT Application No. PCT/US03/40611, filed Dec. 19, 2003 and published on Jul. 15, 2004 as PCT Publication No. WO 2004/058540, and/or U.S. patent application Ser. No. 12/414,190, filed Mar. 30, 2009 (Attorney Docket DON01 P-1509); Ser. No. 09/946,228, filed Sep. 5, 2001 and published Mar. 14, 2002 as U.S. Pat. Publication No. US2002/0031622; and/or Ser. No. 10/744,522, filed Dec. 23, 2003 and published Jul. 15, 2004 as U.S. Pat. Publication No. US2004/0137240, and/or U.S. Pat. Nos. 3,798,370; 4,198,539; 4,661,655; 4,731,508; 4,822,957; 5,045,644; 5,594,222; 6,001,486; 6,087,012; 6,310,611; 6,320,282; 6,369,804; 6,437,258; 6,452,479; 6,492,980; 6,501,465; 6,504,531; 6,627,918; 6,787,240; 7,224,324; 7,249,860; 7,253,723; 7,255,541; 7,360,932; and/or 7,446,924, and/or U.S. provisional applications, Ser. No. 61/647,179, filed May 15, 2012; Ser. No. 61/614,877, filed Mar. 23, 2012; Ser. No. 61/601,756, filed Feb. 22, 2012; Ser. No. 61/590,578, filed Jan. 25, 2012; Ser. No. 61/565,541, filed Dec. 1, 2011; and/or Ser. No. 61/558,623, filed Nov. 11, 2011, which are all hereby incorporated herein by reference in their entireties.

Optionally, the window assembly, when configured for a vehicular sunroof or moonroof application, may include one or more electrical accessories disposed thereat or integrated thereat. For example, the window assembly may include a display device (such as a video display screen for displaying movies or DVDs or the like for viewing by a passenger in the rear seat of the vehicle), which may be mounted at a cross member or support bar or divider bar or the like that extends laterally across the window panel between the side frame portions. The display device may flip up so as to be generally along the lower window panel when not in use and may flip down to a generally vertical use position when in use. Optionally, the display device may comprise an OLED display that is operable to display video images when powered but is substantially transparent when unpowered (or other similar or suitable type of display device or display screen that is operable to display video images when powered but is substantially transparent when unpowered). The display device thus may flip down and may be activated to display video images when it is desired to display the video images, and the display device may flip up when not in use, whereby the display device or screen is generally or substantially transparent so that it is rendered at least partially covert when disposed along the lower surface of the lower window panel. Thus, when the display screen is not in use, the display screen does not substantially block the window.

Thus, the window assembly of the present invention comprises a complex curved outer window panel and a curved inner panel, with a shade film or shading element disposed therein. The window assembly may be manufactured via any suitable manufacturing process. Preferably, the window assembly is assembled in a clean room environment to limit or substantially preclude particles, such as dust or dirt particles, from being drawn to the sheet or film material during the cutting process.

For example, the inner and outer window panels may be provided or supplied at a clean room along with the other components (the anchor bar and end stop and the like). The components may be pre-cleaned before being moved into the clean room (such as via a detergent scrub or the like to the glass surfaces of the window panels). When in the clean room, the inner or lower glass panel (which is already coated on its inner or upper surface with a transparent conductive layer or ITO layer) may be ground cleaned with isopropyl alcohol (with the panel being connected to ground during the cleaning process). For example, a wiping element or sponge or the like may be saturated with isopropyl alcohol and connected to a ground wire and wiped over the inner glass surface of the inner or lower glass panel to clean the inner or lower glass panel and to remove all stored pockets or charge that may be present on the glass surface.

After the glass surface has been so cleaned, the perimeter regions of the glass panel or substrate may be masked (with the mask disposed over the ITO layer at the perimeter regions of the glass panel). The glass panel is then preheated (such as in an oven or heating chamber at, for example, about 100 degrees C. for about 15 minutes), and processed with a laminate roller that rolls and laminates the dielectric layer (such as PET) onto the unmasked ITO coated glass surface of the window panel. For example, the glass may be fed through a heated roller system (that may heat the glass panel to about 210 degrees F. during the lamination process) to laminate the dielectric layer to the heated glass surface. Typically, the dielectric layer may shrink during processing, which may result in wrinkles or non-uniform thickness of the dielectric layer. The present invention reduces or avoids or limits such marks by preheating the glass and laminating the dielectric onto the heated glass and then heating the laminated glass and dielectric configuration, whereby the heating heats the adhesive that adheres the dielectric layer to the window panel and allows for shrinkage of dielectric layer without such wrinkles or the like. Optionally, the dielectric may be otherwise disposed at the ITO coated glass surface, such as by sputter coating or e-beam coating a suitable dielectric material onto the ITO coated glass surface.

The shade film is provided in the clean room as a large coil of film (at the desired thickness and comprising the desired or selected materials). The larger coil of film may be uncoiled onto a charged cutting table, where the charge of the cutting table, when activated, draws the film onto the cutting table surface to hold the film in place during the cutting process (optionally, the cutting table may comprise a vacuum table to draw the film onto the vacuum table when a vacuum or negative pressure is applied). The film may then be readily cut or trimmed to the desired or appropriate length and width for the particular application of that film.

The cut film (cut to the desired size dimensions for the particular shade application) is then rolled or coiled, such as onto a mandrel. The tightly coiled shade film is then heated (such as at about 165 degrees C. for about 45 minutes or thereabouts) to shrink the film and generally fix the coil. The end of the coil may then be uncoiled a little and a fixed loop may be established at the end of the coil. For example, the end of the coiled film may be coiled around a mandrel, and the end or edge of the film may be adhered to the film to close the coil or loop, whereby the mandrel may be removed, leaving a fixed single layer coil at the end of the shade film.

After the dielectric layer is laminated or adhered to the inner surface of the window panel, and after a shade film has been formed as described above, the shade film may be attached at the window panel. The roll stop bar or end stop may be adhered or bonded at the glass surface, and the film may be placed onto the ITO coated surface with the fixed end loop against the end stop. At the area of the window panel where the base or anchor stop or bar will be disposed or attached, an adhesive strip or tape may be disposed across the window panel. The ITO and the end stop may then be powered to uncoil the film towards the anchor stop area, whereby the film may uncoil over the adhesive strip and stick to the adhesive strip. The anchor stop or bar may then be adhered to and over the film at the area where the film is adhered to the window panel. The mandrel and excess film may be cut off or trimmed, leaving a small amount of film that extends past the adhesive strip, whereby the excess film may coil back against the anchor stop.

The wiring and/or electrical connectors may be established at the window panel at any time after the dielectric layer is laminated to the window panel. The electrical connectors may be screen printed or otherwise established at the glass surface or electrical connections may be made to the anchor stop and end stop via other suitable wires or terminals.

The lower or inner window panel (with the anchor stop and end stop and shade film and electrical connections established thereat) is then attached to the spacer and upper window panel. For example, the lower or inner window panel may be placed on a fixture and mated with the spacer, which may already be mated with or bonded to the upper window panel. The spacer (at the mating surface that will mate with the lower panel) may have an adhesive bead disposed along one channel and a desiccant bead disposed along another channel, such as described above, and then the upper window panel may be disposed at the fixture that holds the lower window panel, with the upper window panel and spacer spaced from the lower window panel.

Optionally, the fixture may fixedly hold the lower window panel, with the lower window panel set in the appropriate location via moving the lower panel against a plurality of datums or stops established at the fixture. The fixture may movably support the upper window panel, and may comprise a plurality of supports that urge the upper window panel away from the lower window panel. Thus, the upper window panel may be placed at the fixture (with the adhesive and desiccant beads disposed at the mating surface of the spacer attached to the upper window panel) and moved to properly align the upper window panel with the lower window panel (such as by moving the upper window panel into engagement with a plurality of datums or stops established at the fixture), whereby the upper window panel (and spacer) may be pressed toward the lower window panel to engage the mating surface of the spacer with the surface of the lower window panel.

The fixture then holds the upper panel relative to the lower panel while the adhesive at least partially sets up or cures. The adhesive may be cured via any suitable means, such as via heating the window assembly or allowing the adhesive to cure over time (and/or exposing the adhesive to UV radiation or the like, depending on the type of adhesive used to adhere the spacer to the lower window panel). After the spacer is attached to both the upper and lower window panels, a secondary or outer sealant may be disposed around the spacer at the interface with the upper window panel and/or lower window panel to further seal the window assembly, and the appropriate brackets and electrical connectors or terminals may be added to the window assembly. The secondary sealant and bracketry and electrical connectors may be added to the window assembly after the window assembly is removed from the clean room. The completed window assembly may then be shipped to a vehicle assembly plant or facility for installation at a vehicle and electrical connection to a power source and/or control of the vehicle.

Therefore, the present invention provides a shading device or element that is disposed in a window module that has an overhanging outer window panel to fit at and at least partially within an opening in the outer sheet metal of a vehicle to provide a uniform or flush fit and finish and appearance at the exterior of the vehicle. The outer window panel may have a frit coating or other suitable darkened coating or hiding layer or the like disposed around its perimeter regions to conceal the bonding regions of the outer window panel to the vehicle (such as to flanges or sheet metal or the like of the vehicle) and to conceal the perimeter seal or spacer and, for window assemblies comprising a flexible or coilable/uncoilable shading element, the coiled shading element or film (when in its coiled or retracted position), to enhance the appearance of the window assembly and vehicle to a person viewing the window assembly from outside the vehicle when the window assembly is normally mounted or installed at the vehicle. The inner and outer window panels may have different contours or curvatures and/or dimensions to correspond to the contours or curvatures of the in-cabin surface of the vehicle (such as the vehicle headliner or roof liner of the vehicle) and the outer surface of exterior panels of the vehicle (such as the exterior sheet metal of the vehicle), respectively. In order to provide such different curvatures, the sealing elements or spacers may have non-uniform profiles to engage and seal against the opposing surfaces of the window panels and to provide a varying interspacing distance or gap between the window panels.

Changes and modifications to the specifically described embodiments may be carried out without departing from the principles of the present invention, which is intended to be limited only by the scope of the appended claims, as interpreted according to the principles of patent law.

1. A window assembly for a vehicle, said window assembly comprising:
an outer window panel;
an inner window panel;
a conductive layer disposed at an inner surface of said inner window panel;
a spacer element disposed between said inner and outer window panels to establish an interpane cavity between said inner and outer window panels;
a roller shade disposed within said interpane cavity, wherein said roller shade has an end fixedly attached at an anchor stop along a perimeter portion of said spacer element;
a dielectric layer disposed between said roller shade and said conductive layer;
wherein said roller shade is electrically deployable to coil and uncoil between a coiled light transmitting condition, where said roller shade is coiled along said perimeter portion of said spacer element and functions to substantially allow light transmission through said window assembly, and an at least partially uncoiled light attenuating condition, where said roller shade is uncoiled to at least partially cover a surface of said inner window panel and functions to at least partially attenuate light transmission through said window assembly;
wherein said roller shade is electrically operable via applying a voltage at said conductive layer and at said anchor stop to uncoil said roller shade from said coiled light transmitting condition to said at least partially uncoiled light attenuating condition, and wherein electrical connection is made between said roller shade and a vehicle power source to provide electrical power to said roller shade; and
wherein said window assembly comprises a plurality of conductive elements established at said dielectric layer for dissipating charge at said dielectric layer when said voltage is not applied.

2. The window assembly of claim 1, wherein said perimeter portion of said spacer element comprises a shade attaching structure for attaching said anchor stop at said perimeter portion of said spacer element.

3. The window assembly of claim 1, further comprising an electrically conductive stop element disposed along another perimeter portion of said spacer element, wherein an end of said roller shade at least partially contacts said stop element when said roller shade is uncoiled to its light limiting state, and wherein electrical connection to said stop element is made via an electrically conductive element that electrically connects between said shade attaching structure of said spacer element and said stop element.

4. The window assembly of claim 3, wherein said dielectric layer is established at least partially over said conductive layer and wherein said electrically conductive element comprises at least one electrically conductive strip disposed along said dielectric layer between said anchor stop and said stop element.

5. The window assembly of claim 3, wherein said another perimeter portion of said spacer element is configured to have an outboard portion curved along a curvature of the perimeter of said inner window panel and an inboard portion configured to provide a generally straight stop element receiving portion for receiving and retaining a generally straight stop element.

6. The window assembly of claim 1, wherein said roller shade is electrically operable to adjust between said coiled light transmitting condition and at least two partially uncoiled light attenuating conditions.

7. The window assembly of claim 1, wherein said plurality of conductive elements for dissipating charge comprises a plurality of conductive elements established in an adhesive layer that adheres said dielectric layer at said conductive layer.

8. The window assembly of claim 1, wherein said dielectric layer is established partially over said conductive layer and wherein said plurality of conductive elements for dissipating charge comprises a plurality of conductive strips established along said dielectric layer.

9. The window assembly of claim 8, wherein said plurality of conductive strips conduct electrical current from said anchor stop to an end stop of said window assembly when said voltage is applied at said anchor stop.

10. The window assembly of claim 1, comprising a mechanical stop that is operable to mechanically retain said roller shade in its at least partially uncoiled light attenuating condition, wherein said roller shade remains in its at least partially uncoiled light attenuating condition when said voltage is reduced or not applied.

11. The window assembly of claim 10, wherein said mechanical stop engages said roller shade to mechanically retain said roller shade at least in part responsive to a position sensor that senses when said roller shade is uncoiled to said mechanical stop.

12. The window assembly of claim 11, wherein, when said mechanical stop engages said roller shade, a control is operable to reduce said voltage to a lower voltage level.

13. The window assembly of claim 1, comprising a pressure regulating device for regulating a pressure within said interpane cavity of said window assembly.

14. The window assembly of claim 13, wherein said pressure regulating device comprises one of (i) a vent, (ii) an expandable and contractable container in fluid communication with said interpane cavity of said window assembly and (iii) an expandable and contractable spacer element that allows for movement of said outer window panel towards and away from said inner window panel.

15. The window assembly of claim 14, wherein said pressure regulating device includes a desiccant function.

16. The window assembly of claim 1, wherein an inert gas is disposed in said interpane cavity of said window assembly.

17. The window assembly of claim 16, comprising a controller and a sensor for sensing a gas composition of said inert gas in said interpane cavity, wherein said controller is operable to determine if said window assembly has a leak to atmosphere responsive to said sensor.

18. The window assembly of claim 1, comprising a controller that is operable to control a level of said voltage responsive to a temperature sensor of said window assembly.

19. The window assembly of claim 18, comprising a position sensor that detects a position of said shade element, wherein said controller is operable to determine a rate of deployment of said shade element responsive to said position sensor.

20. The window assembly of claim 19, wherein said controller is operable to detect a fault condition of said window assembly responsive at least in part to said temperature sensor and said position sensor.

21. The window assembly of claim 1, comprising a controller operable to determine a rate of deployment of said shade element, wherein, responsive to the determined rate of deployment of said shade element, said controller is operable to adjust said voltage applied at said shade film to adjust the deployment rate to be within a selected range of deployment rates.

22. A window assembly for a vehicle, said window assembly comprising:
an outer window panel;
an inner window panel;
a conductive layer disposed at an inner surface of said inner window panel;
a spacer element disposed between said inner and outer window panels to establish an interpane cavity between said inner and outer window panels;
a roller shade disposed within said interpane cavity, wherein said roller shade has an end fixedly attached at an anchor stop along a perimeter portion of said spacer element;
a controller operable to electrically coil and uncoil said roller shade between a coiled light transmitting condition, where said roller shade is coiled along said perimeter portion of said spacer element and functions to substantially allow light transmission through said window assembly, and an at least partially uncoiled light attenuating condition, where said roller shade is uncoiled to at least partially cover a surface of said inner window panel and functions to at least partially attenuate light transmission through said window assembly;
wherein said roller shade is electrically operable via applying a voltage at said conductive layer and at said anchor stop to uncoil said roller shade from said coiled light transmitting condition to said at least partially uncoiled light attenuating condition, and wherein electrical connection is made between said roller shade and a vehicle power source to provide electrical power to said roller shade; and
wherein said controller is operable to determine a rate of deployment of said shade element and wherein, responsive to the determined rate of deployment of said shade element, said controller is operable to adjust said voltage applied at said shade film to adjust the deployment rate to be within a selected range of deployment rates.

23. The window assembly of claim 22, wherein said controller is operable to control a level of said voltage responsive to a temperature sensor of said window assembly.

24. The window assembly of claim 23, wherein said controller is operable to detect a fault condition of said window assembly responsive at least in part to said temperature sensor and said position sensor.

25. The window assembly of claim 22, comprising a position sensor that detects a position of said shade element, wherein said controller is operable to determine the rate of deployment of said shade element responsive to said position sensor.

26. A window assembly for a vehicle, said window assembly comprising:
an outer window panel;
an inner window panel;
a conductive layer disposed at an inner surface of said inner window panel;
a spacer element disposed between said inner and outer window panels to establish an interpane cavity between said inner and outer window panels;
a roller shade disposed within said interpane cavity, wherein said roller shade has an end fixedly attached at an anchor stop along a perimeter portion of said spacer element;
wherein said roller shade is electrically deployable to coil and uncoil between a coiled light transmitting condition, where said roller shade is coiled along said perimeter portion of said spacer element and functions to substantially allow light transmission through said window assembly, and an at least partially uncoiled light attenuating condition, where said roller shade is uncoiled to at least partially cover a surface of said inner window panel and functions to at least partially attenuate light transmission through said window assembly;
wherein said roller shade is electrically operable via applying a voltage at said conductive layer and at said anchor stop to uncoil said roller shade from said coiled light transmitting condition to said at least partially uncoiled light attenuating condition, and wherein electrical connection is made between said roller shade and a vehicle power source to provide electrical power to said roller shade;
a pressure regulating device for regulating a pressure within said interpane cavity of said window assembly; and
wherein said pressure regulating device comprises one of (i) a vent, (ii) an expandable and contractable container in fluid communication with said interpane cavity of said window assembly and (iii) an expandable and contractable spacer element that allows for movement of said outer window panel towards and away from said inner window panel.

27. The window assembly of claim 26, wherein said pressure regulating device includes a desiccant function.

28. The window assembly of claim 26, comprising a controller and a sensor for sensing a gas composition of an inert gas disposed in said interpane cavity, wherein said controller is operable to determine if said window assembly has a leak to atmosphere responsive to said sensor.
